(19) United States
(12) Patent Application Publication
(10) Pub. No.: US 2017/0237127 A1
(43) Pub. Date: Aug. 17, 2017

(54) ELECTRODE, MANUFACTURING METHOD THEREOF, NEGATIVE ELECTRODE, MANUFACTURING METHOD THEREOF, POWER STORAGE DEVICE, AND ELECTRONIC DEVICE

(71) Applicant: Semiconductor Energy Laboratory Co., Ltd., Atsugi-shi, Kanagawa-ken (JP)

(72) Inventors: Jun ISHIKAWA, Isehara (JP); Kazuhei NARITA, Atsugi (JP); Teppei OGUNI, Atsugi (JP); Aya UCHIDA, Isehara (JP)

(21) Appl. No.: 15/519,692

(22) PCT Filed: Oct. 15, 2015
(86) PCT No.: PCT/IB2015/057894

§ 371 Date: Apr. 17, 2017

(30) Foreign Application Priority Data
Oct. 24, 2014 (JP) 2014-217545

(51) Int. Cl. H01M 10/42; H01G 11/70; H01G 11/86; H01G 11/52; H01M 4/58; H01G 11/08; H01M 10/0525; H01M 4/66; H01M 4/04; H01M 4/587; H01G 11/28; H01G 11/68

(52) U.S. Cl. CPC H01M 10/4235; H01G 11/28; H01G 11/70; H01G 11/86; H01G 11/52; H01G 11/68; H01G 11/08; H01M 10/0525; H01M 4/661; H01M 4/0404; H01M 4/587; H01M 4/5825; H01M 4/0471

(57) ABSTRACT

A power storage device with a high capacity is provided. A power storage device with a high energy density is provided. A highly reliable power storage device is provided. A power storage device with a long lifetime is provided.

A method for manufacturing an electrode is characterized by including the steps of: mixing an active material, a binder, and a conductive additive to form a slurry; applying the slurry onto a current collector; drying the applied slurry to form an active material layer; and performing heat treatment in an atmosphere containing oxygen to form a film in contact with the current collector. The film is formed on a surface of the current collector where the active material layer is not provided and includes at least one component of the current collector and oxygen.

### TECHNICAL FIELD

One embodiment of the present invention relates to, for example, an object, a method, or a manufacturing method. In addition, one embodiment of the present invention relates to a process, a machine, manufacture, or a composition of matter. In particular, one embodiment of the present invention relates to a semiconductor device, a display device, a light-emitting device, a power storage device, a memory device, a driving method thereof, or a manufacturing method thereof. In particular, one embodiment of the present invention relates to an electrode, a manufacturing method thereof, a negative electrode, a manufacturing method thereof, and a power storage device.

Note that a power storage device in this specification refers to every element and device having a function of storing electric power and, for example, refers to a storage battery such as a lithium-ion secondary battery, a lithium-ion capacitor, an electric double-layer capacitor, and the like.

### BACKGROUND ART

In recent years, a variety of power storage devices, for example, secondary batteries such as lithium-ion secondary batteries, lithium-ion capacitors, and air cells have been actively developed. In particular, demand for lithium-ion secondary batteries with high output and high energy density has rapidly grown with the development of the semiconductor industry, for electronic devices, for example, portable information terminals such as mobile phones, smartphones, and laptop computers, portable music players, and digital cameras; medical equipment; next-generation clean energy vehicles such as hybrid electric vehicles (HEVs), electric vehicles (EVs), and plug-in hybrid electric vehicles (PHEVs); and the like. The lithium-ion secondary batteries are essential as rechargeable energy supply sources for today's information society.

A negative electrode for the power storage devices such as the lithium-ion batteries and the lithium-ion capacitors is a structure body including at least a current collector (hereinafter referred to as a negative electrode current collector) and an active material layer (hereinafter referred to as a negative electrode active material layer) provided over a surface of the negative electrode current collector. The negative electrode active material layer contains an active material (hereinafter referred to as a negative electrode active material), such as carbon or silicon, which can store and release lithium ions serving as carrier ions.

Such a negative electrode of a lithium-ion battery and a lithium-ion capacitor has an extremely low electrode potential and a high reducing ability. For this reason, an electrolytic solution using an organic solvent is reduced and decomposed. The range of potential in which the electrolysis of an electrolytic solution does not occur is referred to as a potential window. Although the negative electrode essentially needs to have an electrode potential in the potential window of the electrolytic solution, the negative electrode potential of a lithium-ion battery or a lithium-ion capacitor is out of the potential windows of almost all electrolytic solutions. Actually a decomposition product thereof forms a passivating film on the surface of the negative electrode, and this film prevents further reductive decomposition. Thus, lithium ions can be inserted into the negative electrode with the use of a low electrode potential below the potential window of the electrolytic solution (for example, see Non-Patent Document 1).

However, such a film on the surface of the negative electrode which is formed by the decomposition product of the electrolytic solution kinetically suppresses the decomposition of the electrolytic solution, which leads to a gradual deterioration. Therefore, it cannot be said that such a film is a stable film. Since the decomposition reaction particularly speeds up at high temperature, the decomposition reaction greatly hinders operation in high temperature environments. In addition, the formation of the film on the surface generates irreversible capacity, so that part of discharge capacity is lost. For these reasons, there are demands for a film on the surface of the negative electrode which is more stable and can be formed without losing its capacity.

Furthermore, cyclic carbonates are used as organic solvents in electrolytic solutions for power storage devices. In particular, ethylene carbonate is often used because of its high dielectric constant and high ionic conductivity.

However, not only ethylene carbonate but also many other organic solvents have volatility and a low flash point. For this reason, in the case of using an organic solvent for an electrolytic solution of a power storage device, the temperature inside the power storage device might rise due to a short circuit, overcharge, or the like of the power storage device and the power storage device might burst or catch fire.

In view of the above, the use of an ionic liquid (also referred to as a room temperature molten salt) having non-flammability and non-volatility as a solvent for a nonaqueous electrolyte of a lithium-ion secondary battery has been considered. Examples include an ionic liquid containing an ethylmethylimidazolium (EMI) cation, an ionic liquid containing an N-methyl-N-propylpyrrolidinium (P13) cation, and an ionic liquid containing an N-methyl-N-propylpiperidinium (PP13) cation (see Patent Document 1).

Improvements have been made to an anion component and a cation component of an ionic liquid to provide a lithium-ion secondary battery that uses the ionic liquid with low viscosity, a low melting point, and high conductivity (see Patent Document 2).

### REFERENCE

### Patent Document

[Patent Document 1] Japanese Published Patent Application No. 2003-331918
[Patent Document 2] PCT International Publication No. 2005/63773

### Non-Patent Document

[Non-Patent Document 1] Zempachi Ogumi, “Lithium Secondary Battery”, Ohmsha, Ltd., the first impression of the first edition published on March 20, H20, pp. 116-118

### SUMMARY OF THE INVENTION

### Problems to be Solved by the Invention

One object of one embodiment of the present invention is to provide a power storage device with a high capacity. One object of one embodiment of the present invention is to provide a power storage device with a high energy density. One object of one embodiment of the present invention is to provide a highly reliable power storage device. One object of one embodiment of the present invention is to provide a long-life power storage device.

One object of one embodiment of the present invention is to provide a power storage device with reduced irreversible capacity. One object of one embodiment of the present invention is to provide a power storage device in which the decomposition reaction of an electrolytic solution is inhibited and a decrease in capacity with increasing number of charge and discharge cycles is prevented. One object of one embodiment of the present invention is to reduce or inhibit the decomposition reaction of an electrolytic solution, which speeds up at high temperature, and to prevent a decrease in charge and discharge capacity in charging and discharging at high temperature, in order to extend the operating temperature range of a power storage device.

One object of one embodiment of the present invention is to increase an yield of a power storage device. One object of one embodiment of the present invention is to provide a novel power storage device, a novel electrode, or the like.

Note that the description of these objects does not preclude the existence of other objects. In one embodiment of the present invention, there is no need to achieve all of these objects. Other objects will be apparent from and can be derived from the description of the specification, the drawings, the claims, and the like.

### Means for Solving the Problems

One embodiment of the present invention is an electrode which includes a current collector and an active material layer, characterized in that a first surface of the current collector includes a region provided with the active material layer, a second surface of the current collector includes a region not provided with the active material layer, the electrode includes a first film, the first film includes a region in contact with the second surface of the current collector, the first film includes an insulating film, and the insulating film includes at least one component of the current collector and oxygen.

Furthermore, in the above-described structure, the first film includes a region having a thickness of more than or equal to 5 nm and less than or equal to 50 nm.

Furthermore, in the above-described structure, the current collector includes copper, and the first film includes copper oxide.

Moreover, in the above-described structure, a second film in contact with a surface of the active material layer may be included.

Furthermore, another embodiment of the present invention is a negative electrode which includes the electrode having the above-described structure, characterized in that the current collector is a negative electrode current collector and the active material layer is a negative electrode active material layer.

Another embodiment of the present invention is a power storage device which includes a positive electrode, a separator, a negative electrode, and an electrolytic solution, characterized in that the separator is provided between the positive electrode and the negative electrode, the positive electrode includes a positive electrode active material layer and a positive electrode current collector, the negative electrode includes a negative electrode current collector and a negative electrode active material layer which faces the positive electrode active material layer with the separator positioned therebetween, a first surface of the negative electrode current collector includes a region provided with the negative electrode active material layer, a second surface of the negative electrode current collector includes a region not provided with the negative electrode active material layer, the negative electrode includes a first film, the first film includes an insulating film, the first film includes a region in contact with the second surface of the negative electrode current collector, and the insulating film includes at least one component of the current collector and oxygen.

Furthermore, in the above-described structure, the first film includes a region having a thickness of more than or equal to 5 nm and less than or equal to 50 nm.

Furthermore, in the above-described structure, the negative electrode current collector includes copper, and the first film includes copper oxide.

Furthermore, in the above-described structure, a second film in contact with a surface of the negative electrode active material layer may be included.

Another embodiment of the present invention is an electronic device characterized by including the above-described power storage device, and a display device, an operation button, an external connection port, a speaker, or a microphone.

Another embodiment of the present invention is a method for manufacturing an electrode, characterized by including the steps of mixing an active material, a binder, and a conductive additive to form a slurry; applying the slurry onto a current collector; drying the applied slurry to form an active material layer; and performing heat treatment in an atmosphere containing oxygen to form a film in contact with the current collector. The film is formed on a surface of the current collector where the active material layer is not provided and includes at least one component of the current collector and oxygen.

Furthermore, in the above-described manufacturing method, the drying is performed at higher than or equal to 30° C. and lower than or equal to 160° C.

Moreover, in the above-described manufacturing method, the heat treatment is performed at higher than or equal to 50° C. and lower than or equal to 200° C. for longer than or equal to 2 hours.

Furthermore, another embodiment of the present invention is a method for manufacturing a negative electrode, characterized in that the current collector is a negative electrode current collector and the active material layer is a negative electrode active material layer in the above-described method for manufacturing an electrode.

### Effect of the Invention

Furthermore, one embodiment of the present invention can provide a power storage device with a high capacity. One embodiment of the present invention can provide a power storage device with a high energy density. One embodiment of the present invention can provide a highly reliable power storage device. One embodiment of the present invention can provide a power storage device with a long lifetime.

Moreover, one embodiment of the present invention can provide a power storage device with reduced irreversible capacity. One embodiment of the present invention can provide a power storage device in which a decomposition reaction of an electrolytic solution is inhibited and a decrease in capacity with increasing number of charge and discharge cycles is prevented. Furthermore, one embodiment of the present invention makes it possible to reduce or inhibit the decomposition reaction of an electrolytic solution, which speeds up at high temperature, and to prevent a decrease in charge and discharge capacity in charging and discharging at high temperature, in order to extend the operating temperature range of a power storage device.

Furthermore, one embodiment of the present invention can increase an yield of a power storage device. Moreover, one embodiment of the present invention can provide a novel power storage device, a novel electrode, or the like.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF DRAWINGS

FIG. 1 A cross-sectional view of a negative electrode of a power storage device.

FIG. 2 Cross-sectional views of a power storage device.

FIG. 3 Views explaining the operation of a power storage device.

FIG. 4 External views of a thin storage battery and electrodes.

FIG. 5 Cross-sectional views of thin storage batteries.

FIG. 6 An external view of a thin storage battery.

FIG. 7 Views illustrating a method for manufacturing a thin storage battery.

FIG. 8 Views illustrating a method for manufacturing a thin storage battery.

FIG. 9 A view illustrating a method for manufacturing a thin storage battery.

FIG. 10 Views illustrating a method for manufacturing an electrode.

FIG. 11 A view explaining a cross-sectional view of a positive electrode active material layer.

FIG. 12 Views illustrating examples of a power storage device.

FIG. 13 Views illustrating an example of a power storage device.

FIG. 14 Views illustrating an example of a power storage device.

FIG. 15 Views explaining a cylindrical storage battery.

FIG. 16 Views explaining coin-type storage batteries.

FIG. 17 Views for explaining an example of a power storage system.

FIG. 18 Views for explaining examples of a power storage system.

FIG. 19 Views for explaining examples of a power storage system.

FIG. 20 Views explaining examples of an electronic device.

FIG. 21 Views explaining an example of an electronic device.

FIG. 22 A view explaining examples of an electronic device.

FIG. 23 Views explaining examples of an electronic device.

FIG. 24 A view explaining a method for manufacturing an electrode.

FIG. 25 A view explaining a method for forming a slurry.

FIG. 26 A view explaining a method for manufacturing a thin storage battery.

FIG. 27 A view explaining initial charge and discharge characteristics of thin storage batteries.

FIG. 28 A view explaining cycle characteristics of thin storage batteries.

FIG. 29 A block diagram explaining a power storage device.

FIG. 30 Conceptual diagrams explaining operation examples of a switch control circuit.

FIG. 31 A circuit diagram explaining a structure example of a switch circuit.

FIG. 32 A circuit diagram explaining a structure example of a switch circuit.

FIG. 33 Conceptual diagrams explaining operation examples of a voltage transformation control circuit.

FIG. 34 A block diagram explaining a structure of a voltage transformer circuit.

FIG. 35 A flow chart explaining the operation of a power storage device.

### MODE FOR CARRYING OUT THE INVENTION

Embodiments of the present invention will be described in detail below with reference to the accompanying drawings. However, the present invention is not limited to the description of the embodiments, and it is easily understood by those skilled in the art that the modes and details can be modified in various ways. Thus, the present invention should not be construed as being limited to the description in the following embodiments.

Note that in each drawing described in this specification, the size of each component, such as the thickness of a film, a layer, a substrate, or the like or the size of a region is exaggerated for clarity in some cases. Therefore, the sizes of the components are not necessarily limited to the sizes in the drawings and relative sizes between the components.

Note that ordinal numbers such as “first” and “second” in this specification and the like are used for convenience and do not denote the order of steps, the stacking order of layers, and the like. Therefore, for example, the term “first” can be replaced with the term “second”, “third”, or the like as appropriate. In addition, the ordinal numbers in this specification and the like are not necessarily the same as those used to specify one embodiment of the present invention.

Note that in structures of the present invention described in this specification and the like, the same portions or portions having similar functions are denoted by common reference numerals in different drawings, and descriptions thereof are not repeated. Further, the same hatching pattern is applied to portions having similar functions, and the portions are not especially denoted by reference numerals in some cases.

Note that in this specification and the like, a positive electrode and a negative electrode for a power storage device (battery cell) may be collectively referred to as an electrode; in this case, the electrode refers to at least one of the positive electrode and the negative electrode.

Here, a charge rate and a discharge rate are described. For example, in the case of charging a secondary battery with a capacity of X [Ah] at a constant current, a charge rate of 1 C means the current value I [A] with which charging is terminated in exactly 1 hour, and, for example, a charge rate of 0.2 C means I/5 [A] (i.e., the current value with which charging is terminated in exactly 5 hours). Similarly, a discharge rate of 1 C means the current value I [A] with which discharging is terminated in exactly 1 hour, and, for example, a discharge rate of 0.2 C means I/5 [A] (i.e., the current value with which discharging is terminated in exactly 5 hours).

Here, an active material refers to only a material that relates to insertion and extraction of ions that are carriers. In this specification and the like, an active material layer also refers to a layer including not only a material that is actually an “active material” but also a conductive additive, a binder, and the like.

### Embodiment 1

In this embodiment, an example of the structure of a power storage device (battery cell) of one embodiment of the present invention will be described.

### [Structure of Battery Cell]

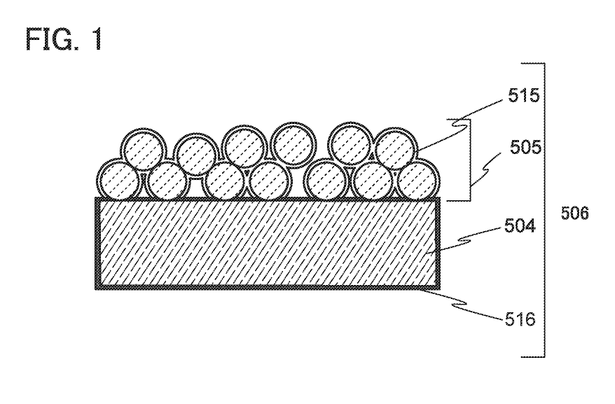

Here, an example of the battery cell of one embodiment of the present invention will be described with reference to FIG. 1. FIG. 1 illustrates an example of a cross-sectional view of a negative electrode of a battery cell. A negative electrode 506 illustrated in FIG. 1 includes a negative electrode current collector 504, a negative electrode active material layer 505 in contact with the negative electrode current collector 504, a film 515 in contact with the negative electrode active material layer 505, and a film 516 which covers the negative electrode current collector 504.

Note that a “film” in one embodiment of the present invention is clearly distinguished from a film which is artificially provided in advance before a battery cell is charged or discharged, and refers to a film generated by oxidation of a surface of a current collector by heating or a film generated by the decomposition reaction between an electrolytic solution and an active material layer. The film serves as a passivating film in some cases. This film might inhibit the decomposition reaction of ions other than lithium ions due to charging or discharging and can suppress a decrease in the capacity of the battery cell. Although the film formed on the surface of the negative electrode active material layer (the film 515) can be regarded as part of the negative electrode active material layer, the film formed on the surface of the negative electrode active material layer is distinguished from the negative electrode active material layer in the description of this specification and the like for easy understanding. Furthermore, in some cases, the film is formed on a surface of part of the negative electrode current collector.

The film is classified into the one formed by oxidation of a surface of a current collector by heating and the one formed by the cell reaction. The film 515 is primarily formed by the cell reaction. Furthermore, the film 516 is formed by oxidation of a surface of a current collector by heating. Note that the film 515 and the film 516 might have different components. The film 515 mainly contains elements constituting the negative electrode active material layer 505 or elements constituting an electrolytic solution. Moreover, the film 516 contains an oxide containing at least one metal element included in the negative electrode current collector 504.

Note that a region around the boundary between the film 515 and the film 516 may include a region where a component of the film 515 and a component of the film 516 are mixed. Furthermore, even at a place apart from the boundary between the film 515 and the film 516, the film 515 may include a component of the film 516 or the film 516 may include a component of the film 515.

After the film 516 is formed, the negative electrode current collector 504, the negative electrode active material layer 505, and the film 516 are immersed in an electrolytic solution or the cell reaction is performed, so that the film 515 is formed. The film 516 might be partly dissolved by an electrolytic solution, and the reaction with the negative electrode current collector 504 which is exposed by the dissolution might form a conductor in a region where the film 516 is dissolved. When the conductor is formed in a region where the film 516 is dissolved, the decomposition reaction occurs between the conductor and the electrolytic solution. This decomposition reaction is often an irreversible reaction and leads to a loss in the capacity of the battery cell. Therefore, in order to prevent the film 516 from being partly dissolved by the electrolytic solution, the film 516 preferably has a thickness with which the negative electrode current collector 504 is not exposed at the dissolution and, for example, preferably more than or equal to 5 nm and less than or equal to 50 nm.

Note that because the film 516 is formed before the electrolytic solution is injected, the formation of the film 516 does not cause the decomposition of the electrolytic solution. Therefore, the provision of the film 516 can inhibit the decomposition of the electrolytic solution which is otherwise caused by the later electrolytic solution injection and can reduce a loss in the capacity of the battery cell.

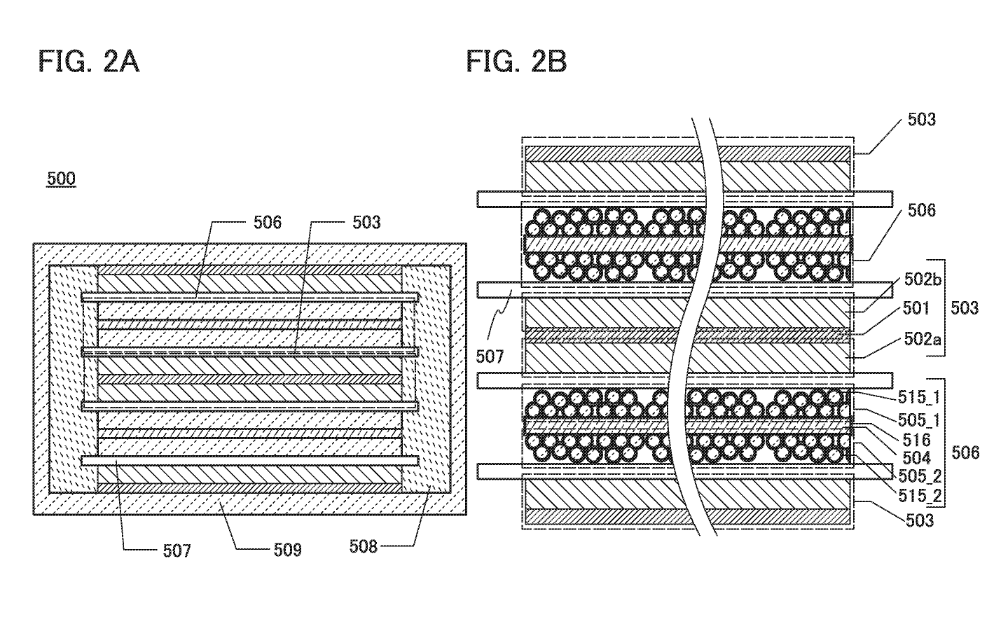

FIG. 2(A) illustrates a battery cell including the negative electrode 506 illustrated in FIG. 1, and FIG. 2(B) is an enlarged view of a positive electrode 503, the negative electrode 506, and a separator 507 which are included in a battery cell 500 illustrated in FIG. 2(A). The battery cell 500 includes the positive electrode 503, the negative electrode 506, the separator 507 sandwiched between the positive electrode 503 and the negative electrode 506, an electrolytic solution 508, and an exterior body 509. The space inside the exterior body 509 is filled with the electrolytic solution 508. Note that although the positive electrode 503 includes a positive electrode current collector 501 and positive electrode active material layers 502a and 502b which face each other with the positive electrode current collector 501 provided therebetween, the structure is not limited thereto; a structure not provided with one of the positive electrode active material layers 502a and 502b may be employed as well. Furthermore, although the negative electrode 506 includes the negative electrode current collector 504 and negative electrode active material layers 505_1 and 505_2 which face each other with the negative electrode current collector 504 provided therebetween, the structure is not limited thereto; a structure not provided with one of the negative electrode active material layers 505_1 and 505_2 may be employed as well. Furthermore, a film 515_1 and a film 515_2 are in contact with the negative electrode active material layer 505_1 and the negative electrode active material layer 505_2, respectively. In addition, the film 516 covers the negative electrode current collector 504. Note that although the positive electrode active material layer 502a and the positive electrode active material layer 502b illustrated in FIG. 2(B) are provided in contact with the positive electrode current collector 501 like the negative electrode active material layer 505_1 and the negative electrode active material layer 505_2, they are illustrated as having a layered shape for simplification of the drawing.

Here, the operation of the battery cell 500 will be described. The case where the battery cell 500 is a lithium-ion battery will be described as an example. In addition, LiFePO₄ and graphite are used as a positive electrode active material and a negative electrode active material, respectively, in the lithium-ion battery described here as an example; however, active materials used for the storage battery of one embodiment of the present invention are not limited thereto.

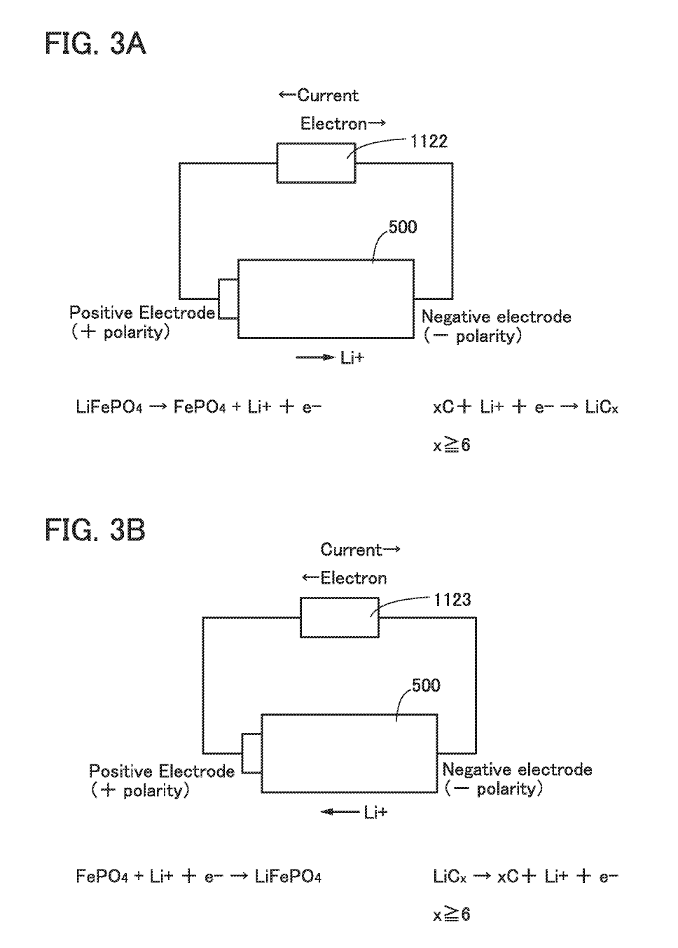

FIG. 3(A) illustrates a connection structure of the battery cell 500 and a charger 1122 when a lithium-ion secondary battery is charged. In the case where the battery cell 500 is a lithium-ion secondary battery, a reaction expressed by Mathematical Formula (1) occurs in the positive electrode in charging.

[Mathematical Formula 1]

LiFePO₄→FePO₄+Li⁺+e⁻ (1)

In addition, a reaction expressed by Mathematical Formula (2) below (see Li⁺ in FIG. 1) occurs in the negative electrode in charging.

[Mathematical Formula 2]

xC+Li⁺+e⁻→LiCₓ x≧6 (2)

Here, for example, an electrolytic solution is decomposed around a surface of the electrode at a battery reaction potential in some cases. Such a decomposition reaction is an irreversible reaction in many cases and thus might lead to a loss in the capacity of the battery cell. Particularly in the negative electrode, the battery reaction potential is low, which easily causes the reductive decomposition of an electrolytic solution, easily reducing the capacity.

Here, the reactions in the negative electrode will be described in more detail. The reaction expressed by Mathematical Formula (2) is referred to as the first reaction.

A reaction other than the reaction expressed by Mathematical Formula (2) in charging occurs in the negative electrode in some cases. For example, an electrolytic solution might be decomposed around the surface of the electrode. Furthermore, for example, in the case of using an ionic liquid as a solvent of an electrolytic solution, cations or the like of the ionic liquid might be intercalated into each gap between layers of an active material. These reactions are irreversible in many cases. An irreversible reaction among the reactions other than Mathematical Formula (2) is referred to as the second reaction.

Since the second reaction is an irreversible reaction, when the second reaction occurs, the discharge capacity becomes lower than the charge capacity. Furthermore, the negative electrode current collector might be eluded by the reaction between the negative electrode current collector and the electrolytic solution (the second reaction), so that a component of the negative electrode current collector might be precipitated on the surface of the negative electrode active material layer. Thus, the second reaction leads to a reduction in the capacity of the battery cell. This is why no second reaction is preferably caused if possible.

In order to suppress the above-described second reaction, this embodiment employs the structure in which the film covering the negative electrode current collector is provided by oxidation of the surface of the negative electrode current collector as in FIG. 1. In this way, the region in which the negative electrode current collector is in contact with the electrolytic solution is reduced, which suppresses the occurrence of the second reaction, leading to an appropriate occurrence of the first reaction.

Furthermore, the second reaction might cause formation of a film on the surface of the negative electrode. The formed film serves as a passivating film in some cases. This passivating film may allow inhibition of a decomposition reaction of ions other than lithium ions by charge or discharge. Accordingly, a decrease in the capacity of the battery cell is possibly inhibited by the film.

Next, discharging will be described. FIG. 3(B) illustrates a connection structure of the battery cell 500 and a charger 1123 when the lithium-ion secondary battery is discharged. A reaction expressed by Mathematical Formula (3) occurs in the positive electrode in discharging.

[Mathematical Formula 3]

FePO₄+Li⁺+e⁻→LiFePO₄ (3)

In addition, a reaction expressed by Mathematical Formula (4) below occurs in the negative electrode in discharging.

[Mathematical Formula 4]

LiCₓ→xC+Li⁺+e⁻ x≧6 (4)

The case where an irreversible reaction such as the decomposition of an electrolytic solution occurs other than the reaction (4) in the negative electrode will be described. In that case, the charge capacity in the next charge and discharge cycle might become lower than the discharge capacity. That is to say, when irreversible reactions repeatedly occur, the capacity might gradually decrease with the increasing number of charge and discharge cycles.

Here, the second reaction that occurs in the case of using an ionic liquid as a solvent of an electrolytic solution will be described in detail.

Cations and anions in an ionic liquid have charge and thus can form an electric double layer at a surface of an electrode, for example. Therefore, an ionic liquid can be used in a power storage device such as an electric double-layer capacitor.

However, cations and anions in an ionic liquid might be decomposed around a surface of an electrode. Most decomposition reactions are irreversible and accordingly might reduce the capacity of a battery cell.

Cations and anions in an ionic liquid are intercalated into each gap between layers of an intercalation compound typified by graphite and deintercalated from the gap after the intercalation in some cases.

These irreversible reactions are examples of the second reaction. The second reaction presumably occurs concurrently with the reactions expressed by Mathematical Formula (1) to Mathematical Formula (4). It is preferred that an environment where normal reactions in a battery operation, that is, the reactions expressed by Mathematical Formula (1) to Mathematical Formula (4) occur more easily than the second reaction be created, because the capacity of a battery cell increases.

With the structure in which the film covering the negative electrode current collector is provided by oxidizing the surface of the negative electrode current collector as in FIG. 1 in one embodiment of the present invention, a region where the surface of the negative electrode current collector is exposed can be reduced, so that the decomposition of the electrolytic solution can be inhibited. Moreover, the elution of the negative electrode current collector can be inhibited.

Next, the relation between the positive electrode 503 and the negative electrode 506 in the battery cell 500 in terms of the sizes and positions will be described. The areas of the positive electrode and the negative electrode in the battery cell 500 are preferably substantially equal. For example, the areas of the positive electrode and the negative electrode that face each other with the separator therebetween are preferably substantially equal. For example, the areas of the positive electrode active material layer and the negative electrode active material layer that face each other with the separator therebetween are preferably substantially equal.

For example, in FIG. 2(B), the area of the positive electrode 503 on the separator 507 side is preferably substantially equal to the area of the negative electrode 506 on the separator 507 side. When the area of a surface of the positive electrode 503 on the negative electrode 506 side is substantially equal to the area of a surface of the negative electrode 506 on the positive electrode 503 side, the region where the negative electrode does not overlap with the positive electrode can be small (does not exist, ideally), whereby the battery cell can have reduced irreversible capacity, which is preferable. Alternatively, in FIG. 2(B), the area of the positive electrode active material layer 502a on the separator 507 side is preferably substantially equal to the area of the negative electrode active material layer 505_1 on the separator 507 side.

Furthermore, an end portion of the positive electrode 503 and an end portion of the negative electrode 506a are preferably substantially aligned with each other as illustrated in the example in FIG. 2(B). Alternatively, end portions of the positive electrode active material layer 502a and the negative electrode active material layer 505_1 are preferably substantially aligned with each other.

Here, the case of using an ionic liquid as a solvent of an electrolytic solution will be described. Cations and anions in the ionic liquid have charge and thus are believed to more easily exist around a surface of an electrode, for example, in the vicinity of a surface of an active material layer or a current collector than molecules in an organic solvent or the like. Accordingly, a decomposition reaction around the surface of the active material layer or the current collector probably occurs more easily. Moreover, a battery reaction of carrier ions such as lithium ions might be hindered. Thus, in the case of using an ionic liquid as a solvent of an electrolytic solution, an influence of the distribution of an electric field or the lithium concentration might be more significant.

Next, an example of an ionic liquid that can be used as a solvent of an electrolytic solution will be described.

In the case of using, as a solvent of an electrolytic solution, an ionic liquid containing an aliphatic onium cation such as a quaternary ammonium cation, a tertiary sulfonium cation, or a quaternary phosphonium cation, which has a lower reduction potential than an ionic liquid containing an aromatic cation such as an imidazolium cation, the irreversible capacity of a storage battery can be reduced in some cases. The ionic liquid, however, has a high viscosity and thus has low ionic (e.g., lithium ionic) conductivity. Furthermore, in the case of using the ionic liquid in a lithium-ion battery, the resistance of the ionic liquid (specifically, an electrolyte containing the ionic liquid) is increased in a low temperature environment (particularly at 0° C. or lower) and thus it is difficult to increase the charge and discharge rate.

An ionic liquid containing an aromatic cation such as an imidazolium cation is preferably used as a solvent of an electrolytic solution because it has a lower viscosity than an ionic liquid containing a cation of an aliphatic compound and can increase the charge and discharge rate. An aromatic cation such as an imidazolium cation, however, might be reductively decomposed easily at surfaces of an active material and a current collector, which are constituent materials of a battery cell. As a result, irreversible capacity might increase. Furthermore, the capacity might be reduced with the increasing number of charge and discharge cycles. These phenomena are possibly due to the high reduction potential of an aromatic cation such as an imidazolium cation. Moreover, these phenomena are possibly due to the structure of an imidazolium cation, for example. Thus, it is particularly preferred that the reductive decomposition of an aromatic cation such as an imidazolium cation at surfaces of an active material and a current collector, which are constituent materials of a battery cell, be inhibited.

Furthermore, for example, an ionic liquid containing an aliphatic onium cation such as a quaternary ammonium cation, a tertiary sulfonium cation, or a quaternary phosphonium cation has a relatively low reduction potential but might be reductively decomposed at surfaces of an active material and a current collector, which are constituent materials of a battery cell, in charge and discharge cycles at a high temperature, for example.

According to one embodiment of the present invention, for example, the decomposition reaction of an electrolytic solution at the surfaces of the active material layer, the current collector, and the like of the battery cell 500 can be inhibited, increasing the capacity of the battery cell.

Furthermore, an irreversible reaction with the electrolytic solution 508 might also occur at the surfaces of the negative electrode current collector 504 and the positive electrode current collector 501. Thus, the positive electrode current collector 501 and the negative electrode current collector 504 are preferably less likely to react with the electrolytic solution.

For example, as the positive electrode current collector 501 and the negative electrode current collector 504, a metal such as stainless steel, gold, platinum, zinc, iron, nickel, copper, aluminum, titanium, tantalum, or manganese, an alloy containing any of the metals, sintered carbon, or the like can be used. Alternatively, copper or stainless steel may be coated with carbon, nickel, titanium, or the like. Alternatively, an aluminum alloy to which an element that improves heat resistance, such as silicon, neodymium, scandium, or molybdenum, is added can be used. Still alternatively, a metal element that forms silicide by reacting with silicon can be used. Examples of the metal element that forms silicide by reacting with silicon include zirconium, titanium, hafnium, vanadium, niobium, tantalum, chromium, molybdenum, tungsten, cobalt, nickel, and the like.

Furthermore, stainless steel or the like is preferably used, in which case a reaction with an electrolytic solution can become weak in some cases.

The positive electrode current collector 501 and the negative electrode current collector 504 can each have any of various shapes including a foil-like shape, a plate-like shape (sheet-like shape), a net-like shape, a cylindrical shape, a coil shape, a punching-metal shape, an expanded-metal shape, a porous shape, and a shape of non-woven fabric as appropriate. Moreover, the positive electrode current collector 501 and the negative electrode current collector 504 may be formed to have micro irregularities on the surface thereof in order to enhance adhesion to the active material layer. The positive electrode current collector 501 and the negative electrode current collector 504 preferably have a thickness of more than or equal to 5 μm and less than or equal to 30 μm.

Furthermore, the positive electrode 503 and the negative electrode 506 may each include a tab region. The tab region may be connected to a lead electrode serving as a terminal of a battery cell. For example, a lead electrode may be welded to part of the tab region. In the tab region provided for the positive electrode 503, at least part of the positive electrode current collector is preferably exposed. In the tab region provided for the negative electrode 506, at least part of the negative electrode current collector is preferably exposed. Exposure of part of the current collector can reduce contact resistance between the lead electrode and the current collector.

Exposure of the surface of the current collector, however, might easily cause a reaction between the electrolytic solution 508 and the current collector. Therefore, it is preferable that the area of a region of the surface of the current collector that is exposed is small or does not exist.

The positive electrode active material layer includes a positive electrode active material. As the positive electrode active material, a material into and from which lithium ions can be inserted and extracted can be used; for example, a material having an olivine structure, a layered rock-salt structure, a spinel structure, or a NASICON crystal structure, or the like can be used. A material that can be used for the positive electrode active material will be described in detail in a later embodiment.

The negative electrode active material layer includes a negative electrode active material. As the negative electrode active material, for example, a carbon-based material, an alloy-based material, or the like can be used. A material that can be used as the negative electrode active material will be described in detail in a later embodiment.

The positive electrode active material layer and the negative electrode active material layer may further include a conductive additive. As the conductive additive, a carbon material, a metal material, a conductive ceramic material, or the like can be used, for example. Alternatively, a fiber material may be used as the conductive additive. A material that can be used as the conductive additive will be described in detail in a later embodiment.

The positive electrode active material layer and the negative electrode active material layer may further include a binder. A material that can be used as the binder will be described in detail in a later embodiment.

As the separator 507, the one formed using paper; nonwoven fabric; glass fiber; ceramics; synthetic fiber containing nylon (polyamide), vinylon (polyvinyl alcohol-based fiber), polyester, acrylic, polyolefin, or polyurethane; or the like can be used.

A solvent of the electrolytic solution 508 preferably contains an ionic liquid (also referred to as a room temperature molten salt) that has non-flammability and non-volatility. Either one kind of ionic liquid or a combination of some kinds of ionic liquids is used. The use of the electrolytic solution 508 containing an ionic liquid can prevent a battery cell from exploding or catching fire even when the battery cell internally shorts out or the internal temperature increases owing to overcharging or the like. An ionic liquid is composed of cations and anions. The ionic liquid contains organic cations and anions. Examples of the organic cation include aromatic cations such as an imidazolium cation and a pyridinium cation and aliphatic onium cations such as a quaternary ammonium cation, a tertiary sulfonium cation, and a quaternary phosphonium cation. Moreover, examples of the anion include a monovalent amide anion, a monovalent methide anion, a fluorosulfonate anion, a perfluoroalkylsulfonate anion, a tetrafluoroborate anion, a perfluoroalkylborate anion, a hexafluorophosphate anion, and a perfluoroalkylphosphate anion. An ionic liquid that can be used as a solvent of the electrolytic solution 508 will be described in detail in Embodiment 2.

As a solvent of the electrolytic solution 508, an aprotic organic solvent may be mixed into any of the above ionic liquids. As the aprotic organic solvent, for example, one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds of these solvents can be used in an appropriate combination in an appropriate ratio.

Furthermore, an additive agent such as vinylene carbonate, propane sultone (PS), tert-butylbenzene (TBB), fluoroethylene carbonate (FEC), or lithium bis(oxalato)borate (LiBOB) may be added to the electrolytic solution. The concentration of such an additive agent in the whole solvent is, for example, higher than or equal to 0.1 weight % and lower than or equal to 5 weight %.

In the case of using lithium ions as carriers, as an electrolyte dissolved in the above-described solvent, one kind of lithium salt such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(FSO₂)₂, LiN(CF₃SO₂)₂, LiN(C₄F₉SO₂) (CF₃SO₂), or LiN(C₂F₅SO₂)₂, which is an alkali metal salt, can be used, or two or more kinds of them can be used in an appropriate combination at an appropriate ratio, for example. Furthermore, the concentration of the electrolyte is preferably high and, for example, higher than or equal to 0.8 mol/kg, further preferably higher than or equal to 1.5 mol/kg.

As the electrolytic solution used for a battery cell, an electrolytic solution which is highly purified and contains a small amount of dust particles and elements other than the constituent elements of the electrolytic solution (hereinafter, also simply referred to as impurities) is preferably used. Specifically, the weight ratio of impurities to the electrolytic solution is less than or equal to 1%, preferably less than or equal to 0.1%, and further preferably less than or equal to 0.01%.

Alternatively, a gelled electrolyte obtained in such a manner that a polymer is swelled with an electrolytic solution may be used. Examples of the gelled electrolyte (polymer-gel electrolyte) include a host polymer that is used as a support and contains the electrolytic solution described above.

Examples of the host polymer are described below. As the host polymer, for example, a polymer having a polyalkylene oxide structure, such as polyethylene oxide (PEO); poly(vinylidene fluoride) (PVdF); polyacrylonitrile or the like; or a copolymer containing any of them can be used. For example, PVdF-HFP, which is a copolymer of PVdF and hexafluoropropylene (HFP) can be used. The formed polymer may be porous.

In combination with the electrolytic solution, a solid electrolyte including an inorganic material such as a sulfide-based inorganic material or an oxide-based inorganic material, or a solid electrolyte including a macromolecular material such as a PEO (polyethylene oxide)-based macromolecular material may be used. For example, the solid electrolyte may be formed over a surface of the active material layer. In the case of using the solid electrolyte and the electrolytic solution in combination, a separator and a spacer do not need to be provided in some cases.

It is preferred that the surface of the exterior body 509 that is in contact with the electrolytic solution, i.e., the inner surface of the exterior body 509, not react with the electrolytic solution significantly. When moisture enters the battery cell 500 from the outside, a reaction between a component of the electrolytic solution or the like and water might occur. Thus, the exterior body 509 preferably has low moisture permeability.

### [Thin Storage Battery]

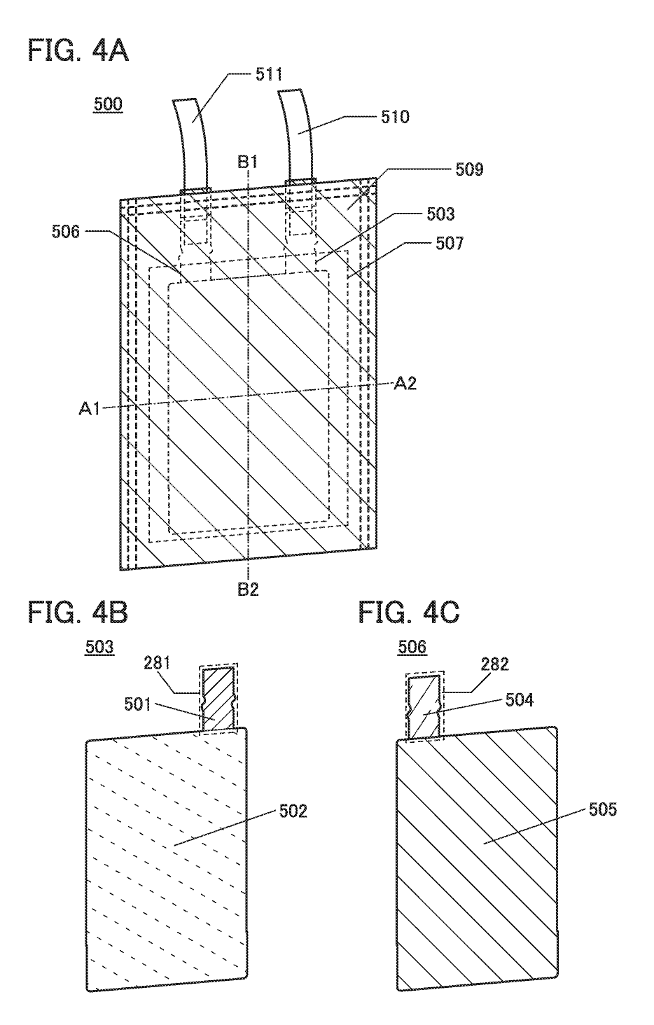

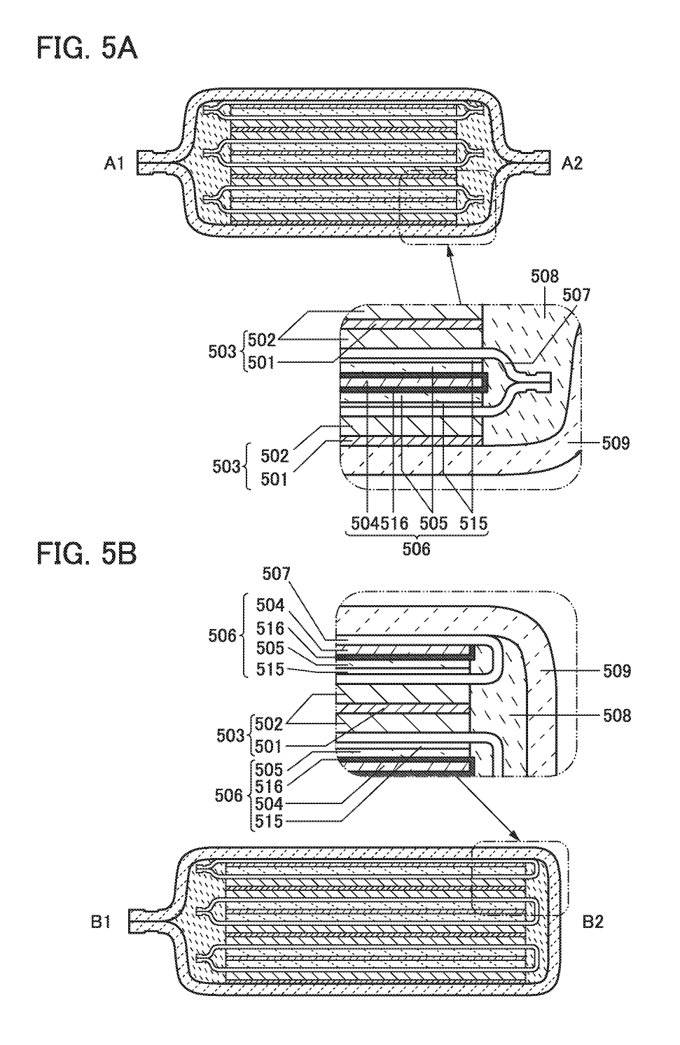

An example of the battery cell 500 fabricated according to one embodiment of the present invention will be described with reference to FIG. 4. FIG. 4(A) illustrates a thin storage battery as an example of the battery cell 500. FIG. 5(A) shows a cross section along dashed-dotted line A1-A2 in FIG. 4. FIG. 5(B) shows a cross section along dashed-dotted line B1-B2 in FIG. 4. The battery cell 500 includes the positive electrode 503, the negative electrode 506, the separator 507, the exterior body 509, a positive electrode lead electrode 510, and a negative electrode lead electrode 511.

FIG. 4(B) is an external view of the positive electrode 503. Here, the positive electrode 503 includes the positive electrode current collector 501 and the positive electrode active material layer 502. The positive electrode 503 preferably includes the tab region 281. The positive electrode lead electrode 510 is preferably welded to part of the tab region 281. The tab region 281 preferably includes a region where the positive electrode current collector 501 is exposed. When the positive electrode lead electrode 510 is welded to the region where the positive electrode current collector 501 is exposed, contact resistance can be further reduced. Although FIG. 4(B) illustrates the example where the positive electrode current collector 501 is exposed in the entire tab region 281, the tab region 281 may partly include the positive electrode active material layer 502.

Furthermore, FIG. 4(C) shows an external view of the negative electrode 506.

Here, the negative electrode 506 includes the negative electrode current collector 504, the negative electrode active material layer 505, and the films 515 and 516 illustrated in FIG. 5. Since the film 515 is formed by the above-described second reaction, it includes at least one of elements constituting the negative electrode active material layer 505 and elements constituting the electrolytic solution. Note that although the negative electrode active material layer and the film 515 are illustrated as having a layered shape for simplification of the drawing, they actually have the structure illustrated in FIG. 1. Since the film 516 is formed by oxidation of the surface of the negative electrode current collector 504 by heating, it includes an oxide including at least one metal element included in the negative electrode current collector 504. The negative electrode 506 preferably includes the tab region 282. The negative electrode lead electrode 511 is preferably welded to part of the tab region 282. The tab region 282 preferably includes a region where the negative electrode current collector 504 is exposed. When the negative electrode lead electrode 511 is welded to the region where the negative electrode current collector 504 is exposed, contact resistance can be further reduced. Although FIG. 4(C) illustrates the example where the negative electrode current collector 504 is exposed in the entire tab region 282, the tab region 282 may partly include the negative electrode active material layer 505.

The use of a flexible exterior body allows the thin storage battery illustrated in FIG. 4(A) to have a flexible structure. With the flexible structure, the flexible portion can be used in an electronic device at least part of which is flexible, and the storage battery can be bent as the electronic device is bent.

Although FIG. 4(A) illustrates the example where the end portions of the positive electrode and the negative electrode are substantially aligned with each other, at least part of the end portion of the positive electrode may extend beyond the end portion of the negative electrode.

The battery cell 500 may include the positive electrode lead electrode 510 and the negative electrode lead electrode 511. The positive electrode lead electrode 510 is preferably electrically connected to the positive electrode 503. For example, the positive electrode lead electrode 510 may be welded to the tab region 281 of the positive electrode 503. Similarly, the negative electrode lead electrode 511 is preferably electrically connected to the negative electrode 506. For example, the negative electrode lead electrode 511 may be welded to the tab region 282 of the negative electrode 506. The positive electrode lead electrode 510 and the negative electrode lead electrode 511 are preferably exposed to the outside of the exterior body so as to serve as terminals for electrical contact with an external portion.

The positive electrode current collector 501 and the negative electrode current collector 504 can double as terminals for electrical contact with an external portion. In that case, the positive electrode current collector 501 and the negative electrode current collector 504 may be arranged so that part of the positive electrode current collector 501 and part of the negative electrode current collector 504 are exposed to the outside of the exterior body 509 without using lead electrodes.

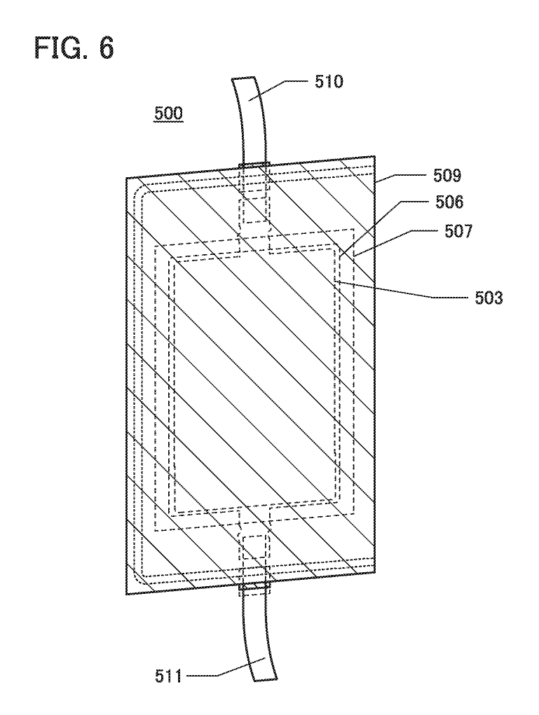

Although the positive electrode lead electrode 510 and the negative electrode lead electrode 511 are provided on the same side of the storage battery in FIG. 4, the positive electrode lead electrode 510 and the negative electrode lead electrode 511 may be provided on different sides of a storage battery as illustrated in FIG. 6. The lead electrodes of a storage battery of one embodiment of the present invention can be freely positioned as described above; therefore, the degree of freedom in design is high. Accordingly, a product including a power storage device (battery cell) of one embodiment of the present invention can have a high degree of freedom in design. Furthermore, a yield of products each including a power storage device (battery cell) of one embodiment of the present invention can be increased.

As the exterior body 509 in the thin storage battery, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

In the above structure, the exterior body 509 of the secondary battery can change its form within a range of a radius of curvature greater than or equal to 10 mm, preferably greater than or equal to 30 mm. One or two films are used as the exterior body of the secondary battery. In the case where the secondary battery has a layered structure, the secondary battery has a cross section sandwiched by two curved lines of the exterior body films when it is curved.

The examples of storage batteries illustrated in FIG. 5 each include three positive electrode-negative electrode pairs. It is needless to say that the number of pairs of electrodes is not limited to three, and may be more than three or less than three. In the case of using a large number of pairs of electrodes, the storage battery can have a high capacity. In contrast, in the case of using a small number of pairs of electrodes, the storage battery can have a smaller thickness and higher flexibility. Furthermore, although FIG. 5 illustrates five positive electrode active material layer-negative electrode active material layer pairs with the positive and negative electrodes of each pair facing each other, it is needless to say that the number of positive electrode active material layer-negative electrode active material layer pairs is not limited to five.

### [Fabricating Method of Thin Storage Battery]

Next, an example of a fabricating method of the battery cell 500 in the case where the battery cell 500 is a thin storage battery will be described.

Next, the positive electrode 503, the negative electrode 506, and the separator 507 are stacked.

First, the separator 507 is positioned over the positive electrode 503. Then, the negative electrode 506 is positioned over the separator 507. In the case of using two or more positive electrode-negative electrode pairs, another separator is positioned over the negative electrode 506, and then, the positive electrode 503 is positioned. In this manner, the positive electrodes and the negative electrodes are alternately stacked and separated by the separator.

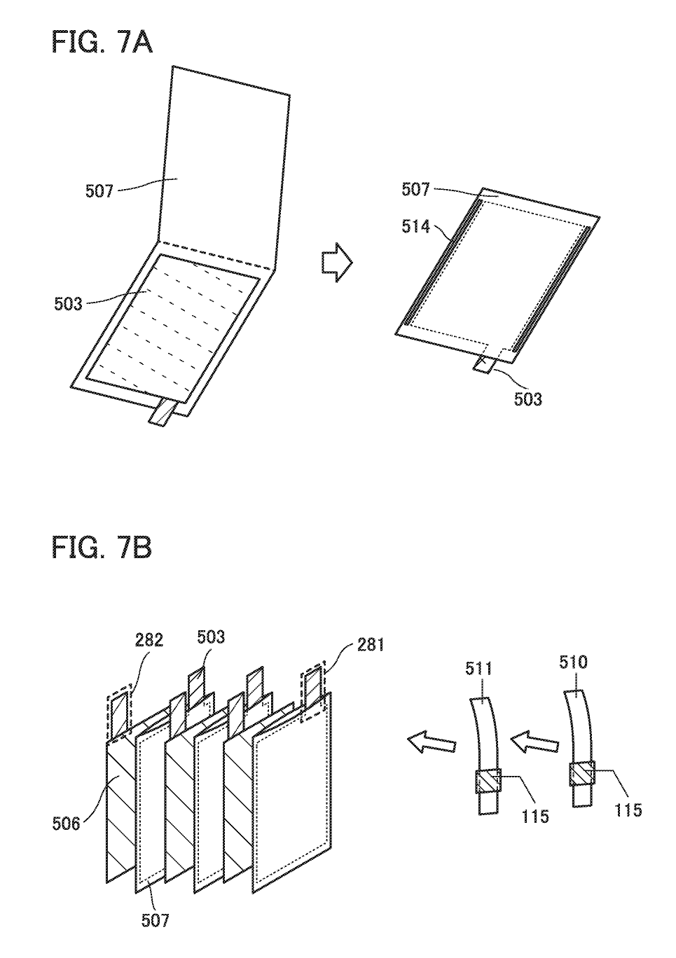

Alternatively, the separator 507 may have a bag-like shape. First, the positive electrode 503 is positioned over the separator 507. Then, the separator 507 is folded along a broken line in FIG. 7(A) so that the positive electrode 503 is sandwiched by the separator 507. Although the example where the positive electrode 503 is sandwiched by the separator 507 is described here, the negative electrode 506 may be sandwiched by the separator 507.

Here, it is preferable that the outer edges of the separator 507 outside the positive electrode 503 be bonded so that the separator 507 has a bag-like shape (or an envelope-like shape). The bonding of the outer edges of the separator 507 can be performed with the use of an adhesive or the like, by ultrasonic welding, or by thermal fusion bonding.

In this embodiment, polypropylene is used as the separator 507 and the outer edges of the separator 507 are bonded by heating. Bonding portions 514 are illustrated in FIG. 7(A). In such a manner, the positive electrode 503 can be covered with the separator 507.

Then, the negative electrodes 506 and the positive electrodes 503 each covered with the separator are alternately stacked as illustrated in FIG. 7(B). Furthermore, the positive electrode lead electrode 510 and the negative electrode lead electrode 511 each having a sealing layer 115 are prepared.

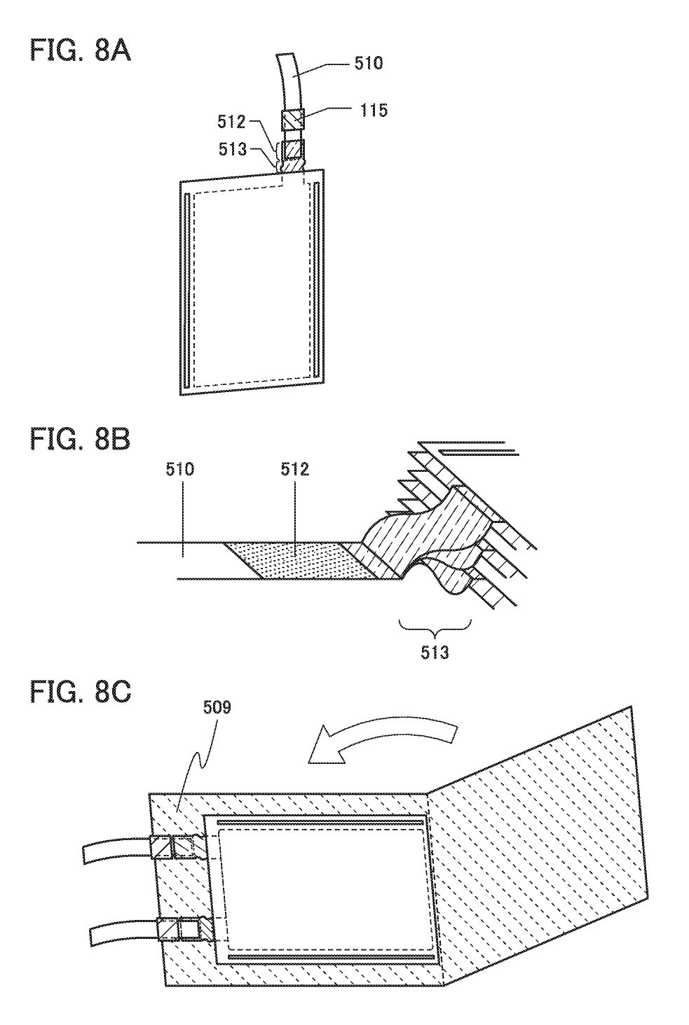

After that, the positive electrode lead electrode 510 having the sealing layer 115 is connected to the tab region 281 of the positive electrode 503 as illustrated in FIG. 8(A). FIG. 8(B) is an enlarged view of a connection portion. The tab region 281 of the positive electrode 503 and the positive electrode lead electrode 510 are electrically connected to each other by irradiating the bonding portion 512 with ultrasonic waves while applying pressure thereto (ultrasonic welding). In that case, a curved portion 513 is preferably provided in the tab region 281.

This curved portion 513 can relieve stress due to external force applied after fabrication of the battery cell 500. Thus, the battery cell 500 can have high reliability.

Next, the negative electrode lead electrode 511 is electrically connected to the tab region 282 of the negative electrode 506 by a similar method.

Subsequently, the positive electrode 503, the negative electrode 506, and the separator 507 are positioned over the exterior body 509.

Then, the exterior body 509 is folded along a portion shown by a dotted line in the vicinity of a center portion of the exterior body 509 in FIG. 8(C).

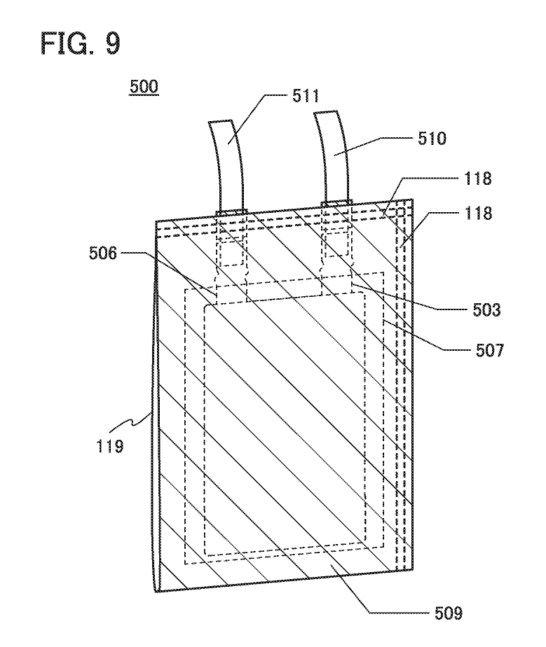

Next, in FIG. 9, the thermocompression bonding portion in the outer edges of the exterior body 509 is illustrated as a bonding portion 118. The outer edges of the exterior body 509 except an inlet 119 for introducing the electrolytic solution 508 are bonded by thermocompression bonding. In thermocompression bonding, the sealing layers 115 provided over the lead electrodes are also melted, thereby fixing the lead electrodes and the exterior body 509 to each other. Moreover, adhesion between the exterior body 509 and the lead electrodes can be increased.

After that, in a reduced-pressure atmosphere or an inert gas atmosphere, a desired amount of electrolytic solution 508 is introduced to the inside of the exterior body 509 from the inlet 119. Lastly, the inlet 119 is sealed by thermocompression bonding. Through the above steps, the battery cell 500, which is a thin storage battery, can be fabricated.

Next, aging after fabrication of the battery cell 500 will be described. Aging is preferably performed after fabrication of the battery cell 500. The aging can be performed under the following conditions, for example. Charge is performed at a rate of more than or equal to 0.001 C and less than or equal to 0.2 C at a temperature higher than or equal to room temperature and lower than or equal to 50° C. In the case where an electrolytic solution is decomposed and a gas is generated and accumulated in the cell, the electrolytic solution cannot be in contact with a surface of the electrode in some regions. That is to say, an effectual reaction area of the electrode is reduced and effectual current density is increased.

When the current density is extremely high, a voltage drop occurs depending on the resistance of the electrode, lithium is intercalated into graphite and, and at the same time, lithium is deposited on the surface of graphite. The lithium deposition might reduce capacity. For example, if a coating film or the like is grown on the surface after lithium deposition, lithium deposited on the surface cannot be dissolved again. This lithium cannot contribute to capacity. In addition, when deposited lithium is physically collapsed and conduction with the electrode is lost, the lithium also cannot contribute to capacity. Therefore, the gas is preferably released before the potential of the electrode reaches the potential of lithium because of a voltage drop.

In the case of performing degasification, for example, part of the exterior body of the thin storage battery is cut to open the storage battery. When the exterior body is expanded because of a gas, the form of the exterior body is preferably adjusted again. Furthermore, the electrolytic solution may be added as needed before resealing.

After the release of the gas, the charging state may be maintained at a temperature higher than room temperature, preferably higher than or equal to 30° C. and lower than or equal to 60° C., further preferably higher than or equal to 35° C. and lower than or equal to 50° C. for, for example, more than or equal to 1 hour and less than or equal to 100 hours. In the initial charge, an electrolytic solution decomposed on the surface forms a coating film. The formed coating film may thus be densified when the charging state is held at a temperature higher than room temperature after the release of the gas, for example.

For example, in storage batteries provided in electronic devices that can be repeatedly folded, exterior bodies gradually deteriorate and cracks are likely to be caused in some cases as the electronic devices are folded repeatedly. Furthermore, the contact between a surface of an active material and the like and an electrolytic solution by charge and discharge causes a decomposition reaction of the electrolytic solution, which might generate a gas or the like. When expanded because of generation of a gas, the exterior bodies are more likely to be damaged as the electronic devices are folded. The decomposition of an electrolytic solution can be inhibited by using one embodiment of the present invention; thus, for example, generation of a gas by charge and discharge can be inhibited in some cases. Consequently, expansion, deformation, damage, and the like of the exterior bodies can be suppressed. This reduces a load on the exterior body, which is preferable.

The use of the electrode of one embodiment of the present invention leads to inhibition of the decomposition of an electrolytic solution and thus also leads to inhibition of excess growth of a coating film in some cases. In the case where the growth of a coating film is large, the resistance of an electrode increases with the increasing number of charge and discharge cycles. Such an increase in resistance promotes the increase of the potential of the electrode to the potential at which lithium is deposited. Furthermore, in a negative electrode, for example, lithium deposition might occur because of stress caused when an electronic device is folded. The electrode of one embodiment of the present invention has durability to stress caused when an electronic device is folded; thus, the use of the electrode leads to, for example, reduction of the possibility of causing lithium deposition in some cases.

In this embodiment, one embodiment of the present invention has been described. Embodiments of the present invention are described in the other embodiments. However, one embodiment of the present invention is not limited to these. In other words, various embodiments of the invention are described in this embodiment and the other embodiments, and one embodiment of the present invention is not limited to a particular embodiment. For example, the example in which one embodiment of the present invention is applied to a lithium-ion secondary battery is described; however, one embodiment of the present invention is not limited thereto. Depending on cases or conditions, one embodiment of the present invention may be used for a variety of power storage devices. For example, depending on cases or conditions, one embodiment of the present invention may be used for a battery, a primary battery, a secondary battery, a lithium-ion secondary battery, a lithium air battery, a lead storage battery, a lithium-ion polymer secondary battery, a nickel-hydrogen storage battery, a nickel-cadmium storage battery, a nickel-iron storage battery, a nickel-zinc storage battery, a silver oxide-zinc storage battery, a solid-state battery, an air battery, a primary battery, a capacitor, a lithium-ion capacitor, and the like.

This embodiment can be implemented in combination with the other embodiments as appropriate.

### Embodiment 2

In this embodiment, a nonaqueous solvent used in a power storage device (battery cell) which is one embodiment of the present invention will be described.

A nonaqueous solvent used in a power storage device (battery cell) of one embodiment of the present invention preferably contains an ionic liquid. Either one kind or a combination of some kinds of ionic liquids is used. The ionic liquid is composed of a cation and an anions; the ionic liquid contains an organic cation and an anion.

As the organic cation, an aromatic cation, an aliphatic onium cation such as a quaternary ammonium cation, a tertiary sulfonium cation, or a quaternary phosphonium cation, or the like is preferably used, for example.

The aromatic cation is preferably a cation having a five-membered heteroaromatic ring, for example. As the cation having a five-membered heteroaromatic ring, there are a benzimidazolium cation, a benzoxazolium cation, a benzothiazolium cation, and the like. As the cation having a five-membered heteroaromatic ring which is a monocyclic compound, there are an oxazolium cation, a thiazolium cation, an isoxazolium cation, an isothiazolium cation, an imidazolium cation, a pyrazolium cation, and the like. In view of the stability, viscosity, and ionic conductivity of the compound and ease of synthesis, the cation having a five-membered heteroaromatic ring which is a monocyclic compound is preferred. In particular, an imidazolium cation is further preferable because it holds promise of reducing viscosity.

Examples of the anion in the above-described ionic liquid include a monovalent amide anion, a monovalent methide anion, a fluorosulfonate anion (SO₃F⁻), a perfluoroalkylsulfonate anion, a tetrafluoroborate anion (BF₄⁻), a perfluoroalkylborate anion, a hexafluorophosphate anion (PF₆⁻), and a perfluoroalkylphosphate anion. An example of the monovalent amide anion is (CₙF₂ₙ₊₁SO₂)₂N⁻ (n=0 to 3). An example of the monovalent cyclic amide anion is (CF₂SO₂)₂N⁻. An example of the monovalent methide anion is (CₙF₂ₙ₊₁SO₂)₃C⁻ (n=0 to 3). An example of the monovalent cyclic methide anion is (CF₂SO₂)₂C⁻(CF₃SO₂). An example of the perfluoroalkylsulfonate anion is (CₘF₂ₘ₊₁SO₃)⁻ (m=0 to 4). An example of the perfluoroalkylborate anion is {BFₙ(CₘHₖF₂ₘ₊₁₋ₖ)₄₋ₙ}⁻ (n=0 to 3, m=1 to 4, and k=0 to 2m). An example of the perfluoroalkylphosphate anion is {PFₙ(CₘHₖF₂ₘ₊₁₋ₖ)₆₋ₙ}⁻ (n=0 to 5, m=1 to 4, and k=0 to 2m). Note that the anion is not limited thereto.

An ionic liquid containing a cation having a five-membered heteroaromatic ring can be expressed by General Formula (G1), for example.

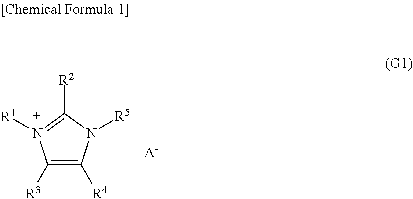

In General Formula (G1), R¹ represents an alkyl group having 1 to 4 carbon atoms; R² to R⁴ each independently represent a hydrogen atom or an alkyl group having 1 to 4 carbon atoms; R⁵ represents a straight chain formed of two or more atoms selected from C, O, Si, N, S, and P; A⁻ represents any one of a monovalent imide anion, a monovalent amide anion, a monovalent methide anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

Furthermore, R⁵ may have a substituent. Examples of the substituent include an alkyl group and an alkoxy group.

Note that the alkyl group of the cation in the ionic liquid represented by General Formula (G1) may be either a straight-chain alkyl group or a branched-chain alkyl group. Examples are an ethyl group and a tert-butyl group. In the cation in the ionic liquid represented by General Formula (G1), it is preferred that R⁵ not have an oxygen-oxygen bond (peroxide). An oxygen-oxygen single bond extremely easily breaks and is highly reactive; thus, the ionic liquid with the bond might be explosive. Thus, a cation having an oxygen-oxygen bond is contained, and the ionic liquid containing the cation is not suitable for battery cells.

Furthermore, the ionic liquid may contain a six-membered heteroaromatic ring. For example, an ionic liquid represented by General Formula (G2) below can be used.

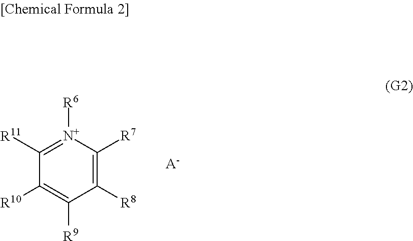

In General Formula (G2), R⁶ represents a straight chain composed of two or more atoms selected from C, O, Si, N, S, and P; R⁷ to R¹¹ each independently represent a hydrogen atom or an alkyl group having 1 to 4 carbon atoms; and A⁻ represents any one of a monovalent imide anion, a monovalent amide anion, a monovalent methide anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

Furthermore, R⁶ may have a substituent. Examples of the substituent include an alkyl group and an alkoxy group.

As an ionic liquid containing a quaternary ammonium cation, an ionic liquid represented by General Formula (G3) below can be used, for example.

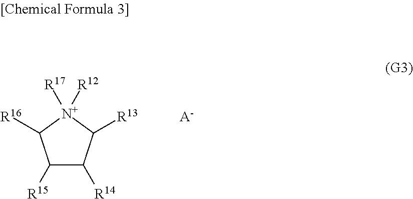

In General Formula (G3), R¹² to R¹⁷ each independently represent an alkyl group, a methoxy group, a methoxymethyl group, or a methoxyethyl group each having 1 to 20 carbon atoms, or a hydrogen atom; and A⁻ represents any one of a monovalent imide anion, a monovalent amide anion, a monovalent methide anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

Furthermore, as the ionic liquid, an ionic liquid containing a quaternary ammonium cation and a monovalent anion and represented by General Formula (G4) below can be used, for example.

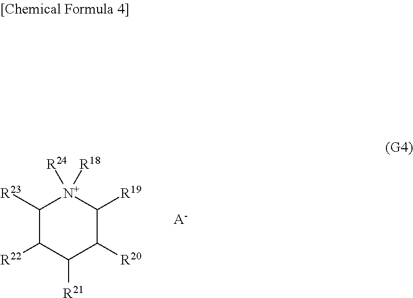

In General Formula (G4), R¹⁸ to R²⁴ each independently represent an alkyl group, a methoxy group, a methoxymethyl group, or a methoxyethyl group each having 1 to 20 carbon atoms, or a hydrogen atom; and A⁻ represents any one of a monovalent imide anion, a monovalent amide anion, a monovalent methide anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the ionic liquid, an ionic liquid containing a quaternary ammonium cation and a monovalent anion and represented by General Formula (G5) below can be used, for example.

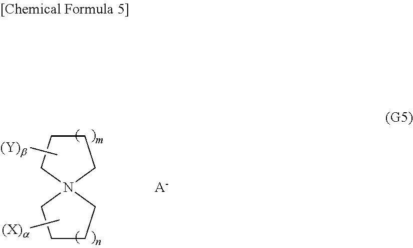

In General Formula (G5), n and m are greater than or equal to 1 and less than or equal to 3. Assume that α is greater than or equal to 0 and less than or equal to 6. When n is 1, α is greater than or equal to 0 and less than or equal to 4. When n is 2, α is greater than or equal to 0 and less than or equal to 5. When n is 3, α is greater than or equal to 0 and less than or equal to 6. Assume that β is greater than or equal to 0 and less than or equal to 6. When m is 1, β is greater than or equal to 0 and less than or equal to 4. When m is 2, β is greater than or equal to 0 and less than or equal to 5. When m is 3, β is greater than or equal to 0 and less than or equal to 6. Note that α or β being 0 means no substitution. In addition, the case where both α and β are 0 is excluded. X or Y represents a substituent such as a straight-chain or side-chain alkyl group having 1 to 4 carbon atoms, a straight-chain or side-chain alkoxy group having 1 to 4 carbon atoms, or a straight-chain or side-chain alkoxyalkyl group having 1 to 4 carbon atoms. Furthermore, A⁻ represents any one of a monovalent imide anion, a monovalent amide anion, a monovalent methide anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

In a quaternary spiro ammonium cation, two aliphatic rings that compose a spiro ring are any of a five-membered ring, a six-membered ring, or a seven-membered ring.

For example, specific examples of the cation represented by General Formula (G1) above include Structural Formula (111) to Structural Formula (174).

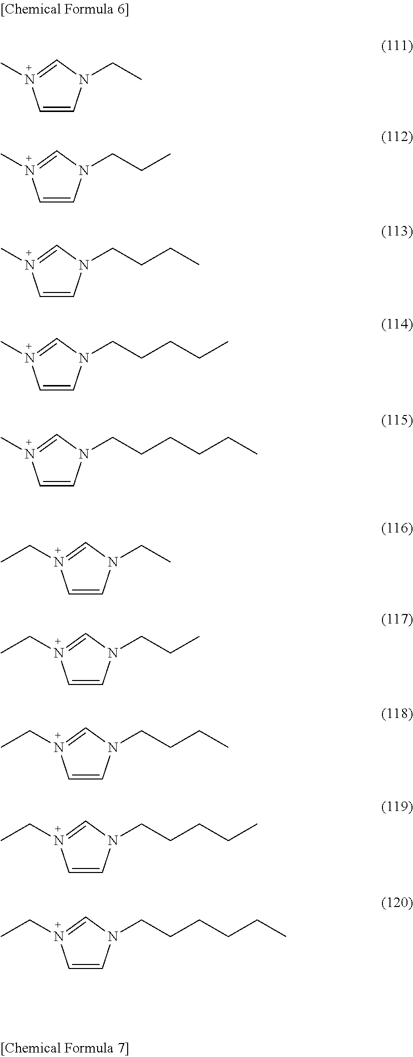

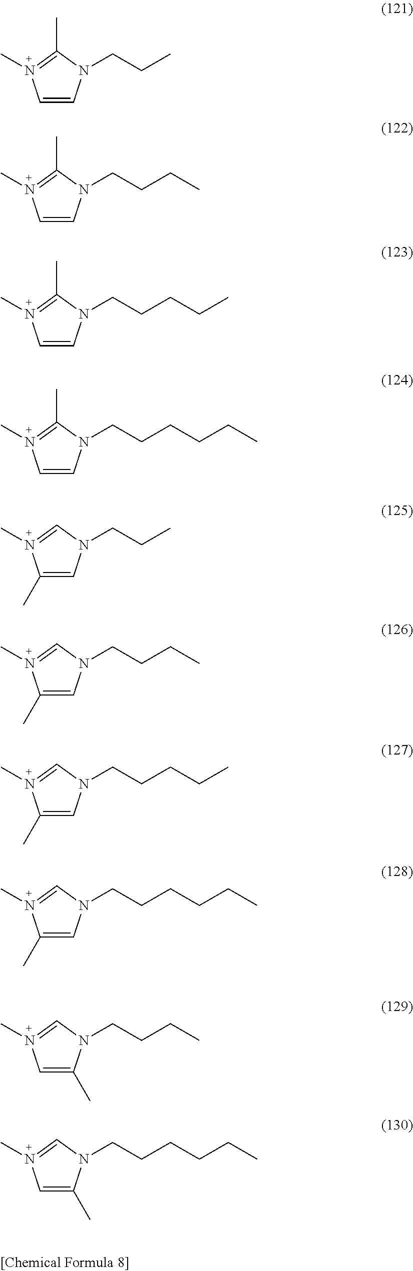

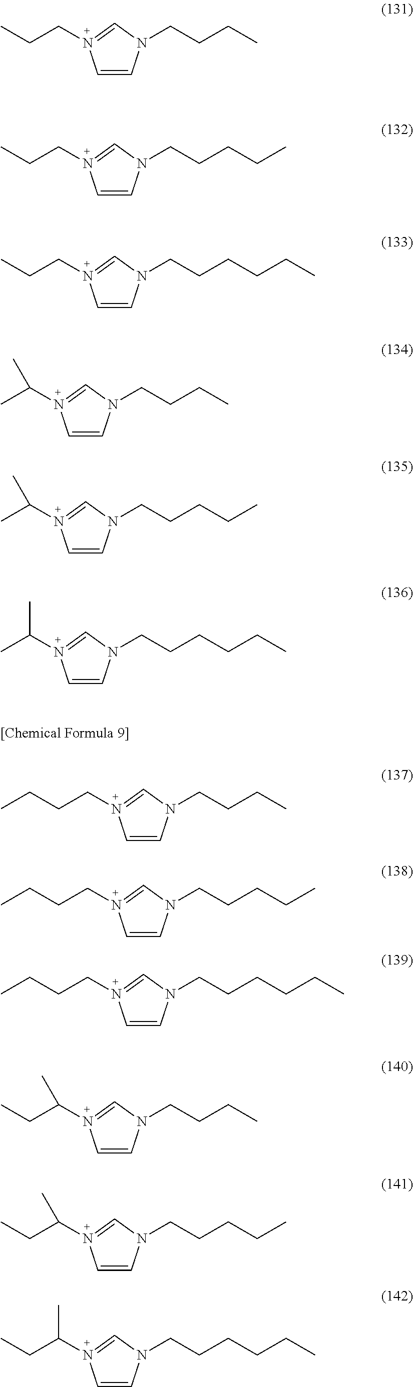

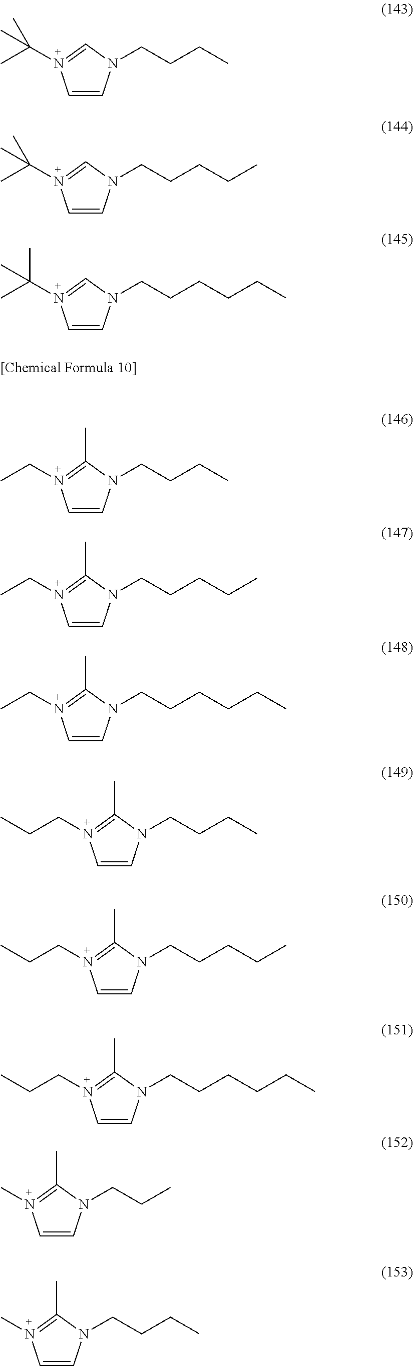

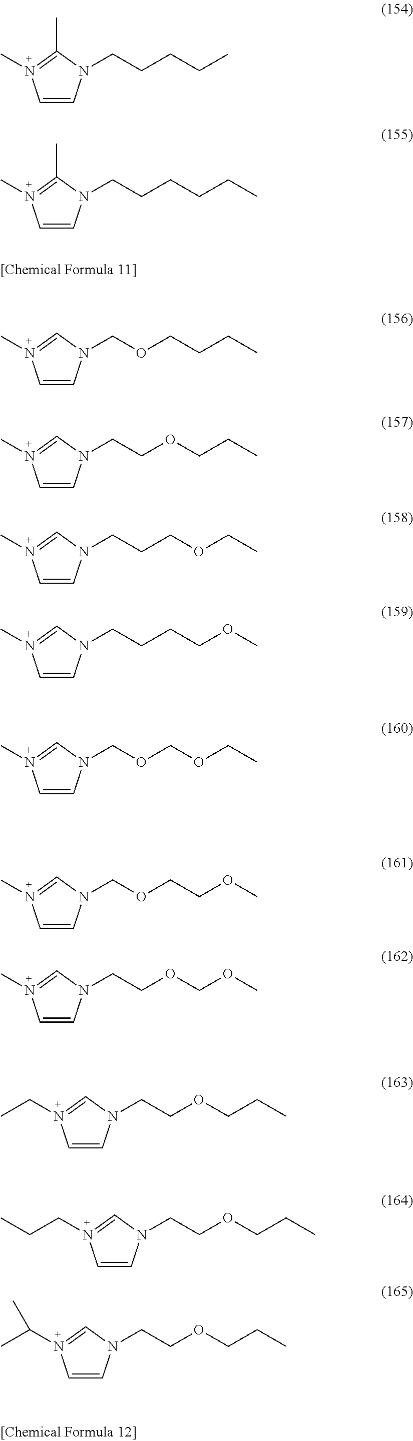

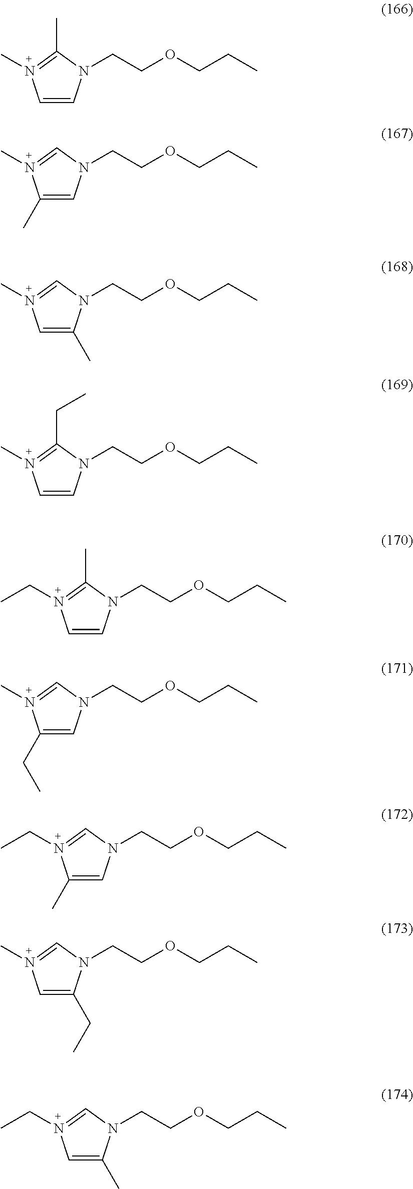

This embodiment can be implemented in combination with the other embodiments as appropriate.

### Embodiment 3

In this embodiment, specific structures and fabricating methods of a positive electrode and a negative electrode that can be used for one embodiment of the present invention will be described.

For the negative electrode current collector 504 and the positive electrode current collector 501, any of the materials for the negative electrode current collector 504 and the positive electrode current collector 501 that are described in Embodiment 1 can be used.

As a negative electrode active material, for example, a carbon-based material, an alloy-based material, or the like can be used. Examples of the carbon-based material include graphite, graphitizing carbon (soft carbon), non-graphitizing carbon (hard carbon), a carbon nanotube, graphene, and carbon black. Examples of graphite include artificial graphite such as meso-carbon microbeads (MCMB), coke-based artificial graphite, and pitch-based artificial graphite and natural graphite such as spherical natural graphite.

Graphite has a low potential substantially equal to that of a lithium metal (higher than or equal to 0.1 V and lower than or equal to 0.3 V vs. Li/Li⁺) when lithium ions are intercalated into the graphite (while a lithium-graphite intercalation compound is formed). For this reason, a lithium-ion secondary battery can have a high operating voltage. In addition, graphite is preferred because of its advantages such as relatively high capacity per unit volume, small volume expansion, low cost, and higher level of safety than that of a lithium metal.

For the negative electrode active material, an alloy-based material or oxide which enables charge-discharge reactions by an alloying reaction and a dealloying reaction with lithium can be used. In the case where carrier ions are lithium ions, a material containing at least one of Mg, Ca, Al, Si, Ge, Sn, Pb, As, Sb, Bi, Ag, Au, Zn, Cd, Hg, In, and the like can be used as the alloy-based material, for example. Such elements have higher capacity than carbon. In particular, silicon has a significantly high theoretical capacity of 4200 mAh/g. For this reason, silicon is preferably used as the negative electrode active material. Examples of an alloy-based material using such elements include Mg₂Si, Mg₂Ge, Mg₂Sn, Sn₅₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, for the negative electrode active material, an oxide such as SiO, SnO, SnO₂, titanium dioxide (TiO₂), lithium titanium oxide (Li₄Ti₅O₁₂), a lithium-graphite intercalation compound (LixC₆), niobium pentoxide (Nb₂O₅), tungsten oxide (WO₂), or molybdenum oxide (MoO₂) can be used.

Still alternatively, for the negative electrode active materials, Li₍₃₋ₓ₎MₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³). A composite nitride of lithium and a transition metal is preferably used as the negative electrode active material because lithium ions are contained in the negative electrode active material and thus the negative electrode active material can be used in combination with a material of a positive electrode active material which does not contain lithium ions, such as V₂O₅ or Cr₃O₈. Even in the case of using a material containing lithium ions as a positive electrode active material, the composite nitride of lithium and a transition metal can be used as the negative electrode active material by extracting lithium ions contained in the positive electrode active material in advance.

Alternatively, a material which causes a conversion reaction can be used for the negative electrode active material. For example, a transition metal oxide which does not cause an alloying reaction with lithium, such as cobalt oxide (CoO), nickel oxide (NiO), or iron oxide (FeO), may be used for the negative electrode active material. Furthermore, as the material which causes a conversion reaction, oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃ can be used.

The reaction potential of the negative electrode active material is preferably as low as possible, in which case the voltage of the battery cell can be high. In contrast, when the potential is low, power of reducing an electrolytic solution is increased, so that an organic solvent or the like used in an electrolytic solution might be subjected to reductive decomposition, for example. The range of potentials in which the electrolysis of an electrolytic solution does not occur is referred to as a potential window. The electrode potential of the negative electrode needs to be within the potential window of the electrolytic solution; however, the potentials of many active materials used for negative electrodes of lithium-ion secondary batteries and lithium-ion capacitors, for example, are out of the potential windows of almost all electrolytic solutions. Specifically, materials with low reaction potentials such as graphite and silicon can increase the voltage of storage batteries but are likely to cause the reductive decomposition of electrolytic solutions.

As the positive electrode active material, a material into and from which lithium ions can be inserted and extracted can be used; for example, a material having an olivine structure, a layered rock-salt structure, a spinel structure, or a NASICON crystal structure, or the like can be used.

For example, as a material of the positive electrode active material, a compound such as LiFeO₂, LiCoO₂, LiNiO₂, LiMn₂O₄, V₂O₅, Cr₂O₅, or MnO₂ can be used.

Alternatively, lithium-containing complex phosphate (general formula: LiMPO₄ (M is one or more of Fe(II), Mn(II), Co(II), and Ni(II))) can be used. Typical examples of LiMPO₄ are lithium metal phosphate compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}NiₐMnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

Alternatively, lithium-containing complex silicate such as Li₍₂₋ⱼ₎MSiO₄ (general formula) (M is one or more of Fe(II), Mn(II), Co(II), and Ni(II); 0≦j≦2) can be used. Typical examples of Li₍₂₋ⱼ₎MSiO₄ (general formula) are lithium silicate compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnᵢSiO₄, Li₍₂₋ⱼ₎NiₖCoₗSiO₄, Li₍₂₋ⱼ₎NiₗMnᵢSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Still alternatively, a NASICON compound expressed by a general formula, AₓM₂(XO₄)₃ (A=Li, Na, or Mg, M=Fe, Mn, Ti, V, Nb, or Al, X=S, P, Mo, W, As, or Si) can be used for the positive electrode active material. Examples of the NASICON compound are Fe₂(MnO₄)₃, Fe₂(SO₄)₃, and Li₃Fe₂(PO₄)₃. Further alternatively, a compound expressed by general formulas Li₂MPO₄F, Li₂MP₂O₇, or Li₅MO₄ (M=Fe or Mn), a perovskite fluoride such as NaF₃ and FeF₃, a metal chalcogenide (a sulfide, a selenide, or a telluride) such as TiS₂ and MoS₂, a material with an inverse spinel crystal structure such as LiMVO₄, a vanadium oxide (V₂O₅, V₆O₁₃, LiV₃O₈, or the like), a manganese oxide, an organic sulfur compound, or the like can be used as the positive electrode active material.

In the case where carrier ions are alkali metal ions other than lithium ions, or alkaline-earth metal ions, a compound in which lithium of the lithium compound, the lithium-containing complex phosphate, or the lithium-containing complex silicate is replaced by carriers such as an alkali metal (e.g., sodium and potassium) or an alkaline-earth metal (e.g., calcium, strontium, barium, beryllium, and magnesium) may be used as the positive electrode active material.

The average particle size of the positive electrode active material is preferably, for example, greater than or equal to 5 nm and less than or equal to 50 μm.

For example, lithium-containing complex phosphate having an olivine structure used for the positive electrode active material has a one-dimensional lithium diffusion path, so that lithium diffusion is slow. Thus, in the case of using lithium-containing complex phosphate having an olivine structure, the average particle size of the positive electrode active material is, for example, preferably greater than or equal to 5 nm and less than or equal to 1 μm so that the charge and discharge rate is increased. The specific surface area of the positive electrode active material is, for example, preferably greater than or equal to 10 m²/g and less than or equal to 50 m²/g.

A positive electrode active material having an olivine structure is much less likely to be changed in the structure by charge and discharge and has a more stable crystal structure than, for example, an active material having a layered rock-salt crystal structure. Thus, a positive electrode active material having an olivine structure is stable toward operation such as overcharge. The use of such a positive electrode active material allows fabrication of a highly safe battery cell.

The negative electrode active material layer 505 and the positive electrode active material layer 502 may each include a conductive additive. Examples of the conductive additive include natural graphite, artificial graphite such as mesocarbon microbeads, and carbon fiber. Examples of the carbon fiber include mesophase pitch-based carbon fiber and isotropic pitch-based carbon fiber. Furthermore, as the carbon fiber, carbon nanofiber, carbon nanotube, or the like can be used. Carbon nanotube can be formed by, for example, a vapor deposition method. As the conductive additive, for example, a carbon material such as carbon black (e.g., acetylene black (AB)) or graphene can be used. Alternatively, metal powder or metal fiber of copper, nickel, aluminum, silver, gold, or the like, a conductive ceramic material, or the like can be used, for example.

Flaky graphene has excellent electrical characteristics of high conductivity and excellent physical properties of high flexibility and high mechanical strength. For this reason, the use of graphene as the conductive additive can increase the points and the area where the active materials are in contact with each other.

Note that graphene in this specification includes single-layer graphene and multilayer graphene including two to hundred layers. Single-layer graphene refers to a one-atom-thick sheet of carbon molecules having π bonds. Graphene oxide refers to a compound formed by oxidation of such graphene. When graphene oxide is reduced to form graphene, oxygen contained in the graphene oxide is not entirely released and part of the oxygen remains in graphene. When graphene contains oxygen, the proportion of oxygen in the whole graphene, which is measured by XPS, is higher than or equal to 2 atomic % and lower than or equal to 11 atomic %, preferably higher than or equal to 3 atomic % and lower than or equal to 10 atomic %.

Furthermore, the negative electrode active material layer 505 and the positive electrode active material layer 502 preferably include a binder.

The binder preferably contains water-soluble polymers, for example. As the water-soluble polymers, a polysaccharide or the like can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used. Any of these rubber materials is more preferably used in combination with the aforementioned water-soluble polymers.

As the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, isobutylene, polyethylene terephthalate, nylon, poly(vinylidene fluoride) (PVdF), or polyacrylonitrile (PAN) is preferably used.

Two or more kinds of the above materials may be used in combination as the binder.

Next, methods for fabricating the negative electrode 506 and the positive electrode 503 will be described.

### [Fabricating Method of Negative Electrode]

First, a fabricating method of the negative electrode 506 will be described.

In order to form the negative electrode active material layer 505, first, a slurry is formed. The slurry can be formed in such a manner that the above-described negative electrode active material is used, a binder, a conductive additive, and the like are added, and mixing is performed together with a solvent, for example. As the solvent, for example, water, NMP (N-methyl-2-pyrrolidone), or the like can be used. Water is preferably used in terms of safety and cost.

The mixing is performed with a mixer. Here, a variety of mixers can be used as the mixer. For example, a planetary mixer, a homogenizer, or the like can be used.

The negative electrode current collector 504 may be subjected to surface treatment. Examples of such surface treatment include corona discharge treatment, plasma treatment, and undercoat treatment. The surface treatment can increase the wettability of the negative electrode current collector 504 with respect to the slurry. In addition, the adhesion between the negative electrode current collector 504 and the negative electrode active material layer 505 can be increased.

Here, the “undercoat” refers to a film formed over a current collector before application of slurry onto the current collector for the purpose of reducing the interface resistance between an active material layer and the current collector or increasing the adhesion between the active material layer and the current collector. Note that the undercoat is not necessarily formed in a film shape, and may be formed in an island shape. In addition, the undercoat may serve as an active material to have capacity. For the undercoat, a carbon material can be used, for example. Examples of the carbon material include graphite, carbon black such as acetylene black and ketjen black (registered trademark), and a carbon nanotube.

Then, the formed slurry is applied onto the negative electrode current collector 504.

For the application, a blade method or the like can be used. Furthermore, a continuous coater or the like may be used for the application.

The positive electrode 503 and the negative electrode 506 preferably include tab regions so that a plurality of stacked positive electrodes can be electrically connected to each other and a plurality of stacked negative electrodes can be electrically connected to each other. Furthermore, a lead electrode is preferably electrically connected to the tab region. In at least part of the tab region, the current collector is preferably exposed.

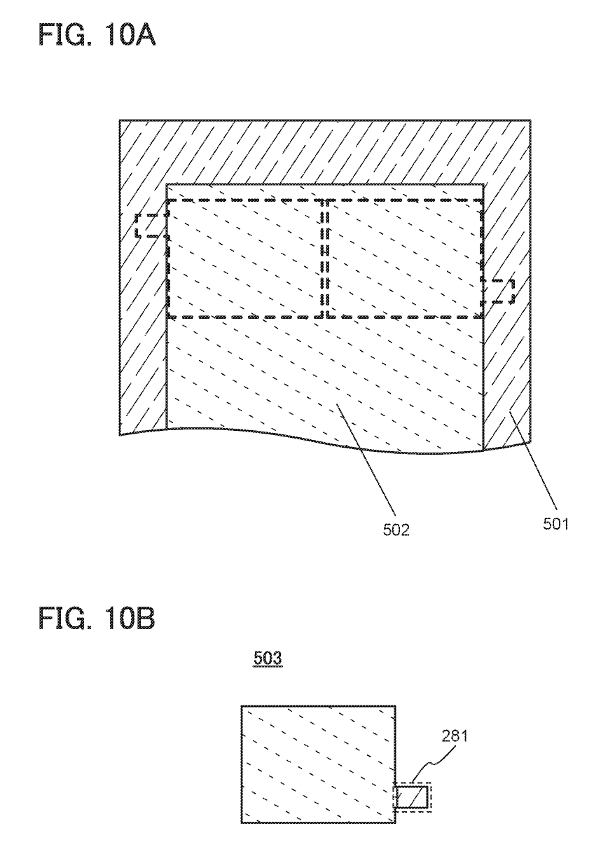

FIG. 10 illustrates an example of a method for providing the tab region. FIG. 10(A) illustrates the example where the positive electrode active material layer 502 is formed over the positive electrode current collector 501 that has a band-like shape. By cutting out the positive electrode 503 along dotted lines, the positive electrode 503 illustrated in FIG. 10(B) can be obtained. The positive electrode 503 is fabricated in this manner, whereby the surface of the positive electrode current collector 501 can be exposed in at least part of the tab region 281. An example of the positive electrode 503 is described here, and the tab region 282 of the negative electrode 506 can be provided similarly.

Alternatively, to provide the tab region 281 and the tab region 282, the positive electrode active material layer 502 and the negative electrode active material layer 505 that are applied may be partly removed so that the current collectors are exposed.

Then, drying is performed on the slurry applied onto the negative electrode current collector 504 by a method such as ventilation drying or reduced-pressure (vacuum) drying, whereby the negative electrode active material layer 505 is formed. The drying is preferably performed using, for example, a hot wind at a temperature higher than or equal to 30° C. and lower than or equal to 160° C. Note that there is no particular limitation on the atmosphere.

The thickness of the negative electrode active material layer 505 formed in the above-described manner is preferably greater than or equal to 5 μm and less than or equal to 300 μm, further preferably greater than or equal to 10 μm and less than or equal to 150 μm, for example. The amount of the active material in the negative electrode active material layer 505 is preferably greater than or equal to 2 mg/cm² and less than or equal to 50 mg/cm², for example.

Note that the negative electrode active material layer 505 is formed over one surface of the negative electrode current collector 504. Without limitation to this, the negative electrode active material layer 505 may be formed on both surfaces of the negative electrode current collector 504.

This negative electrode active material layer 505 may be pressed by a compression method such as a roll press method or a flat plate press method so as to be consolidated.

Next, heat treatment is performed to form the film 516 which covers the negative electrode current collector 504. This heat treatment is performed in an atmosphere containing oxygen (e.g., in an air atmosphere) at a temperature higher than or equal to 50° C. and lower than or equal to 200° C. for 2 hours or more, preferably 5 hours or more, further preferably 10 hours or more. This heat treatment oxidizes the surface of the negative electrode current collector 504, so that the film 516 can be formed. Moreover, because the film 516 is formed before the electrolytic solution is injected, the formation of the film 516 does not cause the decomposition of the electrolytic solution. Therefore, the provision of the film 516 can inhibit the decomposition of the electrolytic solution which is otherwise caused by the injection of the electrolytic solution and can reduce a loss in the capacity of the battery cell.

Through the above steps, the negative electrode 506 can be fabricated.

Note that the negative electrode active material layer 505 may be predoped. There is no particular limitation on the method for predoping the negative electrode active material layer 505. For example, it may be performed electrochemically. For example, before the battery is assembled, the negative electrode active material layer 505 can be predoped with lithium in an electrolytic solution described later with the use of a lithium metal as a counter electrode.

### [Fabricating Method of Positive Electrode]

Next, a fabricating method of the positive electrode 503 will be described. For the fabricating method of the positive electrode 503, the fabricating method of the negative electrode 506 can be referred to.

In order to form the positive electrode active material layer 502, first, a slurry is formed. The slurry can be formed in such a manner that the above-described positive electrode active material is used, a binder, a conductive additive, and the like are added, and mixing is performed together with a solvent, for example. As the solvent, the solvent described for forming the negative electrode active material layer 505 can be used.

The mixing is performed with a mixer as in the case of the negative electrode.

The positive electrode current collector 501 may be subjected to surface treatment as in the case of the negative electrode.

Then, the positive electrode slurry is applied onto the current collector.

Drying is performed on the slurry applied onto the positive electrode current collector 501 by a method such as ventilation drying or reduced-pressure (vacuum) drying, whereby the positive electrode active material layer 502 is formed. The drying is preferably performed using, for example, a hot wind at a temperature higher than or equal to 50° C. and lower than or equal to 160° C. Note that there is no particular limitation on the atmosphere.

Note that the positive electrode active material layer 502 may be formed over both surfaces of the positive electrode current collector 501 or may be formed over only one surface. Alternatively, a region where the positive electrode active material layer 502 is formed over both surfaces may be included partly.

This positive electrode active material layer 502 may be pressed by a compression method such as a roll press method or a flat plate press method so as to be consolidated.

The thickness of the positive electrode active material layer 502 formed in the above-described manner is preferably greater than or equal to 5 μm and less than or equal to 300 μm, further preferably greater than or equal to 10 μm and less than or equal to 150 μm, for example. The amount of the active material in the positive electrode active material layer 502 is preferably greater than or equal to 2 mg/cm² and less than or equal to 50 mg/cm², for example.

Through the above steps, the positive electrode 503 can be fabricated.

Moreover, the positive electrode active material layer 502 preferably contains graphene. Graphene is capable of making low-resistance surface contact and has extremely high conductivity even with a small thickness. Therefore, even a small amount of graphene can efficiently form a conductive path in an active material layer.

For example, lithium-containing complex phosphate with an olivine crystal structure used for the positive electrode active material has a one-dimensional lithium diffusion path, so that lithium diffusion is slow. The average size of particles of the active material is thus, for example, preferably greater than or equal to 5 nm and less than or equal to 1 μm so that the charge and discharge rate is increased. The specific surface area of the active material is, for example, preferably greater than or equal to 10 m²/g and less than or equal to 50 m²/g.

In the case where such an active material with a small average particle size of, for example, 1 μm or less is used, the specific surface area of the active material is large and thus more conductive paths connecting the active materials are necessary. In such a case, it is particularly preferred that graphene with extremely high conductivity that can efficiently form a conductive path even with a small amount be used.

In the case where the positive electrode active material layer 502 includes a binder, the binder described above is used. One example here is PVdF, which has high resistance to oxidation and is stable even in the case where the reaction potential, particularly, in the battery reaction of the positive electrode is high. Another example is water-soluble polymers, which have high dispersibility and can be evenly dispersed with the small active material. Thus, water-soluble polymers can function even with a smaller amount. A film containing water-soluble polymers that covers or is in contact with the surface of an active material can inhibit the decomposition of an electrolytic solution.

Note that the amount of graphene oxide is set to more than or equal to 0.1 weight % and less than or equal to 10 weight %, preferably more than or equal to 0.1 weight % and less than or equal to 5 weight %, further preferably more than or equal to 0.2 weight % and less than or equal to 1 weight % with respect to the total weight of the mixture of the graphene oxide, the positive electrode active material, the conductive additive, and the binding agent. In contrast, graphene obtained after the positive electrode paste is applied to a current collector and reduction is performed is included at least at more than or equal to 0.05 weight % and less than or equal to 5 weight %, preferably more than or equal to 0.05 weight % and less than or equal to 2.5 weight %, further preferably more than or equal to 0.1 weight % and less than or equal to 0.5 weight % with respect to the total weight of the positive electrode active material layer. This is because the weight of graphene obtained by reducing graphene oxide is approximately half

Note that a solvent may be further added after the mixing so that the viscosity of the mixture can be adjusted. Mixing and addition of a polar solvent may be repeated a plurality of times.

This positive electrode active material layer 502 may be pressed by a compression method such as a roll press method or a flat plate press method so as to be consolidated.

Next, a fabricating method of the positive electrode 503 in which the positive electrode active material layer 502 contains graphene will be described.

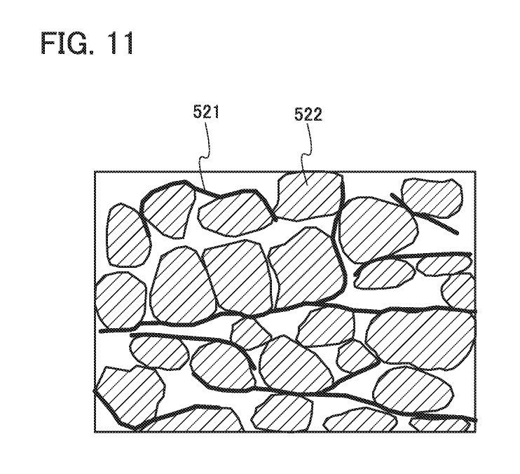

FIG. 11 is a longitudinal cross-sectional view of the positive electrode active material layer 502. The positive electrode active material layer 502 includes a particulate positive electrode active material 522, graphenes 521 serving as a conductive additive, and a binding agent (also referred to as a binder. Not illustrated).

The graphenes 521 in a sheet shape are dispersed substantially uniformly inside the positive electrode active material layer 502 in the longitudinal cross section of the positive electrode active material layer 502 as illustrated in FIG. 11. Although the graphenes 521 are schematically shown by thick lines in FIG. 11, the graphenes are actually thin films having a thickness corresponding to the thickness of a single layer or a multi-layer of carbon molecules. A plurality of graphenes 521 are formed in such a way as to wrap or coat a plurality of particles of the positive electrode active material 522 or to adhere to surfaces of the plurality of particles of the positive electrode active material 522, so that surface contact is made. Furthermore, the graphenes 521 are also in surface contact with each other; consequently, the plurality of graphenes 521 form a three-dimensional network for electric conduction.

This is because graphene oxide with extremely high dispersibility in a polar solvent is used for the formation of the graphenes 521. The solvent is removed by volatilization from a dispersion medium in which graphene oxide is uniformly dispersed, and the graphene oxide is reduced to graphene; hence, the graphenes 521 remaining in the positive electrode active material layer 502 partly overlap with each other and are dispersed such that surface contact is made, thereby forming an electrical conduction path.

Unlike a conventional particulate conductive additive, such as acetylene black, which makes point contact with an active material, the graphenes 521 is capable of making low-resistance surface contact; accordingly, the electrical conduction between the particulate positive electrode active material 522 and the graphenes 521 can be improved without an increase in the amount of a conductive additive. Thus, the proportion of the positive electrode active material 522 in the positive electrode active material layer 502 can be increased. This can increase the discharge capacity of a storage battery.

Although the example of using graphene for the positive electrode has been described, graphene can also be used for the negative electrode.

Next, an example of a method for fabricating a positive electrode in which graphene is used as a conductive additive will be described. First, an active material, a binder, and graphene oxide are prepared.

The graphene oxide is a raw material of the graphenes 521 that serve as a conductive additive later. Graphene oxide can be formed by various synthesis methods such as a Hummers method, a modified Hummers method, and oxidation of graphite. Note that a method for fabricating a storage battery electrode of the present invention is not limited by the degree of separation of graphene oxide.

For example, the Hummers method is a method for forming graphite oxide by oxidizing graphite such as flake graphite. In the obtained graphite oxide, graphite that is oxidized in places is bonded to a functional group such as a carbonyl group, a carboxyl group, or a hydroxyl group, where the crystallinity of the graphite is lost and the distance between layers is increased. Therefore, the layers can be easily separated by ultrasonic treatment or the like to obtain graphene oxide.

The length of one side (also referred to as a flake size) of the graphene oxide is greater than or equal to 50 nm and less than or equal to 100 μm, preferably greater than or equal to 800 nm and less than or equal to 20 μm. Particularly in the case where the flake size is smaller than the average particle size of the particulate positive electrode active material, the surface contact with the plurality of the positive electrode active materials 522 and connection between graphenes become difficult, resulting in difficulty in improving the electrical conductivity of the positive electrode active material layer 502.

A positive electrode paste is formed by adding a solvent to such graphene oxide, an active material, and a binding agent as described above. As the solvent, water or a polar organic solvent such as N-methylpyrrolidone (NMP) or dimethylformamide can be used.

With the use of the active material layer including the particulate active material, graphene, and the binding agent in the above-described manner, a sheet of graphene is two-dimensionally in contact with particles of the alloy-based material so as to wrap the particles, and graphenes are also two-dimensionally in contact to overlap with each other; thus, an extensive network of three-dimensional electronic conduction paths is established in the active material layer. For this reason, it is possible to form an active material layer with higher electric conductivity than the case of using acetylene black (AB) particles or ketj en black (KB) particles, which are generally used as a conductive additive and make an electrical point contact.

Furthermore, graphene is preferably used because even in the case of using, for example, an active material with a small particle size, the conductive path can be maintained even after charge and discharge are repeatedly performed. Thus, favorable cycle characteristics can be achieved.

Graphenes are bonded to each other to form net-like graphene (hereinafter referred to as a graphene net). In the case where the graphene net covers the active material, the graphene net can function as a binder for binding particles. The amount of a binding agent can thus be reduced, or the binder does not have to be used. This can increase the proportion of the active material in the electrode volume or weight. That is to say, the capacity of the battery cell can be increased.

Then, graphene oxide is preferably reduced. The reduction is performed by heat treatment or with the use of a reducing agent, for example.

An example of a reducing method using a reducing agent will be described below. First, a reaction is caused in a solvent containing a reducing agent. Through this step, the graphene oxide contained in the active material layer is reduced to form the graphenes 521. Note that oxygen in the graphene oxide is not necessarily entirely released and may partly remain in the graphene. When the graphenes 521 contain oxygen, the proportion of oxygen in the whole graphenes measured by XPS is higher than or equal to 2 atomic % and lower than or equal to 11 atomic %, preferably higher than or equal to 3 atomic % and lower than or equal to 10 atomic %. This reduction treatment is preferably performed at higher than or equal to room temperature and lower than or equal to 150° C.

Examples of the reducing agent include ascorbic acid, hydrazine, dimethyl hydrazine, hydroquinone, sodium boron hydride (NaBH₄), tetra butyl ammonium bromide (TBAB), LiAlH₄, ethylene glycol, polyethylene glycol, N,N-diethylhydroxylamine, and a derivative thereof

A polar solvent can be used as the solvent. The material is not limited as long as it can dissolve the reducing agent. For example, a mixed solution of one kind or two or more kinds of water, methanol, ethanol, acetone, tetrahydrofuran (THF), dimethylformamide (DMF), N-methylpyrrolidone (NMP), and dimethyl sulfoxide (DMSO) can be used.

After that, washing and drying are performed. The drying is preferably performed under a reduced pressure (in vacuum) or in a reduction atmosphere. This drying step is preferably performed, for example, in vacuum at a temperature higher than or equal to 50° C. and lower than or equal to 160° C. for longer than or equal to 10 minutes and shorter than or equal to 48 hours. The drying allows evaporation, volatilization, or removal of the polar solvent and moisture existing in the positive electrode active material layer 502. The drying may be followed by pressing.

Alternatively, the drying may be performed using a drying furnace or the like. In the case of using a drying furnace, the drying is performed at a temperature higher than or equal to 30° C. and lower than or equal to 200° C. for longer than or equal to 30 seconds and shorter than or equal to 20 minutes, for example. The temperature may be increased in stages.

Note that heating can facilitate the reduction reaction caused using the reducing agent. After drying following the chemical reduction, heating may further be performed.

In the case of not performing reduction with the use of a reducing agent, reduction can be performed by heat treatment. For example, reduction by heat treatment can be performed under a reduced pressure (in vacuum) at a temperature higher than or equal to 150° C. for longer than or equal to 0.5 hours and shorter than or equal to 30 hours.

Through the above steps, the positive electrode active material layer 502 in which the graphenes 521 are uniformly dispersed in the positive electrode active material 522 can be formed. Furthermore, the positive electrode 503 can be fabricated.

Here, reduction is preferably performed on an electrode using graphene oxide. The reduction is further preferably performed using conditions that thermal reduction is performed after the chemical reduction. In thermal reduction, oxygen atoms are released in the form of, for example, carbon dioxide. In contrast, in chemical reduction, reduction is performed using a chemical reaction, whereby the proportion of carbon atoms that form an sp² bond of graphene can be increased. Furthermore, thermal reduction is preferably performed after chemical reduction, in which case the conductivity of formed graphene can be further increased.

The use of LiFePO₄ for the positive electrode allows fabrication of a highly safe storage battery that is stable to an external load such as overcharge. Such a storage battery is particularly suitable for, for example, a mobile device which is carried around, a wearable device which is worn on the body, and the like.

Here, the ratio of the capacity of a positive electrode of a storage battery to the capacity of a negative electrode of the storage battery will be described. R defined by Mathematical Formula (5) below is the ratio of positive electrode capacity to negative electrode capacity. Here, the positive electrode capacity means the capacity of the positive electrode of the storage battery, and negative electrode capacity means the capacity of the negative electrode of the storage battery.

$$\begin{matrix}[ Mathematical Formula 5 ] & \\ R = \frac{capacity of positive electrode}{capacity of negative electrode} \times 100 [ \% ] & ( 5 )\end{matrix}$$

Here, the theoretical capacity or the like may be used for calculation of the positive electrode capacity and the negative electrode capacity. Alternatively, capacity based on a measured value or the like may be used. For example, in the case where LiFePO₄ and graphite are used, the capacity per unit weight of the active material of LiFePO₄ is 170 mAh/g, and that of graphite is 372 mAh/g.

This embodiment can be implemented in combination with the other embodiments as appropriate.

### Embodiment 4

In this embodiment, a variety of modes of power storage devices that uses one embodiment of the present invention will be described.

### [Structural Example of Storage Battery Using Wound Body]

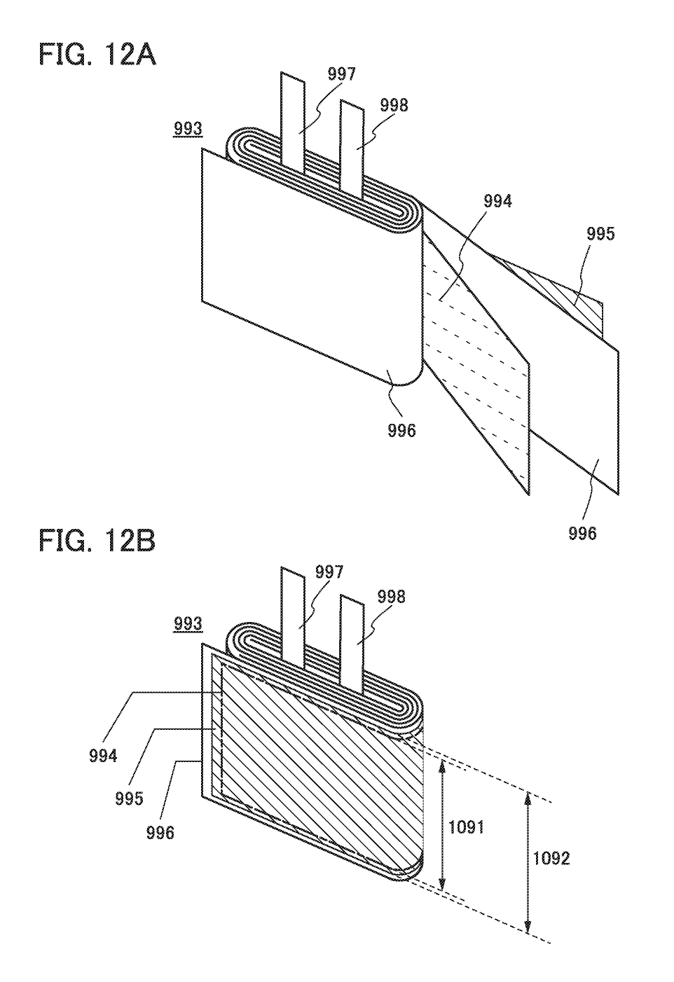

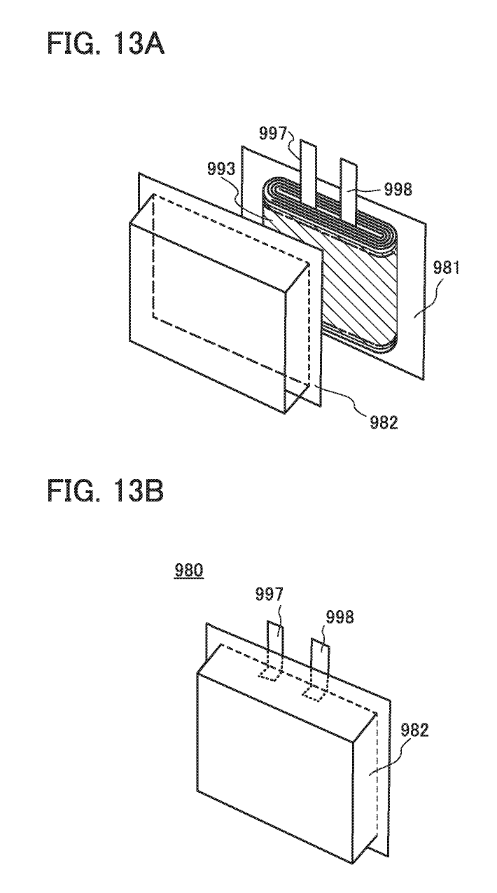

Next, FIG. 12 and FIG. 13 illustrate structural examples of a storage battery using a wound body that is a power storage device that uses one embodiment of the present invention. A wound body 993 illustrated in FIG. 12 includes a negative electrode 994, a positive electrode 995, and a separator 996.

The wound body 993 is obtained by winding a sheet of a stack in which the negative electrode 994 overlaps with the positive electrode 995 with the separator 996 sandwiched therebetween. The wound body 993 is covered with a rectangular sealed container or the like; thus, a rectangular secondary battery is fabricated.

Note that the number of stacks each including the negative electrode 994, the positive electrode 995, and the separator 996 is determined as appropriate depending on capacity and element volume which are required. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

The area of a region where the negative electrode 994 does not overlap with the positive electrode 995 is preferably as small as possible. FIG. 12(B) illustrates the example where a width 1091 of the negative electrode 994 in the wound body 993 is smaller than a width 1092 of the positive electrode 995. In addition, an end portion of the negative electrode 994 is located inside the positive electrode 995. With such a structure, the negative electrode 994 can entirely overlap with the positive electrode 995 or the area of a region where the negative electrode 994 and the positive electrode 995 do not overlap with each other can be reduced.

In the case where the area of the positive electrode 995 is too larger than that of the negative electrode 994, an excess portion of the positive electrode 995 is large, which reduces the capacity of a storage battery per unit volume, for example. Thus, in the case where the end portion of the negative electrode 994 is located inside the end portion of the positive electrode 995, the distance between the end portion of the positive electrode 995 and the end portion of the negative electrode 994 is preferably 3 mm or less, further preferably 0.5 mm or less, still further preferably 0.1 mm or less. Alternatively, the difference between the widths of the positive electrode 995 and the negative electrode 994 is preferably 6 mm or less, further preferably 1 mm or less, still further preferably 0.2 mm or less.

Alternatively, it is preferred that the widths 1091 and 1092 be approximately equal values and the end portion of the negative electrode 994 be substantially aligned with the end portion of the positive electrode 995.

Moreover, when the negative electrode 994 employs a structure including a film covering the negative electrode current collector formed by oxidation of a surface of the negative electrode current collector, a region of the negative electrode current collector in contact with the electrolytic solution is reduced, suppressing the occurrence of the above-described second reaction and promoting an appropriate occurrence of the first reaction.

In a storage battery 990 illustrated in FIG. 13(A) and FIG. 13(B), the wound body 993 is packed in a space formed by bonding a film 981 and a film 982 having a depressed portion that serve as exterior bodies by thermocompression bonding or the like. The wound body 993 includes the lead electrode 997 and the lead electrode 998, and is soaked in an electrolytic solution inside a space surrounded by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be fabricated.

Although FIG. 13(A) and FIG. 13(B) illustrate an example where a space is formed by two films, the wound body 993 may be placed in a space formed by bending one film.

Furthermore, a flexible power storage device can be fabricated by using a resin material or the like for an exterior body and a sealed container of the power storage device. Note that in the case where a resin material is used for the exterior body and the sealed container, a conductive material is used for a portion connected to the outside.

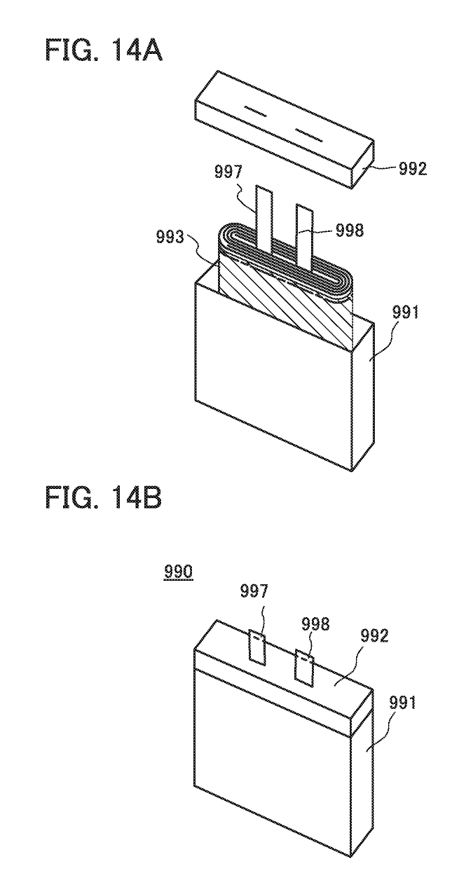

FIG. 14 illustrates an example of a thin storage battery that is different from that in FIG. 13. The wound body 993 illustrated in FIG. 14(A) is the same as that illustrated in FIG. 12 and FIG. 13(A), and the detailed description thereof is omitted.

In the storage battery 990 illustrated in FIG. 14(A) and FIG. 14(B), the wound body 993 is packed in an exterior body 991. The wound body 993 includes the lead electrode 997 and the lead electrode 998, and is soaked in an electrolytic solution inside a space surrounded by the exterior body 991 and an exterior body 992. For example, a metal material such as aluminum or a resin material can be used for the exterior body 991 and the exterior body 992. With the use of a resin material for the exterior body 991 and the exterior body 992, the exterior body 991 and the exterior body 992 can be changed in their forms when external force is applied; thus, a flexible thin storage battery can be fabricated.

### [Cylindrical Storage Battery]

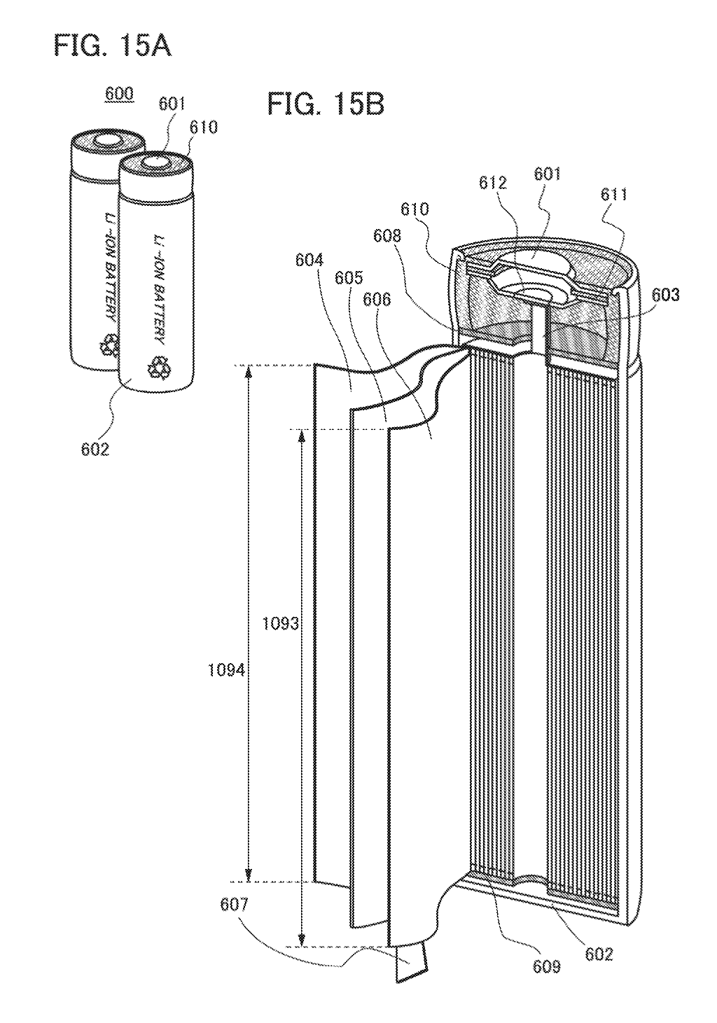

Next, a cylindrical storage battery will be described as an example of a power storage device using a wound body as in FIG. 12 to FIG. 14. The cylindrical storage battery will be described with reference to FIG. 15. As illustrated in FIG. 15(A), a cylindrical storage battery 600 includes a positive electrode cap (battery cap) 601 on the top surface and a battery can (outer can) 602 on the side surface and bottom surface. The positive electrode cap and the battery can (outer can) 602 are insulated from each other by a gasket (insulating gasket) 610.

FIG. 15(B) is a diagram schematically illustrating a cross section of the cylindrical storage battery. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. One end of the battery can 602 is close and the other end thereof is open. For the battery can 602, a metal having a corrosion-resistant property to an electrolytic solution, such as aluminum or titanium, an alloy of such a metal, or an alloy of such a metal and another metal (e.g., stainless steel or the like) can be used. Alternatively, the battery can is preferably covered with aluminum or the like in order to prevent corrosion due to the electrolytic solution. Inside the battery can 602, the battery element in which the positive electrode, the negative electrode, and the separator are wound is provided between a pair of insulating plates 608 and 609 which face each other. Furthermore, a nonaqueous electrolytic solution (not illustrated) is injected inside the battery can 602 provided with the battery element. As the nonaqueous electrolytic solution, a nonaqueous electrolytic solution that is similar to those of the coin-type storage battery can be used.

The positive electrode 604 and the negative electrode 606 can be formed in a manner similar to that of the positive electrode and the negative electrode of the thin storage battery described above. Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

The area of a region where the negative electrode 606 does not overlap with the positive electrode 604 is preferably as small as possible. For example, an end portion of the negative electrode 994 is preferably located inside an end portion of the positive electrode 995. Furthermore, the distance between the end portion of the positive electrode 604 and the end portion of the negative electrode 606 is preferably 3 mm or less, further preferably 0.5 mm or less, still further preferably 0.1 mm or less. Alternatively, the difference between a width 1093 of the positive electrode 604 and a width 1094 of the negative electrode 606 is preferably 6 mm or less, further preferably 1 mm or less, still further preferably 0.2 mm or less.

Alternatively, it is preferred that the widths 1093 and 1094 be approximately equal values and the end portion of the negative electrode 606 be substantially aligned with the end portion of the positive electrode 604.

Moreover, when the negative electrode 994 employs a structure including a film covering the negative electrode current collector formed by oxidation of a surface of the negative electrode current collector, a region of the negative electrode current collector in contact with the electrolytic solution is decreased, suppressing the occurrence of the above-described second reaction and promoting an appropriate occurrence of the first reaction.

Furthermore, the second reaction might cause formation of a film on the surface of the negative electrode. The formed film serves as a passivating film in some cases. This passivating film may allow inhibition of a further decomposition reaction of ions other than lithium ions by charge or discharge. Accordingly, a decrease in the capacity of the power storage device is possibly inhibited by the film.

Furthermore, because the film covering the negative electrode current collector obtained by oxidation of the surface of the negative electrode current collector is formed before the electrolytic solution is injected, the formation of the film does not cause the decomposition of the electrolytic solution. Therefore, the provision of the film can inhibit the decomposition of the electrolytic solution which is otherwise caused by the injection of the electrolytic solution and can reduce a loss in the capacity of the power storage device.

### [Coin-Type Storage Battery]

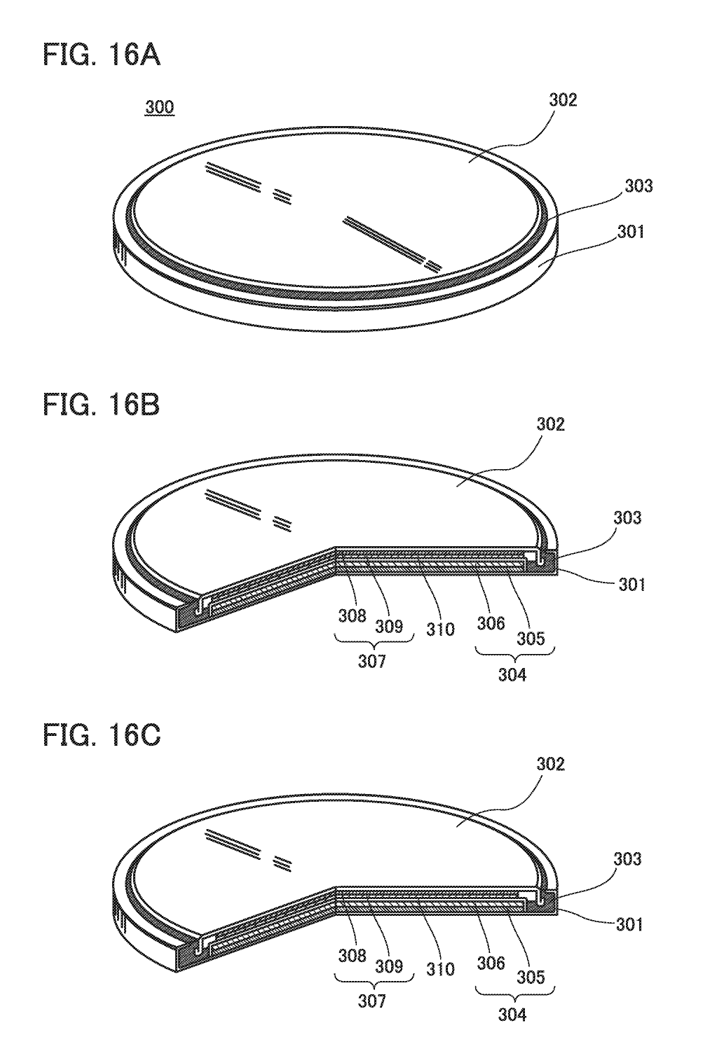

Next, an example of a coin-type storage battery, which is a storage battery using one embodiment of the present invention, will be described as an example of a power storage device with reference to FIG. 16. FIG. 16(A) is an external view of a coin-type (single-layer flat type) storage battery, and FIG. 16(B) and FIG. 16(C) are cross-sectional views thereof

In a coin-type storage battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. The description of the positive electrode active material layer 502 can be referred to for the positive electrode active material layer 306.

A negative electrode 307 includes a negative electrode current collector 308 and a negative electrode active material layer 309 provided in contact with the negative electrode current collector 308. The description of the negative electrode active material layer 505 can be referred to for the negative electrode active material layer 309. The description of the separator 507 can be referred to for the separator 310. The description of the electrolytic solution 508 can be referred to for the electrolytic solution.

Note that only one surface of each of the positive electrode 304 and the negative electrode 307 used for the coin-type storage battery 300 is provided with an active material layer.

It is preferred that the shape and area of the positive electrode 304 be preferably substantially the same as those of the negative electrode 307 and an end portion of the positive electrode 304 be substantially aligned with an end portion of the negative electrode 307. FIG. 16(B) illustrates an example where the end portion of the positive electrode 304 is aligned with the end portion of the negative electrode 307.

Alternatively, it is preferred that the area of the negative electrode 307 be larger than that of the positive electrode 304 and the end portion of the positive electrode 304 be located inside the end portion of the negative electrode 307. FIG. 16(C) illustrates an example where the end portion of the positive electrode 304 is located inside the end portion of the negative electrode 307.

For the positive electrode can 301 and the negative electrode can 302, a metal having a corrosion-resistant property to an electrolytic solution, such as aluminum or titanium, an alloy of such a metal, or an alloy of such a metal and another metal (e.g., stainless steel or the like) can be used. Alternatively, the positive electrode can and the negative electrode can are preferably covered with aluminum or the like in order to prevent corrosion due to the electrolytic solution. The positive electrode can 301 and the negative electrode can 302 are electrically connected to the positive electrode 304 and the negative electrode 307, respectively.

The negative electrode 307, the positive electrode 304, and the separator 310 are immersed in the electrolytic solution. Then, as illustrated in FIG. 16(B) and FIG. 16(C), the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. Thus, the coin-type storage battery 300 is fabricated.

Note that in this embodiment, the coin-type storage battery, the cylindrical storage battery, and the thin storage battery are given as examples of the storage battery; however, any of storage batteries with a variety of shapes, such as a sealed storage battery and a square-type storage battery, can be used. Furthermore, a structure in which a plurality of positive electrodes, a plurality of negative electrodes, and a plurality of separators are stacked or wound may be employed.

### [Structural Example of Power Storage System]

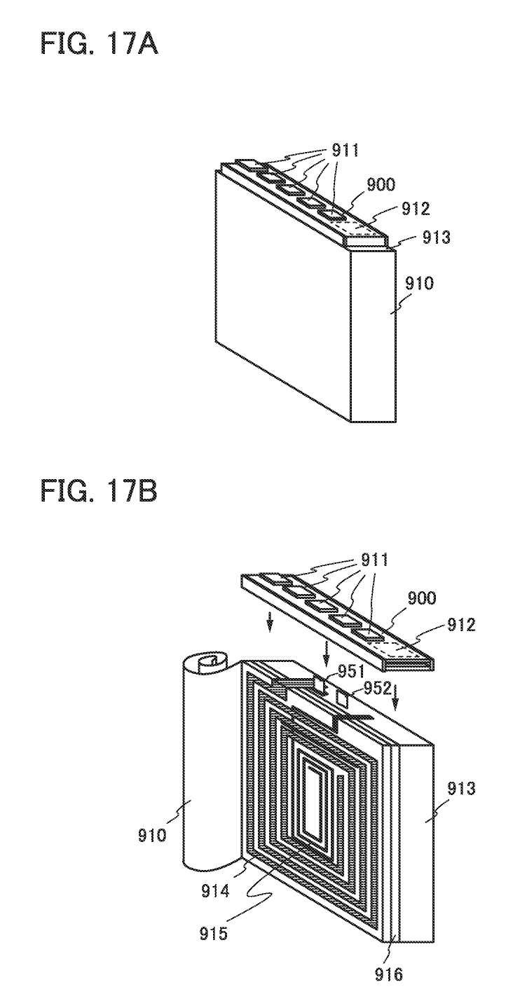

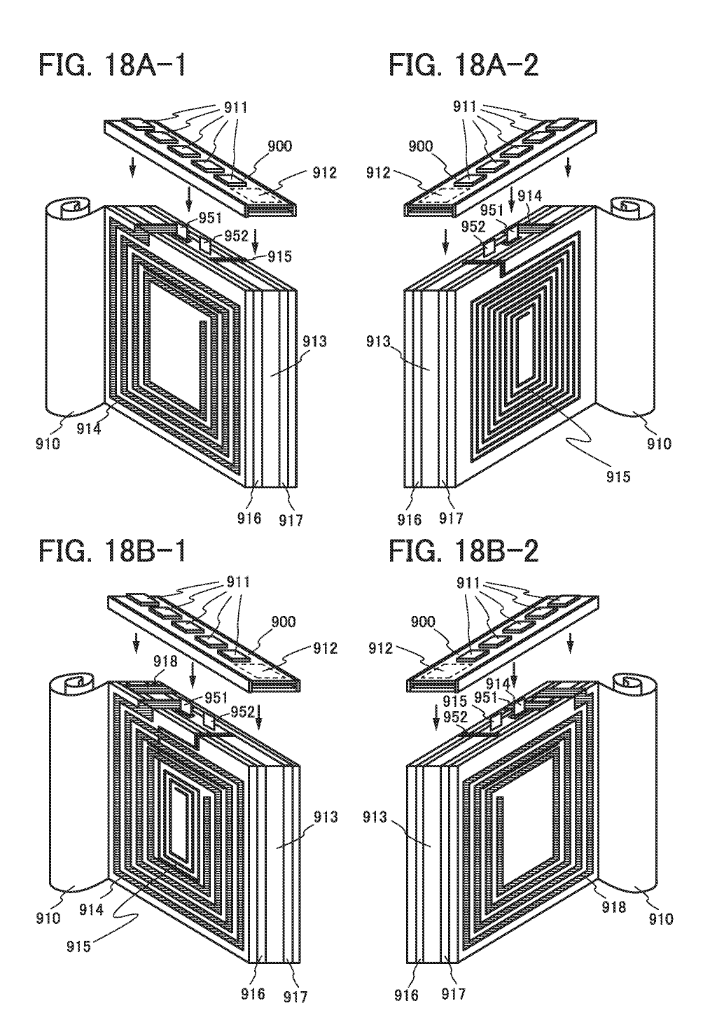

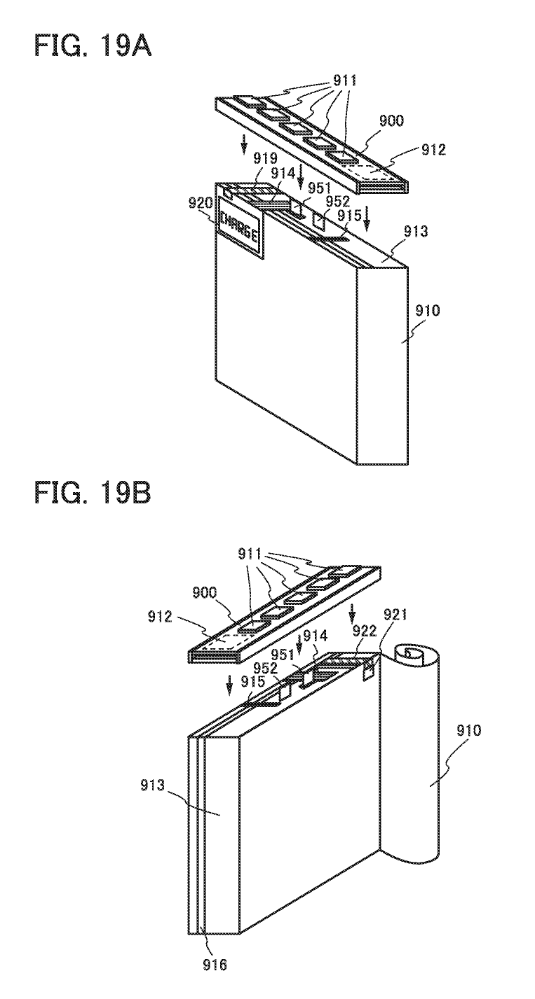

Structural examples of power storage systems will be described with reference to FIG. 17, FIG. 18, and FIG. 19. Here, a power storage system refers to, for example, a device including a power storage device. The power storage system described in this embodiment includes a storage battery that is a power storage device using one embodiment of the present invention.

FIG. 17(A) and FIG. 17(B) are external views of a power storage system. The power storage system includes a circuit board 900 and a storage battery 913. A label 910 is attached to the storage battery 913. As shown in FIG. 17(B), the power storage system further includes a terminal 951 and a terminal 952 and includes an antenna 914 and an antenna 915.

The circuit board 900 includes terminals 911 and a circuit 912. The terminals 911 are connected to the terminals 951 and 952, the antennas 914 and 915, and the circuit 912. Note that a plurality of terminals 911 may be provided to each serve as a control signal input terminal, a power supply terminal, or the like.

The circuit 912 may be provided on the rear surface of the circuit board 900. The shape of each of the antennas 914 and 915 is not limited to a coil shape and may be a linear shape or a plate shape. Further, a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 can serve as one conductor of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage system includes a layer 916 between the storage battery 913 and the antennas 914 and 915. The layer 916 has a function of blocking an electromagnetic field by the storage battery 913, for example. As the layer 916, for example, a magnetic body can be used.

Note that the structure of the power storage system is not limited to that shown in FIG. 17.

For example, as shown in FIG. 18(A-1) and FIG. 18(A-2), a pair of facing surfaces of the storage battery 913 in FIG. 17(A) and FIG. 17(B) may each be provided with an antenna. FIG. 18(A-1) is an external view seen from one side direction of the pair of surfaces, and FIG. 18(A-2) is an external view seen from the other side direction of the pair of surfaces. For portions similar to those in FIG. 17(A) and FIG. 17(B), the description of the power storage system illustrated in FIG. 17(A) and FIG. 17(B) can be referred to as appropriate.

As illustrated in FIG. 18(A-1), the antenna 914 is provided on one of the pair of surfaces of the storage battery 913 with the layer 916 interposed therebetween, and as illustrated in FIG. 18(A-2), the antenna 915 is provided on the other of the pair of surfaces of the storage battery 913 with a layer 917 interposed therebetween. The layer 917 has a function of blocking an electromagnetic field from the storage battery 913, for example. As the layer 917, for example, a magnetic body can be used.

With the above structure, both the antenna 914 and the antenna 915 can be increased in size.

Alternatively, as illustrated in FIG. 18(B-1) and FIG. 18(B-2), each of the pair of facing surfaces of the storage battery 913 in FIG. 17(A) and FIG. 17(B) may be provided with a different type of antenna. FIG. 18(B-1) is an external view seen from one side direction of the pair of surfaces, and FIG. 18(B-2) is an external view seen from the other side direction of the pair of surfaces. For portions similar to those in FIG. 17(A) and FIG. 17(B), the description of the power storage system illustrated in FIG. 17(A) and FIG. 17(B) can be referred to as appropriate.

As illustrated in FIG. 18(B-1), the antennas 914 and 915 are provided on one of the pair of surfaces of the storage battery 913 with the layer 916 interposed therebetween, and as illustrated in FIG. 18(A-2), an antenna 918 is provided on the other of the pair of surfaces of the storage battery 913 with the layer 917 interposed therebetween. The antenna 918 has a function of communicating data with an external device, for example. An antenna with a shape that can be applied to the antenna 914 and the antenna 915, for example, can be used as the antenna 918.

As a system for communication using the antenna 918 between the power storage system and another device, a response method that can be used between the power storage system and another device, such as NFC, can be employed.

Alternatively, as illustrated in FIG. 19(A), the storage battery 913 in FIG. 17(A) and FIG. 17(B) may be provided with a display device 920. The display device 920 is electrically connected to the terminal 911 via a terminal 919. It is possible that the label 910 is not provided in a portion where the display device 920 is provided. For portions similar to those in FIG. 17(A) and FIG. 17(B), the description of the power storage system illustrated in FIG. 17(A) and FIG. 17(B) can be referred to as appropriate.

The display device 920 can display, for example, an image showing whether charge is being carried out, an image showing the amount of stored power, or the like. As the display device 920, electronic paper, a liquid crystal display device, an electroluminescent (also referred to as EL) display device, or the like can be used. For example, the use of electronic paper can reduce power consumption of the display device 920.

Alternatively, as illustrated in FIG. 19(B), the storage battery 913 illustrated in FIG. 17(A) and FIG. 17(B) may be provided with a sensor 921. The sensor 921 is electrically connected to the terminal 911 via a terminal 922. For portions similar to those in FIG. 17(A) and FIG. 17(B), the description of the power storage system illustrated in FIG. 17(A) and FIG. 17(B) can be referred to as appropriate.

As the sensor 921, a sensor that has a function of measuring, for example, force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays can be used. With the sensor 921, for example, data on an environment (e.g., temperature) where the power storage system is placed can be determined and stored in a memory inside the circuit 912.

The electrode of one embodiment of the present invention is used in the storage battery and the power storage system that are described in this embodiment. The capacity of the storage battery and the power storage system can thus be high. Furthermore, the energy density can be high. Moreover, the reliability can be high, and life can be long.

This embodiment can be implemented in combination with the other embodiments as appropriate.

### Embodiment 5

In this embodiment, an example of an electronic device including a flexible storage battery that is a power storage device using one embodiment of the present invention will be described.

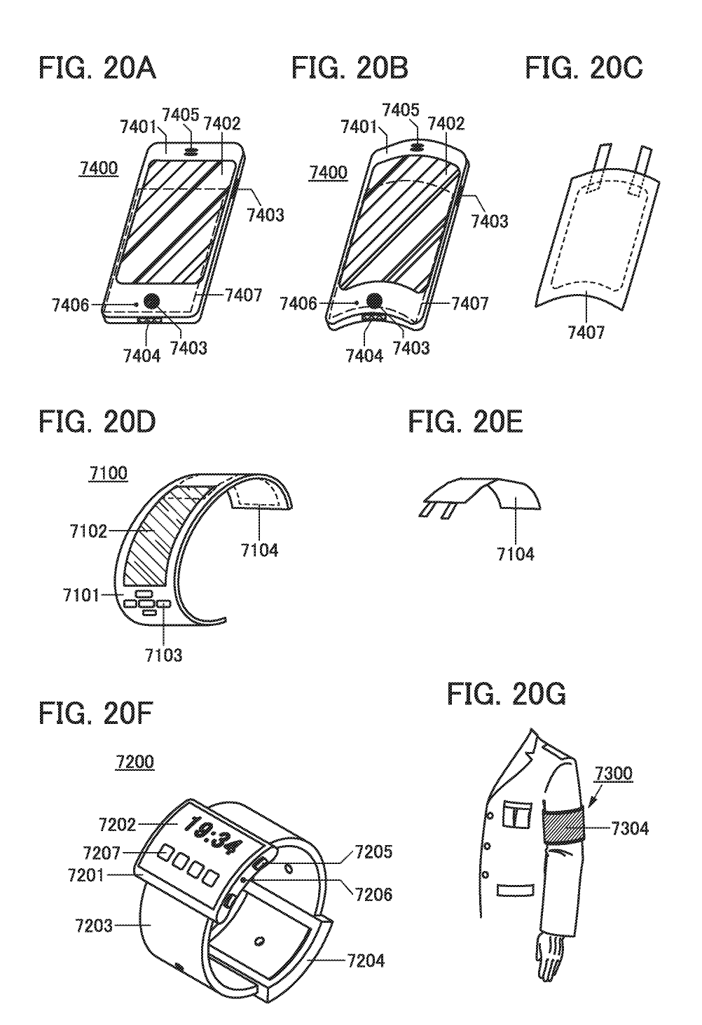

FIG. 20 illustrates examples of electronic devices including the flexible storage batteries described in the above embodiment. Examples of electronic devices including a power storage device with a flexible shape include television devices (also referred to as televisions or television receivers), monitors of computers or the like, digital cameras, digital video cameras, digital photo frames, mobile phones (also referred to as mobile phones or mobile phone devices), portable game machines, portable information terminals, audio reproducing devices, and large game machines such as pachinko machines.

In addition, a power storage device with a flexible shape can be incorporated along a curved inside/outside wall surface of a house or a building or a curved interior/exterior surface of a car.

FIG. 20(A) illustrates an example of a mobile phone. A mobile phone 7400 is provided with not only a display portion 7402 incorporated in a housing 7401 but also an operation button 7403, an external connection port 7404, a speaker 7405, a microphone 7406, and the like. Note that the mobile phone 7400 includes a power storage device 7407.

FIG. 20(B) illustrates the mobile phone 7400 that is curved. When the whole mobile phone 7400 is curved by the external force, the power storage device 7407 included in the mobile phone 7400 is also bent. FIG. 20(C) illustrates the bent power storage device 7407. The power storage device 7407 is a thin storage battery. The power storage device 7407 is fixed in a state of being curved. Note that the power storage device 7407 includes a lead electrode 7408 electrically connected to a current collector 7409. The current collector 7409 is, for example, copper foil, and partly alloyed with gallium; thus, adhesion between the current collector 7409 and an active material layer in contact with the current collector 7409 is improved and the power storage device 7407 can have high reliability even in a state of being bent.

FIG. 20(D) illustrates an example of a bangle display device. A portable display device 7100 includes a housing 7101, a display portion 7102, an operation button 7103, and a power storage device 7104. FIG. 20(E) illustrates the bent power storage device 7104. When the display device is worn on a user's arm while the power storage device 7104 is bent, the housing changes its form and the curvature of a part or the whole of the power storage device 7104 is changed. Note that what expresses the curving degree at a point of a curve in the value of radius of a corresponding circle is a radius of curvature, and the reciprocal of the radius of curvature is referred to as curvature. Specifically, a part or the whole of the housing or the main surface of the power storage device 7104 is changed in the range of radius of curvature from greater than or equal to 40 mm and less than or equal to 150 mm. When the radius of curvature at the main surface of the power storage device 7104 is greater than or equal to 40 mm and less than or equal to 150 mm, the reliability can be kept high.

FIG. 20(F) illustrates an example of a watch-type portable information terminal. A portable information terminal 7200 includes a housing 7201, a display portion 7202, a band 7203, a buckle 7204, an operation button 7205, an input output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as power on/off, on/off of wireless communication, setting and cancellation of a manner mode, and setting and cancellation of a power saving mode in addition to time setting can be performed. For example, the functions of the operation button 7205 can be set freely by setting the operating system incorporated in the portable information terminal 7200.

The portable information terminal 7200 can employ near field communication based on an existing communication standard. In that case, for example, mutual communication between the portable information terminal 7200 and a headset capable of wireless communication can be performed, and thus hands-free calling is possible.

Moreover, the portable information terminal 7200 includes the input output terminal 7206, and data can be directly transmitted to and received from another information terminal via a connector. In addition, charging via the input output terminal 7206 is possible. Note that the charging operation may be performed by wireless power feeding without using the input output terminal 7206.

The display portion 7202 of the portable information terminal 7200 is provided with a power storage device including an electrode member of one embodiment of the present invention. For example, the power storage device 7104 illustrated in FIG. 20(E) that is in the state of being curved can be provided in the housing 7201. Alternatively, the power storage device 7104 illustrated in FIG. 20(E) can be provided in the band 7203 such that it can be curved.

FIG. 20(G) illustrates an example of an armband display device. A display device 7300 includes a display portion 7304 and the power storage device of one embodiment of the present invention. Furthermore, the display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input output terminal, and data can be directly transmitted to and received from another information terminal via a connector. In addition, charging via the input output terminal is possible. Note that the charging operation may be performed by wireless power feeding without using the input output terminal.

This embodiment can be implemented in combination with the other embodiments as appropriate.

### Embodiment 6

In this embodiment, examples of electronic devices that can include power storage devices will be described.

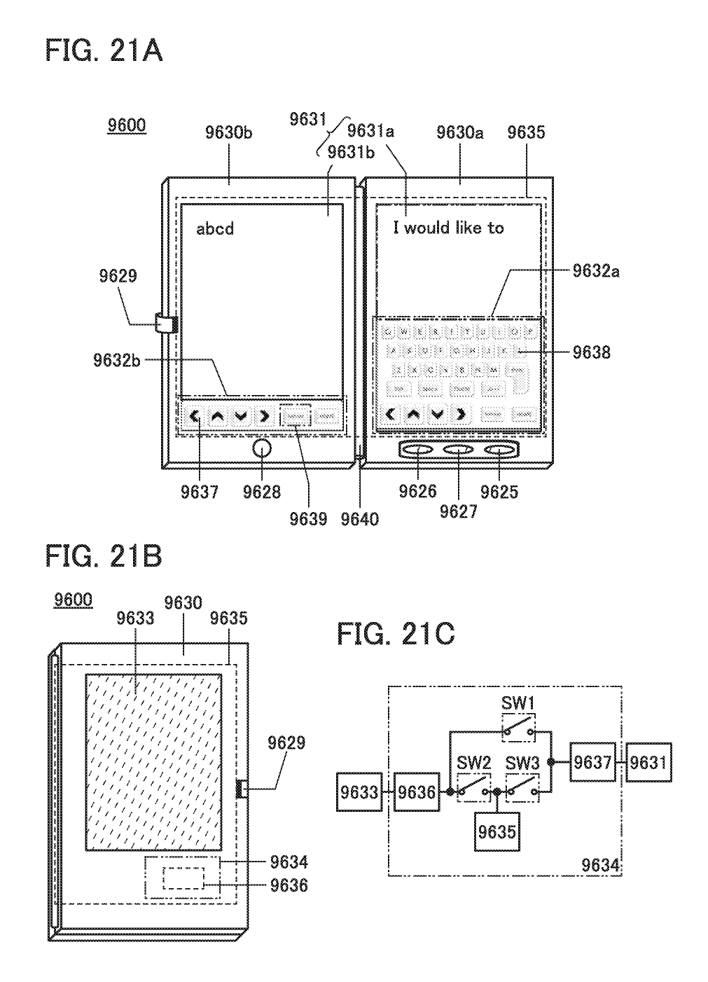

FIG. 21(A) and FIG. 21(B) illustrate an example of a tablet terminal that can be folded in half. A tablet terminal 9600 illustrated in FIG. 21(A) and FIG. 21(B) includes a housing 9630a, a housing 9630b, a movable portion 9640 connecting the housings 9630a and 9630b, a display portion 9631 including a display portion 9631a and a display portion 9631b, a display mode changing switch 9626, a power switch 9627, a power saving mode changing switch 9625, a fastener 9629, and an operation switch 9628. FIG. 21(A) illustrates the tablet terminal 9600 in an opened state, and FIG. 21(B) illustrates the tablet terminal 9600 in a closed state.

The tablet terminal 9600 includes a power storage unit 9635 inside the housings 9630a and 9630b. The power storage unit 9635 is provided across the housings 9630a and 9630b, passing through the movable portion 9640.

Part of the display portion 9631a can be a touch panel region 9632a, and data can be input by touching operation keys 9638 that are displayed. Note that although a structure in which a half of the area of the display portion 9631a has only a display function and the other half of the area has a touch panel function is shown as an example, the structure of the display portion 9631a is not limited to this structure. All the area of the display portion 9631a may have a touch panel function. For example, all the area of the display portion 9631a can display a keyboard and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger, a stylus, or the like, a keyboard can be displayed on the display portion 9631b.

Touch input can be performed in the touch panel region 9632a and the touch panel region 9632b at the same time.

The display mode changing switch 9626 allows switching between a landscape mode and a portrait mode, color display and black-and-white display, and the like. The power saving mode changing switch 9625 can control display luminance in accordance with the amount of external light in use of the tablet terminal 9600, which is measured with an optical sensor incorporated in the tablet terminal 9600. In addition to the optical sensor, other detecting devices such as sensors for determining inclination, such as a gyroscope or an acceleration sensor, may be incorporated in the tablet terminal.

Although the display portion 9631a and the display portion 9631b have the same area in the example illustrated in FIG. 21(A), there is no particular limitation. One display portion and the other display portion may have different sizes or different display qualities. For example, a display panel in which one displays higher definition images than the other may be provided.

The tablet terminal is closed in FIG. 21(B). The tablet terminal includes the housing 9630, a solar cell 9633, and a charge and discharge control circuit 9634 including a DC-DC converter 9636. The power storage unit of one embodiment of the present invention is used as the power storage unit 9635.

The tablet terminal 9600 can be folded in half such that the housings 9630a and 9630b overlap with each other when not in use. Thus, the display portions 9631a and 9631b can be protected by folding, which increases the durability of the tablet terminal 9600. In addition, the power storage unit 9635 using the power storage unit of one embodiment of the present invention has flexibility and can be repeatedly bent and straightened without a significant decrease in charge and discharge capacity. Thus, a highly reliable tablet terminal can be provided.

Furthermore, the tablet terminal illustrated in FIG. 21(A) and FIG. 21(B) can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processing portion, and the like. Note that the solar cell 9633 can be provided on one or both surfaces of the housing 9630, which is preferable because the power storage unit 9635 can be charged efficiently. The use of a lithium-ion battery as the power storage unit 9635 brings an advantage such as reduction in size.

The structure and operation of the charge and discharge control circuit 9634 illustrated in FIG. 21(B) will be described with reference to a block diagram in FIG. 21(C). The solar cell 9633, the power storage unit 9635, the DC-DC converter 9636, a converter 9637, switches SW1 to SW3, and the display portion 9631 are illustrated in FIG. 21(C), and the power storage unit 9635, the DC-DC converter 9636, the converter 9637, and the switches SW1 to SW3 correspond to the charge and discharge control circuit 9634 in FIG. 21(B).

First, an example of operation when electric power is generated by the solar cell 9633 using external light will be described. The voltage of electric power generated by the solar cell is raised or lowered by the DC-DC converter 9636 to a voltage for charging the power storage unit 9635. When the display portion 9631 is operated with the electric power from the solar cell 9633, the switch SW1 is turned on and the voltage of the electric power is raised or lowered to a voltage needed in the display portion 9631 by the converter 9637. When display on the display portion 9631 is not performed, the switch SW1 is turned off and the switch SW2 is turned on, so that the power storage unit 9635 can be charged.

Note that the solar cell 9633 is described as an example of a power generation means; however, one embodiment of the present invention is not limited to this example. The power storage unit 9635 may be charged using another power generation means such as a piezoelectric element or a thermoelectric conversion element (Peltier element). For example, the power storage unit 9635 may be charged with a non-contact power transmission module capable of performing charging by transmitting and receiving electric power wirelessly (without contact), or any of the other charge means used in combination.

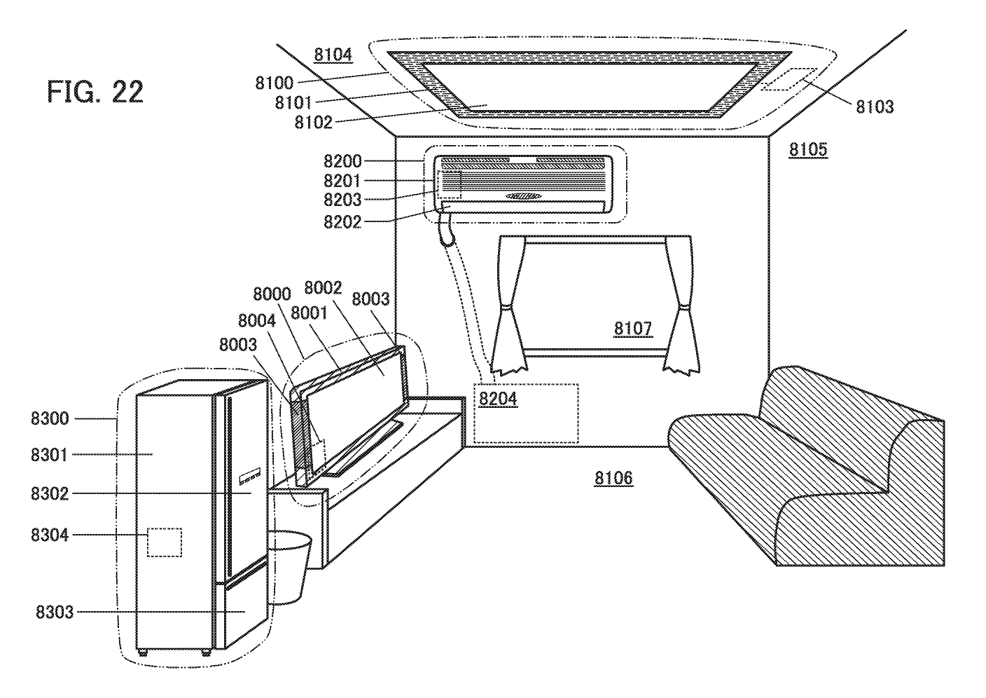

FIG. 22 illustrates other examples of electronic devices. In FIG. 22, a display device 8000 is an example of an electronic device including a power storage device 8004 of one embodiment of the present invention. Specifically, the display device 8000 corresponds to a display device for TV broadcast reception and includes a housing 8001, a display portion 8002, speaker portions 8003, the power storage device 8004, and the like. The power storage device 8004 of one embodiment of the present invention is provided in the housing 8001. The display device 8000 can receive electric power from a commercial power supply. Alternatively, the display device 8000 can use electric power stored in the power storage device 8004. Thus, the display device 8000 can be operated with the use of the power storage device 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides for TV broadcast reception.

In FIG. 22, an installation lighting device 8100 is an example of an electronic device including a power storage device 8103 of one embodiment of the present invention. Specifically, the lighting device 8100 includes a housing 8101, a light source 8102, the power storage device 8103, and the like. Although FIG. 22 illustrates the case where the power storage device 8103 is provided in a ceiling 8104 on which the housing 8101 and the light source 8102 are installed, the power storage device 8103 may be provided in the housing 8101. The lighting device 8100 can receive electric power from a commercial power supply. Alternatively, the lighting device 8100 can use electric power stored in the power storage device 8103. Thus, the lighting device 8100 can be operated with the use of the power storage device 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 22 as an example, the power storage device of one embodiment of the present invention can be used in an installation lighting device provided in, for example, a wall 8105, a floor 8106, a window 8107, or the like other than the ceiling 8104. Alternatively, the power storage device of one embodiment of the present invention can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 22, an air conditioner including an indoor unit 8200 and an outdoor unit 8204 is an example of an electronic device including a power storage device 8203 of one embodiment of the present invention. Specifically, the indoor unit 8200 includes a housing 8201, an air outlet 8202, the power storage device 8203, and the like. Although FIG. 22 illustrates the case where the power storage device 8203 is provided in the indoor unit 8200, the power storage device 8203 may be provided in the outdoor unit 8204. Alternatively, the power storage devices 8203 may be provided in both the indoor unit 8200 and the outdoor unit 8204. The air conditioner can receive electric power from a commercial power supply. Alternatively, the air conditioner can use electric power stored in the power storage device 8203. Particularly in the case where the power storage devices 8203 are provided in both the indoor unit 8200 and the outdoor unit 8204, the air conditioner can be operated with the use of the power storage device 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 22 as an example, the power storage device of one embodiment of the present invention can be used in an air conditioner in which the functions of an indoor unit and an outdoor unit are integrated in one housing.

In FIG. 22, an electric refrigerator-freezer 8300 is an example of an electronic device including a power storage device 8304 of one embodiment of the present invention. Specifically, the electric refrigerator-freezer 8300 includes a housing 8301, a door for a refrigerator 8302, a door for a freezer 8303, the power storage device 8304, and the like. The power storage device 8304 is provided in the housing 8301 in FIG. 22. The electric refrigerator-freezer 8300 can receive electric power from a commercial power supply. Alternatively, the electric refrigerator-freezer 8300 can use electric power stored in the power storage device 8304. Thus, the electric refrigerator-freezer 8300 can be operated with the use of the power storage device 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of an electronic device can be prevented by using the power storage device of one embodiment of the present invention as an auxiliary power supply for supplying electric power which cannot be supplied enough by a commercial power supply.

In addition, in a time period when electronic devices are not used, particularly when the proportion of the amount of electric power which is actually used to the total amount of electric power which can be supplied from a commercial power supply source (such a proportion is referred to as a usage rate of electric power) is low, electric power can be stored in the power storage device, whereby an increase in the usage rate of electric power can be suppressed in a period other than the above-described time period. For example, in the case of the electric refrigerator-freezer 8300, electric power can be stored in the power storage device 8304 in night time when the temperature is low and the door for a refrigerator 8302 and the door for a freezer 8303 are not often opened or closed. Then, in daytime when the temperature is high and the door for a refrigerator 8302 and the door for a freezer 8303 are opened and closed, the power storage device 8304 is used as an auxiliary power supply; thus, the usage rate of electric power in daytime can be suppressed low.

This embodiment can be implemented in combination with the other embodiments as appropriate.

### Embodiment 7

In this embodiment, examples of vehicles using power storage devices will be described.

The use of power storage devices in vehicles enables production of next-generation clean energy vehicles such as hybrid electric vehicles (HEVs), electric vehicles (EVs), and plug-in hybrid electric vehicles (PHEVs).

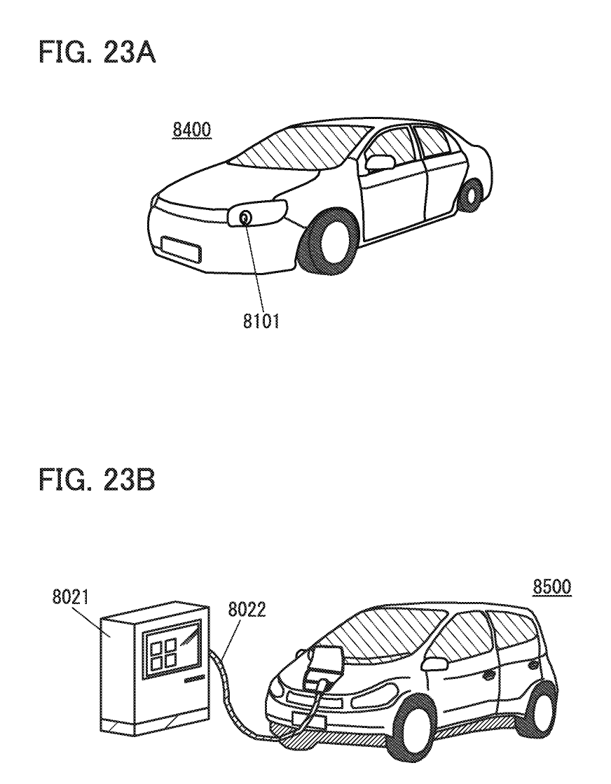

FIG. 23 illustrates an example of a vehicle using one embodiment of the present invention. An automobile 8400 illustrated in FIG. 23(A) is an electric vehicle that runs on the power of an electric motor. Alternatively, the automobile 8400 is a hybrid vehicle capable of appropriately selecting either the electric motor or the engine as the power for running. One embodiment of the present invention can provide a high-mileage vehicle. The automobile 8400 includes the power storage device. The power storage device can not only drive the electric motor, but also supply electric power to a light-emitting device such as a headlight 8401 or a room light (not illustrated).

The power storage device can also supply electric power to a display device of a speedometer, a tachometer, or the like included in the automobile 8400. Furthermore, the power storage device can supply electric power to a semiconductor device included in the automobile 8400, such as a navigation system.

An automobile 8500 illustrated in FIG. 23(B) can be charged when electric power from external charging equipment is received at the power storage device by a plug-in system, a contactless power feeding system, or the like. FIG. 23(B) illustrates a state where a power storage device included in the automobile 8500 is charged with the use of a ground-based charging apparatus 8021 through a cable 8022. In charging, a given method such as CHAdeMO (registered trademark) or Combined Charging System may be employed as a charging method, the standard of a connector, or the like as appropriate. The charging apparatus 8021 may be a charging station provided in a commerce facility or a power source in a house. For example, with the use of a plug-in technique, the power storage device 8024 included in the automobile 8500 can be charged by being supplied with electric power from the outside. The charging can be performed by converting AC electric power into DC electric power through a converter such as an AC-DC converter.

Furthermore, although not illustrated, the vehicle may include a power receiving device so that it can be charged by being supplied with electric power from an above-ground power transmitting device in a contactless manner. In the case of the contactless power feeding system, by embedding a power transmitting device in a road or an exterior wall, charging can be performed not only when the electric vehicle is stopped but also when driven. In addition, the contactless power feeding system may be utilized to perform transmission and reception of electric power between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the power storage device can have improved cycle characteristics and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Furthermore, the power storage device included in the vehicle can be used as a power source for supplying electric power to products other than the vehicle. In such a case, the use of a commercial power source can be avoided at peak time of electric power demand.

This embodiment can be implemented in combination with the other embodiments as appropriate.

### Embodiment 8

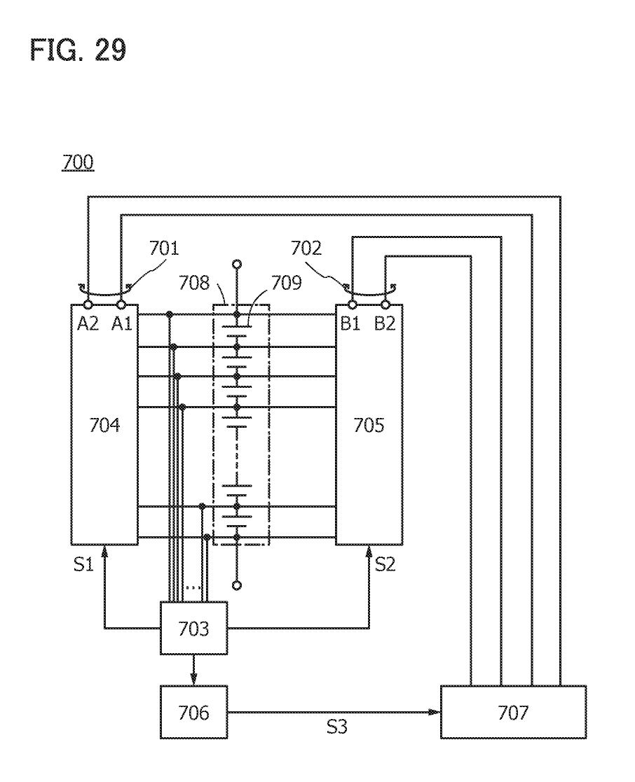

A battery control unit (Battery Management Unit: BMU) that can be used in combination with the battery cells described in the above embodiment and transistors that are suitable for a circuit included in the battery control unit will be described with reference to FIG. 29 to FIG. 35. In this embodiment, in particular, a battery control unit of a power storage device including battery cells connected in series will be described.

When the plurality of battery cells connected in series are repeatedly charged and discharged, variations in characteristics among the battery cells cause variations in capacity (output voltage). The discharge capacity of all the battery cells connected in series depends on the battery cell having a low capacity. The variations in capacity reduce the discharge capacity. Furthermore, when charging is performed based on the battery cell having a low capacity, the battery cells might be undercharged. In contrast, when charging is performed based on the battery cell having a high capacity, the battery cells might be overcharged.

Thus, the battery control unit of the power storage device including the battery cells connected in series has a function of reducing variations in capacity among the battery cells, which cause an undercharge and an overcharge. Examples of a circuit configuration for reducing variations in capacity among battery cells include a resistive type, a capacitive type, and an inductive type, and a circuit configuration that can reduce variations in capacity using transistors with a low off-state current will be explained here as an example.

A transistor including an oxide semiconductor in its channel formation region (an OS transistor) is preferably used as the transistor with a low off-state current. When an OS transistor with a low off-state current is used in the circuit structure of the battery control unit of the power storage device, the amount of charge that leaks from a battery can be reduced, and reduction in capacity with the lapse of time can be suppressed.

As the oxide semiconductor used in the channel formation region, an In-M-Zn oxide (M is Ga, Sn, Y, Zr, La, Ce, or Nd) is used. In the case where the atomic ratio of the metal elements of a target for forming an oxide semiconductor film is In:M:Zn=xi:yi:zi, xi/yi is preferably greater than or equal to ⅓ and less than or equal to 6, further preferably greater than or equal to 1 and less than or equal to 6, and zi/yi is preferably greater than or equal to ⅓ and less than or equal to 6, further preferably greater than or equal to 1 and less than or equal to 6. Note that when zi/yi is greater than or equal to 1 and less than or equal to 6, a CAAC-OS film as the oxide semiconductor film is easily formed.

Here, the CAAC-OS film will be described.

A CAAC-OS film is one of oxide semiconductor films having a plurality of c-axis aligned crystal parts.

From the observation of a combined analysis image (also referred to as a high-resolution TEM image) of a bright-field image and a diffraction pattern of a CAAC-OS film with a transmission electron microscope (TEM), a plurality of crystal parts can be seen. However, in the high-resolution TEM image, a boundary between crystal parts, that is, a grain boundary is not clearly observed. Thus, in the CAAC-OS film, a reduction in electron mobility due to the grain boundary is less likely to occur.

When the high-resolution cross-sectional TEM image of the CAAC-OS film is observed from the direction substantially parallel to the sample surface, it can be seen that metal atoms are arranged in a layered manner in the crystal parts. Each metal atom layer reflects unevenness of a surface over which the CAAC-OS film is formed (also referred to as a formation surface) or the top surface of the CAAC-OS film, and is arranged parallel to the formation surface or the top surface of the CAAC-OS film.

On the other hand, when the plan high-resolution TEM image of the CAAC-OS film is observed from the direction substantially perpendicular to the sample surface, metal atoms are arranged in a triangular or hexagonal arrangement in the crystal parts. However, there is no regularity of arrangement of metal atoms between different crystal parts.

For example, when the structure of a CAAC-OS including an InGaZnO₄ crystal is analyzed by an out-of-plane method using an X-ray diffraction (XRD) apparatus, a peak may appear at a diffraction angle (2θ) of around 31°. This peak is derived from the (009) plane of the InGaZnO₄ crystal, which indicates that crystals in the CAAC-OS film have c-axis alignment, and that the c-axes are aligned in the direction substantially perpendicular to the formation surface or the top surface of the CAAC-OS film.

Note that in analysis of the CAAC-OS film with an InGaZnO₄ crystal by an out-of-plane method, another peak may appear when 2θ is around 36°, in addition to the peak at 2θ of around 31°. The peak at 2θ of around 36° indicates that a crystal having no c-axis alignment is included in part of the CAAC-OS film. It is preferable that in the CAAC-OS film, a peak appear when 2θ is around 31° and that a peak not appear when 2θ is around 36°.

The CAAC-OS film is an oxide semiconductor film with low impurity concentration. The impurity is an element other than the main components of the oxide semiconductor film, such as hydrogen, carbon, silicon, or a transition metal element. In particular, an element (specifically, silicon or the like) having higher strength of bonding to oxygen than a metal element included in an oxide semiconductor film extracts oxygen from the oxide semiconductor film, which results in disorder of the atomic arrangement and reduced crystallinity of the oxide semiconductor film. Furthermore, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

Furthermore, the CAAC-OS film is an oxide semiconductor having a low density of defect states. In some cases, oxygen vacancies in the oxide semiconductor film serve as carrier traps or serve as carrier generation sources when hydrogen is captured therein, for example.

The state in which impurity concentration is low and density of defect states is low (the number of oxygen vacancies is small) is referred to as a “highly purified intrinsic” or “substantially highly purified intrinsic” state. A highly purified intrinsic or substantially highly purified intrinsic oxide semiconductor film has few carrier generation sources, and thus can have a low carrier density. Therefore, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has little variation in electrical characteristics and high reliability. Charge trapped by the carrier traps in the oxide semiconductor film takes a long time to be released and might behave like fixed charge. Thus, the transistor including the oxide semiconductor film having high impurity concentration and a high density of defect states has unstable electrical characteristics in some cases.

Furthermore, variation in the electrical characteristics of the transistor including the CAAC-OS film due to irradiation with visible light or ultraviolet light is small.

Since the OS transistor has a wider band gap than a transistor including silicon in its channel formation region (a Si transistor), dielectric breakdown is unlikely to occur when a high voltage is applied. Although a voltage of several hundreds of volts is generated when battery cells are connected in series, the above-described OS transistor is suitably included in a circuit configuration of a battery control unit in the power storage device which is used for such battery cells.

FIG. 29 is an example of a block diagram of the power storage device. A power storage device 700 illustrated in FIG. 29 includes a terminal pair 701, a terminal pair 702, a switching control circuit 703, a switching circuit 704, a switching circuit 705, a voltage transformation control circuit 706, a voltage transformer circuit 707, and a battery portion 708 including a plurality of battery cells 709 connected in series.

In the power storage device 700 illustrated in FIG. 29, a portion including the terminal pair 701, the terminal pair 702, the switching control circuit 703, the switching circuit 704, the switching circuit 705, the voltage transformation control circuit 706, and the voltage transformer circuit 707 can be referred to as a battery control unit.

The switching control circuit 703 controls operations of the switching circuit 704 and the switching circuit 705. Specifically, the switching control circuit 703 selects battery cells to be discharged (a discharge battery cell group) and battery cells to be charged (a charge battery cell group) in accordance with the voltage measured for every battery cell 709.

Furthermore, the switching control circuit 703 outputs a control signal S1 and a control signal S2 on the basis of the selected discharge battery cell group and the selected charge battery cell group. The control signal S1 is output to the switching circuit 704. The control signal S1 controls the switching circuit 704 so that the terminal pair 701 and the discharge battery cell group are connected. In addition, the control signal S2 is output to the switching circuit 705. The control signal S2 is a signal for controlling the switching circuit 705 so that the terminal pair 702 and the charge battery cell group are connected.

Furthermore, the switching control circuit 703 generates the control signal Si and the control signal S2 on the basis of the structure of the switching circuit 704, the switching circuit 705, and the voltage transformer circuit 707 so that terminals having the same polarity are connected to each other between the terminal pair 702 and the charge battery cell group.

The operations of the switching control circuit 703 will be described in detail.

First, the switching control circuit 703 measures the voltage of each of the plurality of battery cells 709. Then, the switching control circuit 703 determines that the battery cell 709 having a voltage higher than a predetermined threshold value is a high-voltage battery cell (high-voltage cell) and that the battery cell 709 having a voltage lower than the predetermined threshold value is a low-voltage battery cell (low-voltage cell), for example.

As a method to determine whether a battery cell is a high-voltage cell or a low-voltage cell, any of various methods can be employed. For example, the switching control circuit 703 may determine whether each battery cell 709 is a high-voltage cell or a low-voltage cell on the basis of the voltage of the battery cell 709 having the highest voltage or the lowest voltage among the plurality of battery cells 709. In this case, the switching control circuit 703 can determine whether each battery cell 709 is a high-voltage cell or a low-voltage cell by, for example, determining whether or not the ratio of the voltage of each battery cell 709 to the reference voltage is the predetermined value or more. Then, the switching control circuit 703 determines a charge battery cell group and a discharge battery cell group on the basis of the determination result.

Note that high-voltage cells and low-voltage cells are mixed in various states in the plurality of battery cells 709. For example, the switching control circuit 703 selects a portion having the largest number of high-voltage cells that are consecutively connected in series among the mixed high-voltage and low-voltage cells as the discharge battery cell group. Furthermore, the switching control circuit 703 selects a portion having the largest number of low-voltage cells that are consecutively connected in series as the charge battery cell group. In addition, the switching control circuit 703 may preferentially select the battery cells 709 which are almost overcharged or over-discharged as the discharge battery cell group or the charge battery cell group.

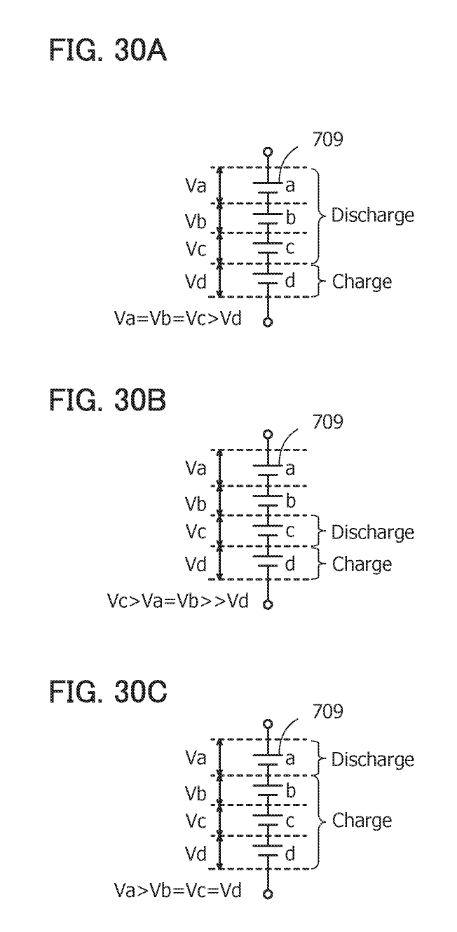

Here, operation examples of the switching control circuit 703 in this embodiment will be described with reference to FIG. 30. FIG. 30 is a view for explaining the operation examples of the switching control circuit 703. Note that FIG. 30 illustrates the case where four battery cells 709 are connected in series as an example for convenience of explanation.

First, in the example in FIG. 30(A), the case where the relation of voltages Va, Vb, Vc, and Vd is Va=Vb=Vc>Vd where the voltage Va to the voltage Vd are the voltages of battery cells a to d is shown. That is, a series of three high-voltage cells a to c and one low-voltage cell d are connected in series. In this case, the switching control circuit 703 selects the series of three high-voltage cells a to c as the discharge battery cell group. In addition, the switching control circuit 703 selects the low-voltage cell D as the charge battery cell group.

Next, in the example in FIG. 30(B), the case where the relation of the voltages is Vc>Va=Vb>>Vd is shown. That is, a series of two low-voltage cells a and b, one high-voltage cell c, and one low-voltage cell d which is almost over-discharged are connected in series. In this case, the switching control circuit 703 selects the high-voltage cell c as the discharge battery cell group. Since the low-voltage cell d is almost over-discharged, the switching control circuit 703 preferentially selects the low-voltage cell d as the charge battery cell group instead of the series of two low-voltage cells a and b.

Lastly, in the example in FIG. 30(C), the case where the relation of the voltages is Va>Vb=Vc=Vd is shown. That is, one high-voltage cell a and a series of three low-voltage cells b to d are connected in series. In this case, the switching control circuit 703 selects the high-voltage cell a as the discharge battery cell group. In addition, the switching control circuit 703 selects the series of three low-voltage cells b to d as the charge battery cell group.

On the basis of the determination result shown in the examples of FIG. 30(A) to FIG. 30(C), the switching control circuit 703 outputs the control signal S1 and the control signal S2 to the switching circuit 704 and the switching circuit 705, respectively. Information showing the discharge battery cell group, which is the connection destination of the switching circuit 704, is set in the control signal S1. Information showing the charge battery cell group, which is the connection destination of the switching circuit 705 is set in the control signal S2.

The above is the detailed description of the operations of the switching control circuit 703.

The switching circuit 704 sets the connection destination of the terminal pair 701 at the discharge battery cell group selected by the switching control circuit 703, in response to the control signal Si output from the switching control circuit 703.

The terminal pair 701 includes a pair of terminals A1 and A2. The switching circuit 704 sets the connection destination of the terminal pair 701 by connecting one of the terminals A1 and vA2 to a positive electrode terminal of the battery cell 709 positioned on the most upstream side (on the high potential side) of the discharge battery cell group, and the other to a negative electrode terminal of the battery cell 709 positioned on the most downstream side (on the low potential side) of the discharge battery cell group. Note that the switching circuit 704 can recognize the position of the discharge battery cell group on the basis of the information set in the control signal Si.

The switching circuit 705 sets the connection destination of the terminal pair 702 at the charge battery cell group selected by the switching control circuit 703, in response to the control signal S2 output from the switching control circuit 703.

The terminal pair 702 includes a pair of terminals B1 and B2. The switching circuit 705 sets the connection destination of the terminal pair 702 by connecting one of the terminals B1 and B2 to a positive electrode terminal of the battery cell 709 positioned on the most upstream side (on the high potential side) of the charge battery cell group, and the other to a negative electrode terminal of the battery cell 709 positioned on the most downstream side (on the low potential side) of the charge battery cell group. Note that the switching circuit 705 can recognize the position of the charge battery cell group on the basis of the information set in the control signal S2.

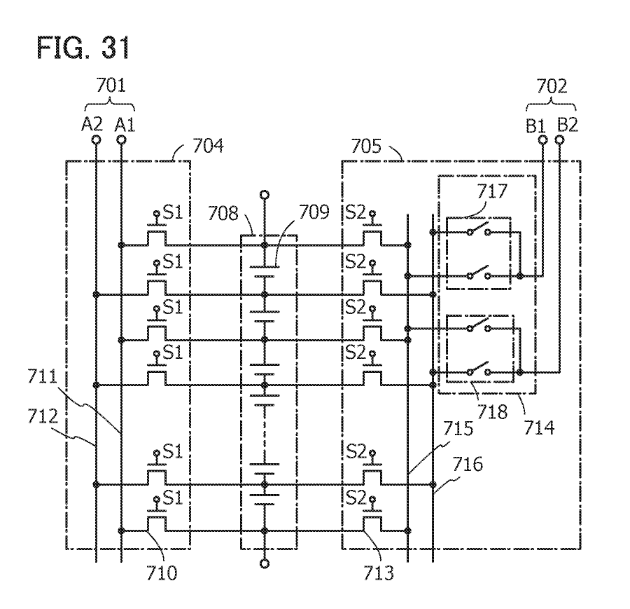

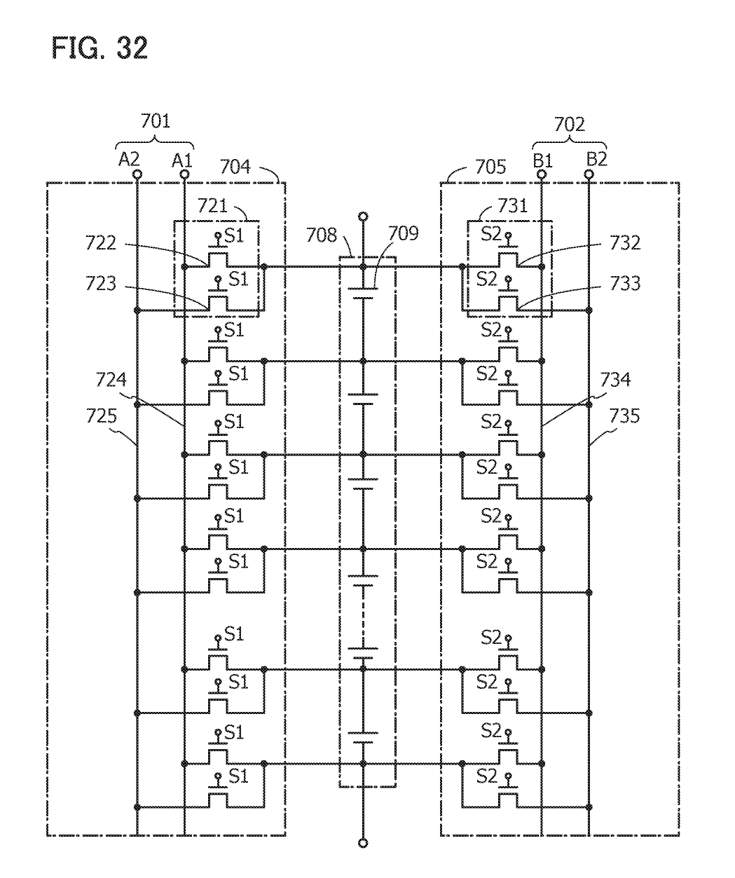

FIG. 31 and FIG. 32 are circuit diagrams showing configuration examples of the switching circuit 704 and the switching circuit 705.

In FIG. 31, the switching circuit 704 includes a plurality of transistors 710, a bus 711, and a bus 712. The bus 711 is connected to the terminal A1. The bus 712 is connected to the terminal A2. Either sources or drains of the plurality of transistors 710 are connected alternately to the bus 711 and the bus 712. The other of the sources and the drains of the plurality of transistors 710 are each connected between two adjacent battery cells 709.

The other of the source and the drain of the transistor 710 positioned on the most upstream side of the plurality of transistors 710 is connected to the positive electrode terminal of the battery cell 709 positioned on the most upstream side of the battery portion 708. The other of the source and drain of the transistor 710 positioned on the most downstream side of the plurality of transistors 710 is connected to the negative electrode terminal of the battery cell 709 positioned on the most downstream side of the battery portion 708.

The switching circuit 704 connects the discharge battery cell group to the terminal pair 701 by bringing one of the plurality of transistors 710 which are connected to the bus 711 and one of the plurality of transistors 710 which are connected to the bus 712 into an on state in response to the control signal Si supplied to gates of the plurality of transistors 710. Accordingly, the positive electrode terminal of the battery cell 709 positioned on the most upstream side of the discharge battery cell group is connected to one of the pair of terminals A1 and A2. In addition, the negative electrode terminal of the battery cell 709 positioned on the most downstream side of the discharge battery cell group is connected to the other of the pair of terminals A1 and A2 (i.e., a terminal which is not connected to the positive electrode terminal).

An OS transistor is preferably used as the transistor 710. Since the off-state current of the OS transistor is low, the amount of charge that leaks from the battery cell which does not belong to the discharge battery cell group can be reduced, and reduction in capacity with the lapse of time can be suppressed. In addition, dielectric breakdown is unlikely to occur in the OS transistor when a high voltage is applied. Therefore, the battery cell 709 and the terminal pair 701, which are connected to the transistor 710 in an off state, can be insulated from each other even when the output voltage of the discharge battery cell group is high.

In FIG. 31, the switching circuit 705 includes a plurality of transistors 713, a current control switch 714, a bus 715, and a bus 716. The bus 715 and the bus 716 are provided between the plurality of transistors 713 and the current control switch 714. Either sources or drains of the plurality of transistors 713 are connected alternately to the bus 715 and the bus 716. The other of the sources and the drains of the plurality of transistors 713 are each connected between two adjacent battery cells 709.

The other of the source and the drain of the transistor 713 positioned on the most upstream side of the plurality of transistors 713 is connected to the positive electrode terminal of the battery cell 709 positioned on the most upstream side of the battery portion 708. Furthermore, the other of the source and the drain of the transistor 713 positioned on the most downstream side of the plurality of transistors 713 is connected to the negative electrode terminal of the battery cell 709 on the most downstream side of the battery portion 708.

An OS transistor is preferably used as the transistors 713 like the transistors 710. Since the off-state current of the OS transistor is low, the amount of charge that leaks from the battery cells which do not belong to the charge battery cell group can be reduced, and reduction in capacity with the lapse of time can be suppressed. In addition, dielectric breakdown is unlikely to occur in the OS transistor when a high voltage is applied. Therefore, the battery cell 709 and the terminal pair 702, which are connected to the transistor 713 in an off state, can be insulated from each other even when a voltage for charging the charge battery cell group is high.

The current control switch 714 includes a switch pair 717 and a switch pair 718. A terminal on one end of the switch pair 717 is connected to the terminal B1. A terminal on the other end of the switch pair 717 branches off by two switches; one switch is connected to the bus 715 and the other switch is connected to the bus 716. A terminal on one end of the switch pair 718 is connected to the terminal B2. A terminal on the other end of the switch pair 718 branches off by two switches: one switch is connected to the bus 715 and the other switch is connected to the bus 716.

OS transistors are preferably used for the switches included in the switch pair 717 and the switch pair 718 like the transistors 710 and 713.

The switching circuit 705 connects the charge battery cell group and the terminal pair 702 by controlling the combination of on/off states of the transistors 713 and the current control switch 714 in response to the control signal S2.

For example, the switching circuit 705 connects the charge battery cell group and the terminal pair 702 in the following manner.

The switching circuit 705 brings a transistor 713 connected to the positive electrode terminal of the battery cell 709 on the most upstream side of the charge battery cell group into an on state in response to the control signal S2 supplied to gates of the plurality of transistors 710. In addition, the switching circuit 705 brings a transistor 713 connected to the negative electrode terminal of the battery cell 709 on the most downstream side of the charge battery cell group into an on state in response to the control signal S2 supplied to the gates of the plurality of transistors 710.

The polarities of voltages applied to the terminal pair 702 can vary in accordance with the configurations of the voltage transformer circuit 707 and the discharge battery cell group connected to the terminal pair 701. In order to supply a current in the direction for charging the charge battery cell group, terminals with the same polarity are required to be connected to each other between the terminal pair 702 and the charge battery cell group. In view of this, the current control switch 714 is controlled by the control signal S2 so that the connection destination of the switch pair 717 and that of the switch pair 718 are changed in accordance with the polarities of the voltages applied to the terminal pair 702.

The state where voltages are applied to the terminal pair 702 so as to make the terminal B1 a positive electrode and the terminal B2 a negative electrode will be described as an example. Here, in the case where the battery cell 709 positioned on the most downstream side of the battery portion 708 is in the charge battery cell group, the switch pair 717 is controlled to be connected to the positive electrode terminal of the battery cell 709 in response to the control signal S2. That is, the switch of the switch pair 717 connected to the bus 716 is turned on, and the switch of the switch pair 717 connected to the bus 715 is turned off. In contrast, the switch pair 718 is controlled to be connected to the negative electrode terminal of the battery cell 709 in response to the control signal S2. That is, the switch of the switch pair 718 connected to the bus 715 is turned on, and the switch of the switch pair 718 connected to the bus 716 is turned off. In this manner, terminals with the same polarity are connected to each other between the terminal pair 702 and the charge battery cell group. In addition, the direction of the current which flows from the terminal pair 702 is controlled to be a direction of charging the charge battery cell group.

In addition, instead of the switching circuit 705, the switching circuit 704 may include the current control switch 714. In that case, the polarities of the voltages applied to the terminal pair 702 are controlled by controlling the polarities of the voltages applied to the terminal pair 701 in response to the current control switch 714 and the control signal S 1. Thus, the current control switch 714 controls the direction of current which flows from the terminal pair 702 to the charge battery cell group.

FIG. 32 is a circuit diagram illustrating a configuration example of the switching circuit 704 and the switching circuit 705 which is different from that in FIG. 31.

In FIG. 32, the switching circuit 704 includes a plurality of transistor pairs 721, a bus 724, and a bus 725. The bus 724 is connected to the terminal A1. The bus 725 is connected to the terminal A2. A terminal on one end of each of the plurality of transistor pairs 721 branches off by a transistor 722 and a transistor 723. Either sources or drains of the transistors 722 are connected to the bus 724. The other of the sources and the drains of the transistors 723 are connected to the bus 725. In addition, terminals on the other end of each of the plurality of transistor pairs are connected between two adjacent battery cells 709. The terminals on the other end of the transistor pair 721 positioned on the most upstream side of the plurality of transistor pairs 721 are connected to the positive electrode terminal of the battery cell 709 positioned on the most upstream side of the battery portion 708. The terminals on the other end of the transistor pair 721 positioned on the most downstream side of the plurality of transistor pairs 721 are connected to a negative electrode terminal of the battery cell 709 on the most downstream side of the battery portion 708.

The switching circuit 704 switches the connection destination of the transistor pair 721 to one of the terminal A1 and the terminal A2 by turning on/off the transistor 722 and the transistor 723 in response to the control signal S1. Specifically, when the transistor 722 is turned on, the transistor 723 is turned off, so that the connection destination of the transistor pair 721 is the terminal A1. On the other hand, when the transistor 723 is turned on, the transistor 722 is turned off, so that the connection destination of the transistor pair 721 is the terminal A2.

Which of the transistors 722 and 723 is turned on is determined by the control signal S1.

Two transistor pairs 721 are used to connect the terminal pair 701 and the discharge battery cell group. Specifically, the connection destinations of the two transistor pairs 721 are determined on the basis of the control signal S1, and the discharge battery cell group and the terminal pair 701 are connected. The connection destinations of the two transistor pairs 721 are controlled by the control signal S1 so that one of the connection destinations is the terminal A1 and the other is the terminal A2.

The switching circuit 705 includes a plurality of transistor pairs 731, a bus 734, and a bus 735. The bus 734 is connected to the terminal B1. The bus 735 is connected to the terminal B2. Terminals on one end of each of the plurality of transistor pairs 731 branch off by a transistor 732 and a transistor 733. One terminal which branches off by the transistor 732 is connected to the bus 734. Further, one terminal which branches off by the transistor 733 is connected to the bus 735. Terminals on the other end of each of the plurality of transistor pairs 731 are connected between two adjacent battery cells 709. The terminal on the other end of the transistor pair 731 positioned on the most upstream side of the plurality of transistor pairs 731 is connected to the positive electrode terminal of the battery cell 709 positioned on the most upstream side of the battery portion 708. The terminal on the other end of the transistor pair 731 on the most downstream side of the plurality of transistor pairs 731 is connected to the negative electrode terminal of the battery cell 709 positioned on the most downstream side of the battery portion 708.

The switching circuit 705 switches the connection destination of the transistor pair 731 to one of the terminal B1 and the terminal B2 by turning on or off the transistor 732 and the transistor 733 in response to the control signal S2. Specifically, when the transistor 732 is turned on, the transistor 733 is turned off, so that the connection destination of the transistor pair 731 is the terminal B1. On the other hand, when the transistor 733 is turned on, the transistor 732 is turned off, so that the connection destination of the transistor pair 731 is the terminal B2. Which of the transistors 732 and 733 is turned on is determined by the control signal S2.

Two transistor pairs 731 are used to connect the terminal pair 702 and the charge battery cell group. Specifically, the connection destinations of the two transistor pairs 731 are determined on the basis of the control signal S2, and the charge battery cell group and the terminal pair 702 are connected. The connection destinations of the two transistor pairs 731 are controlled by the control signal S2 so that one of the connection destinations is the terminal B1 and the other is the terminal B2.

The connection destinations of the two transistor pairs 731 are determined by the polarities of the voltages applied to the terminal pair 702. Specifically, in the case where voltages which make the terminal B1 a positive electrode and the terminal B2 a negative electrode are applied to the terminal pair 702, the transistor pair 731 on the upstream side is controlled by the control signal S2 so that the transistor 732 is turned on and the transistor 733 is turned off. In contrast, the transistor pair 731 on the downstream side is controlled by the control signal S2 so that the transistor 733 is turned on and the transistor 732 is turned off. In the case where voltages which make the terminal B1 a negative electrode and the terminal B2 a positive electrode are applied to the terminal pair 702, the transistor pair 731 on the upstream side is controlled by the control signal S2 so that the transistor 733 is turned on and the transistor 732 is turned off. In contrast, the transistor pair 731 on the downstream side is controlled by the control signal S2 so that the transistor 732 is turned on and the transistor 733 is turned off. In this manner, terminals with the same polarity are connected to each other between the terminal pair 702 and the charge battery cell group. In addition, the direction of the current which flows from the terminal pair 702 is controlled to be the direction for charging the charge battery cell group.

The voltage transformation control circuit 706 controls the operation of the voltage transformer circuit 707. The voltage transformation control circuit 706 generates a voltage transformation signal S3 for controlling the operation of the voltage transformer circuit 707 on the basis of the number of the battery cells 709 included in the discharge battery cell group and the number of the battery cells 709 included in the charge battery cell group and outputs the voltage transformation signal S3 to the voltage transformer circuit 707.

In the case where the number of the battery cells 709 included in the discharge battery cell group is larger than that included in the charge battery cell group, it is necessary to prevent a charging voltage which is too high from being applied to the charge battery cell group. Thus, the voltage transformation control circuit 706 outputs the voltage transformation signal S3 for controlling the voltage transformer circuit 707 so that a discharging voltage (Vdis) is lowered within a range where the charge battery cell group can be charged.

In the case where the number of the battery cells 709 included in the discharge battery cell group is less than or equal to that included in the charge battery cell group, a charging voltage necessary for charging the charge battery cell group needs to be ensured. Therefore, the voltage transformation control circuit 706 outputs the voltage transformation signal S3 for controlling the voltage transformer circuit 707 so that the discharging voltage (Vdis) is raised within a range where a charging voltage which is too high is not applied to the charge battery cell group.

The voltage value of the charging voltage which is too high is determined in the light of product specifications and the like of the battery cell 709 used in the battery portion 708. The voltage which is raised or lowered by the voltage transformer circuit 707 is applied as a charging voltage (Vcha) to the terminal pair 702.

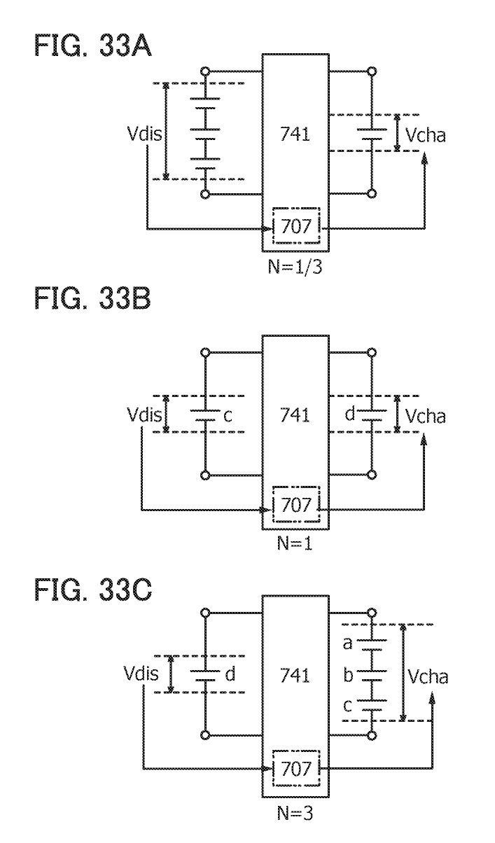

Here, operation examples of the voltage transformation control circuit 706 in this embodiment will be described with reference to FIG. 33(A) to FIG. 33(C). FIG. 33(A) to FIG. 33(C) are conceptual diagrams for explaining the operation examples of the voltage transformation control circuits 706 for the discharge battery cell groups and the charge battery cell groups described in FIG. 30(A) to FIG. 30(C). FIG. 33(A) to FIG. 33(C) illustrate a battery control unit 741. As described above, the battery control unit 741 includes the terminal pair 701, the terminal pair 702, the switching control circuit 703, the switching circuit 704, the switching circuit 705, the voltage transformation control circuit 706, and the voltage transformer circuit 707.

In an example illustrated in FIG. 33(A), the series of three high-voltage cells a to c and one low-voltage cell d are connected in series as described in FIG. 30(A). In this case, as described using FIG. 30(A), the switching control circuit 703 determines the high-voltage cells a to c as the discharge battery cell group, and determines the low-voltage cell d as the charge battery cell group. The voltage transformation control circuit 706 calculates a ratio N for raising or lowering voltage of the discharging voltage (Vdis based on the ratio of the number of the battery cells 709 included in the charge battery cell group to the number of the battery cells 709 included in the discharge battery cell group.

In the case where the number of the battery cells 709 included in the discharge battery cell group is larger than that included in the charge battery cell group, when a discharging voltage is applied to the terminal pair 702 without transforming the voltage, an overvoltage may be applied to the battery cells 709 included in the charge battery cell group through the terminal pair 702. Thus, in the case of FIG. 33(A), it is necessary that a charging voltage (Vcha) applied to the terminal pair 702 be lower than the discharging voltage. In addition, in order to charge the charge battery cell group, it is necessary that the charging voltage be higher than the total voltage of the battery cells 709 included in the charge battery cell group. Thus, the voltage transformation control circuit 706 sets the ratio N for raising or lowering voltage larger than the ratio of the number of the battery cells 709 included in the charge battery cell group to the number of the battery cells 709 included in the discharge battery cell group.

Thus, the voltage transformation control circuit 706 preferably sets the ratio N for raising or lowering voltage larger than the ratio of the number of the battery cells 709 included in the charge battery cell group to the number of the battery cells 709 included in the discharge battery cell group by about 1% to 10%. Here, the charging voltage is made higher than the voltage of the charge battery cell group, but the charging voltage is equal to the voltage of the charge battery cell group in reality. Note that the voltage transformation control circuit 706 feeds a current for charging the charge battery cell group in accordance with the ratio N for raising or lowering voltage in order to make the voltage of the charge battery cell group equal to the charging voltage. The value of the current is set by the voltage transformation control circuit 706.

In the example illustrated in FIG. 33(A), since the number of the battery cells 709 included in the discharge battery cell group is three and the number of the battery cells 709 included in the charge battery cell group is one, the voltage transformation control circuit 706 calculates a value which is slightly larger than 1/3 as the ratio N for raising or lowering voltage. Then, the voltage transformation control circuit 706 outputs the voltage transformation signal S3, which lowers the discharging voltage in accordance with the ratio N for raising or lowering voltage and converts the voltage into a charging voltage, to the voltage transformer circuit 707. The voltage transformer circuit 707 applies the charging voltage which is obtained by transformation in response to the voltage transformation signal S3 to the terminal pair 702. Then, the battery cells 709 included in the charge battery cell group are charged with the charging voltage applied to the terminal pair 702.

In each of examples illustrated in FIG. 33(B) and FIG. 33(C), the ratio N for raising or lowering voltage is calculated in a manner similar to that of FIG. 33(A). In each of the examples illustrated in FIG. 33(B) and FIG. 33(C), since the number of the battery cells 709 included in the discharge battery cell group is less than or equal to the number of the battery cells 709 included in the charge battery cell group, the ratio N for raising or lowering voltage is 1 or more. Therefore, in this case, the voltage transformation control circuit 706 outputs the voltage transformation signal S3 for raising the discharging voltage and converting the voltage into the charging voltage.

The voltage transformer circuit 707 converts the discharging voltage applied to the terminal pair 701 into a charging voltage in response to the voltage transformation signal S3. The voltage transformer circuit 707 applies the charging voltage to the terminal pair 702. Here, the voltage transformer circuit 707 electrically insulates the terminal pair 701 from the terminal pair 702. Accordingly, the voltage transformer circuit 707 prevents a short circuit due to a difference between the absolute voltage of the negative electrode terminal of the battery cell 709 positioned on the most downstream side of the discharge battery cell group and the absolute voltage of the negative electrode terminal of the battery cell 709 positioned on the most downstream side of the charge battery cell group. Furthermore, the voltage transformer circuit 707 converts the discharging voltage, which is the total voltage of the discharge battery cell group, into the charging voltage in response to the voltage transformation signal S3 as described above.

For example, an insulated DC (direct current)-DC converter or the like can be used in the voltage transformer circuit 707. In that case, the voltage transformation control circuit 706 controls the charging voltage converted by the voltage transformer circuit 707 by outputting a signal for controlling the on/off ratio (the duty ratio) of the insulated DC-DC converter as the voltage transformation signal S3.

Note that examples of the insulated DC-DC converter include a flyback converter, a forward converter, a ringing choke converter (RCC), a push-pull converter, a half-bridge converter, and a full-bridge converter, and a suitable converter is selected in accordance with the value of the intended output voltage.

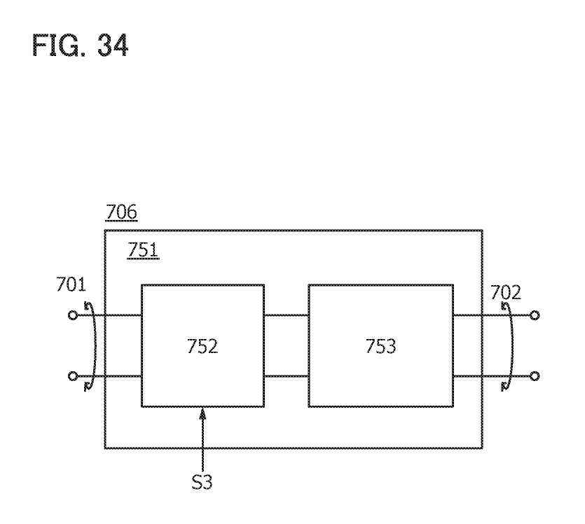

The configuration of the voltage transformer circuit 707 including the insulated DC-DC converter is illustrated in FIG. 34. An insulated DC-DC converter 751 includes a switch portion 752 and a transformer 753. The switch portion 752 is a switch for switching on/off the operation of the insulated DC-DC converter, and a metal-oxide-semiconductor field-effect transistor (MOSFET), a bipolar transistor, or the like is used as the switch portion 752. The switch portion 752 periodically turns on and off the insulated DC-DC converter 751 in response to the voltage transformation signal S3 for controlling the on/off ratio which is output from the voltage transformation control circuit 706. Note that the switch portion 752 can have any of various structures in accordance with the type of the insulated DC-DC converter which is used. The transformer 753 converts the discharging voltage applied from the terminal pair 701 into the charging voltage. Specifically, the transformer 753 operates in conjunction with the on/off state of the switch portion 752 and converts the discharging voltage into the charging voltage in accordance with the on/off ratio. As the time during which the switch portion 752 is on becomes longer in its switching period, the charging voltage is increased. Further, as the time during which the switch portion 752 is on becomes shorter in its switching period, the charging voltage is decreased. In the case where the insulated DC-DC converter is used, the terminal pair 701 and the terminal pair 702 can be insulated from each other inside the transformer 753.

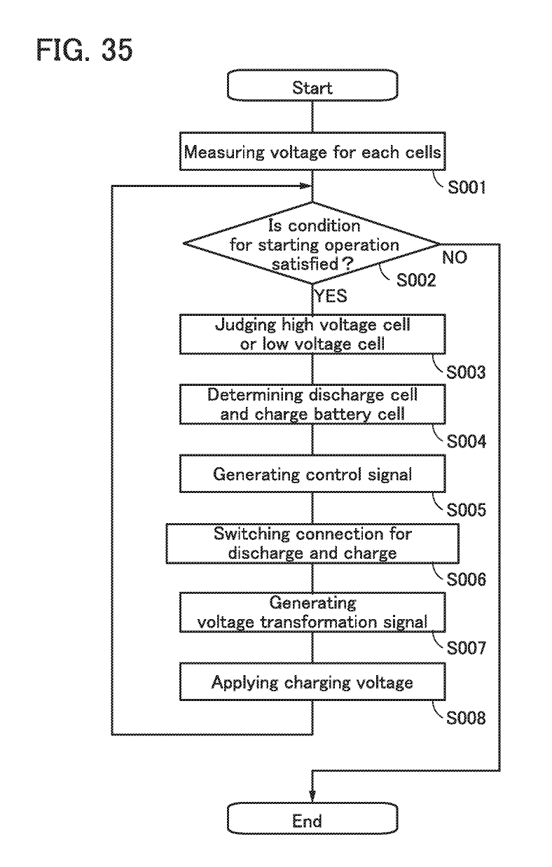

A flow of operations of the power storage device 700 in this embodiment will be described with reference to FIG. 35. FIG. 35 is a flow chart showing the flow of the operations of the power storage device 700.

First, the power storage device 700 obtains a voltage measured for each of the plurality of battery cells 709 (step S001). Then, the power storage device 700 determines whether or not the condition for starting the operation of reducing variations in voltage of the plurality of battery cells 709 is satisfied (step S002). For example, this starting condition is that the difference between the maximum value and the minimum value of the voltage measured in each of the plurality of battery cells 709 is higher than or equal to the predetermined threshold value. In the case where the starting condition is not satisfied (step S002: NO), the power storage device 700 does not perform the following operation because voltages of the battery cells 709 are well balanced. In contrast, in the case where the starting condition is satisfied (step S002: YES), the power storage device 700 performs the operation of reducing variations in the voltage of the battery cells 709. In this operation, the power storage device 700 determines whether each battery cell 709 is a high voltage cell or a low voltage cell on the basis of the measured voltage of each cell (step S003). Then, the power storage device 700 determines a discharge battery cell group and a charge battery cell group on the basis of the determination result (step S004).

In addition, the power storage device 700 generates the control signal S1 for setting the connection destination of the terminal pair 701 to the determined discharge battery cell group, and the control signal S2 for setting the connection destination of the terminal pair 702 to the determined charge battery cell group (step S005). The power storage device 700 outputs the generated control signals S1 and S2 to the switching circuit 704 and the switching circuit 705, respectively. Then, the switching circuit 704 connects the terminal pair 701 and the discharge battery cell group, and the switching circuit 705 connects the terminal pair 702 and the discharge battery cell group (step S006). The power storage device 700 generates the voltage transformation signal S3 based on the number of the battery cells 709 included in the discharge battery cell group and the number of the battery cells 709 included in the charge battery cell group (step S007). Then, the power storage device 700 converts, in response to the voltage transformation signal S3, the discharging voltage applied to the terminal pair 701 into a charging voltage and applies the charging voltage to the terminal pair 702 (step S008). In this way, charge of the discharge battery cell group is transferred to the charge battery cell group.

Although the plurality of steps are shown in order in the flow chart of FIG. 35, the order of performing the steps is not limited to that order.

According to this embodiment, when charge is transferred from the discharge battery cell group to the charge battery cell group, a structure where charge from the discharge battery cell group is temporarily stored and then sent to the charge battery cell group is unnecessary, unlike in the capacitive type. Accordingly, the charge transfer efficiency per unit time can be increased. In addition, the switching circuit 704 and the switching circuit 705 can separately switch the discharge battery cell group and the charge battery cell group.

Furthermore, the voltage transformer circuit 707 converts the discharging voltage applied to the terminal pair 701 into the charging voltage based on the number of the battery cells 709 included in the discharge battery cell group and the number of the battery cells 709 included in the charge battery cell group, and applies the charging voltage to the terminal pair 702. Thus, charge can be transferred without any problems regardless of how the battery cells 709 on the discharge side or the charging side are selected.

Furthermore, the use of OS transistors as the transistor 710 and the transistor 713 can reduce the amount of charge that leaks from the battery cells 709 not belonging to the charge battery cell group or the discharge battery cell group. Accordingly, a decrease in the capacity of the battery cells 709 which do not contribute to charging or discharging can be suppressed. In addition, the variations in characteristics of the OS transistor due to heat are smaller than those of a Si transistor. Accordingly, even when the temperature of the battery cells 709 is increased, an operation such as turning on or off the transistors in response to the control signals Si and S2 can be performed normally.

This embodiment can be implemented in combination with the other embodiments as appropriate.

### Example

In this example, the thin storage battery described in the above embodiment was fabricated as a power storage device using one embodiment of the present invention, and the characteristics thereof were evaluated.

A pair of electrodes, the positive electrode 503 and the negative electrode 506, were used in the thin storage battery. Note that the area of a surface of the positive electrode 503 on the negative electrode 506 side was set substantially equal to that of a surface of the negative electrode 506 on the positive electrode 503 side.

### [Fabrication of Electrodes]

First, fabrication of the positive electrode and the negative electrode will be described.

First, the composition and fabricating conditions of the negative electrode active material layer will be described. Spherical natural graphite having a specific surface area of 6.3 m²/g and an average particle size of 15 μm was used as an active material. As a binding agent, sodium carboxymethyl cellulose (CMC-Na) and SBR were used. The polymerization degree of CMC-Na that was used was 600 to 800, and the viscosity of a 1% CMC-Na aqueous solution was in the range from 300 mPa·s to 500 mPa·s. The composition of a slurry for fabricating the electrode was as follows: graphite:CMC-Na:SBR=97:1.5:1.5 (wt %).

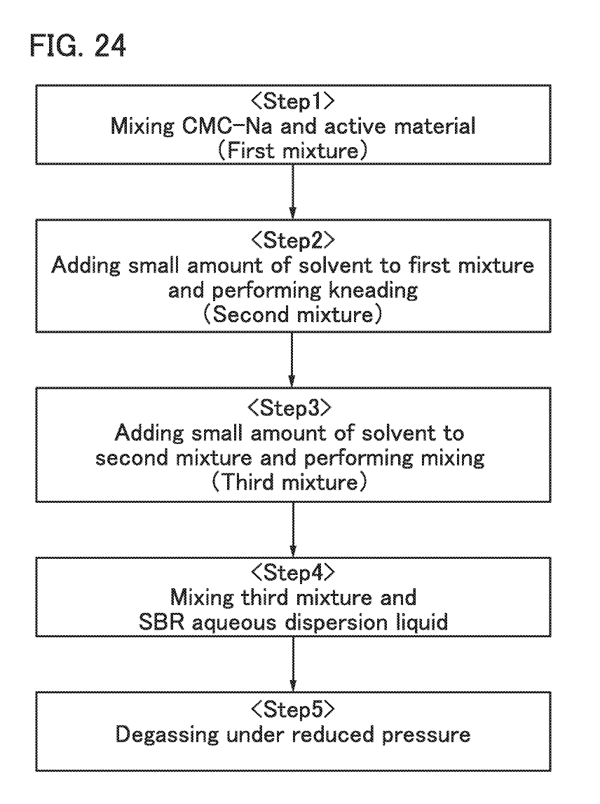

Next, formation of the slurry for the negative electrode will be described using a flow chart in FIG. 24.

First, CMC-Na powder and an active material were added together and mixed with a mixer (Step 1). The mixture is referred to as a first mixture.

Then, a small amount of water was added to the first mixture and kneading was performed, so that a second mixture was obtained (Step 2). At this time, water is preferably added little by little in order to prevent, for example, cohesion of CMC-Na and the active material.

Then, a solvent was further added and mixing was performed with a mixer (Step 3). This mixture is referred to as a third mixture. The viscosity is preferably decreased in advance before addition of SBR, so that separation and precipitation of SBR due to strong stirring can be prevented in some cases. Furthermore, mixing of air bubbles by stirring can be reduced in some cases, which is preferable.

Next, a 50 wt % SBR aqueous dispersion liquid was added, and mixing was performed with a mixer (Step 4). After that, degassing under a reduced pressure was performed to obtain a slurry for application to the electrode (Step 5).

Then, the paste was applied to a current collector with the use of a continuous coater. An 18-μm-thick rolled copper foil was used as the current collector. The coating speed was set to 0.75 m/min.

Then, the coated electrode was dried in a drying furnace. The drying conditions were performed in an air atmosphere. The drying temperature and time were as follows: drying was performed at 50° C. for 120 seconds and then at 80° C. for 120 seconds.

Furthermore, drying was performed at 100° C. under a reduced-pressure atmosphere for 10 hours.

Through the above steps, the negative electrode active material layer was formed over one surface of the current collector.

After that, heat treatment was further performed. The heat treatment was performed at 100° C. for 10 hours in an air atmosphere, so that a film was formed on a surface of the current collector.

Through the above steps, the negative electrode was fabricated.

Next, the composition and fabricating conditions of the positive electrode will be described. LiFePO₄ with a specific surface area of 9.2 m²/g was used as an active material, PVdF was used as a binding agent, and graphene was used as a conductive additive. Note that graphene was originally graphene oxide in the formation of the slurry and obtained by reduction treatment after application of the electrode. The composition of the slurry for fabricating the electrode was set to LiFePO₄: graphene oxide: PVdF=94.4: 0.6: 5.0 (wt %).

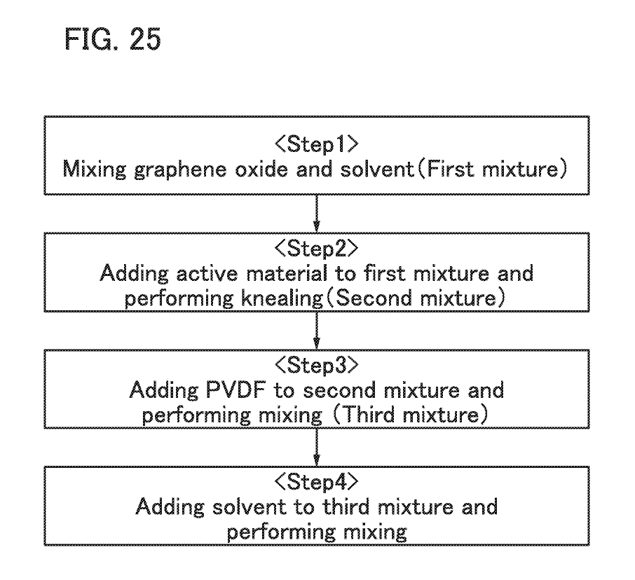

Next, a method for forming the slurry for the positive electrode will be described using a flow chart in FIG. 25.

First, graphene oxide powder and NMP serving as a solvent were mixed with a mixer, so that a first mixture was obtained (Step 1).

Then, the active material was added to the first mixture and the mixture was kneaded with a mixer, so that a second mixture was obtained (Step 2). By kneading, the cohesion of the active material can be weakened and graphene oxide can be dispersed more uniformly.

Then, PVdF was added to the second mixture and mixing was performed with a mixer, so that a third mixture was obtained (Step 3).

Next, NMP serving as a solvent was added to the third mixture and mixing was performed with a mixer (Step 4). Through the above steps, the slurry was formed.

Then, the formed slurry was applied to an aluminum current collector (with a thickness of 20 μm) subjected to undercoating in advance. The application was performed with a continuous coater at a coating speed of 1 m/min. After that, drying was performed using a drying furnace. The drying conditions were performed at 80° C. for 4 minutes. Then, reduction of the electrode was performed.

The reduction conditions were as follows: chemical reduction was first performed, followed by thermal reduction. First, conditions for chemical reduction will be described. A solution used for the reduction was prepared as follows: a solvent in which NMP and water were mixed at 9:1 was used, and ascorbic acid and LiOH were added to have concentrations of 77 mmol/L and 73 mmol/L, respectively. The reduction treatment was performed at 60° C. for 1 hour. After that, cleaning with ethanol was performed, and drying was performed in a reduced-pressure atmosphere at room temperature. Next, conditions for thermal reduction will be described. After the chemical reduction, the thermal reduction was performed. The thermal reduction was performed at 170° C. in a reduced-pressure atmosphere for 10 hours.

Then, the positive electrode active material layer was pressed by a roll press method so as to be consolidated. Through the above steps, the positive electrode was fabricated.

Table 1 shows the active material amount, the thickness, and the density of the negative electrode active material layer and the positive electrode active material layer that were formed. The values shown in Table 1 are the average, the maximum, and the minimum of measurement values of the electrodes used in fabricating the storage battery.

TABLE 1

| | | average | max. | min. |
|---|---|---|---|---|
| Positive electrode active | Thickness [μm] | 57 | 61 | 55 |
| material layer | Amount [mg/cm²] | 9.8 | 9.9 | 9.5 |
| | Density [g/cc] | 1.7 | 1.8 | 1.6 |
| Negative electrode active | Thickness [μm] | 56 | 57 | 55 |
| material layer | Amount [mg/cm²] | 4.8 | 4.8 | 4.8 |
| | Density [g/cc] | 0.9 | 0.9 | 0.8 |

Next, in the electrolytic solution, 1-ethyl-3-methylimidazolium bis(fluorosulfonyl)amide (EMI-FSA) represented by the following structural formula was used as a solvent and lithium bis(trifluoromethanesulfonyl)amide (LiN(CF₃SO₂)₂, abbreviation: LiTFSA) was used as an electrolyte. LiTFSA was dissolved in EMI-FSA, so that an electrolytic solution with a LiTFSA concentration of 1 mol/kg was prepared.

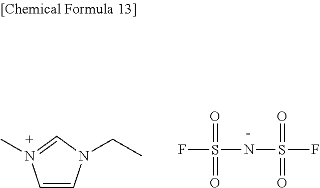

In addition, as a separator, 50-μm-thick solvent-spun regenerated cellulosic fiber (TF40, produced by NIPPON KODOSHI CORPORATION) was used. The separator was cut to have a rectangular shape with a size of 24 mm (vertical)×45 mm (horizontal). Furthermore, as an exterior body, an aluminum film whose both surfaces were covered with a resin layer was used.

### [Fabrication of Storage Battery]

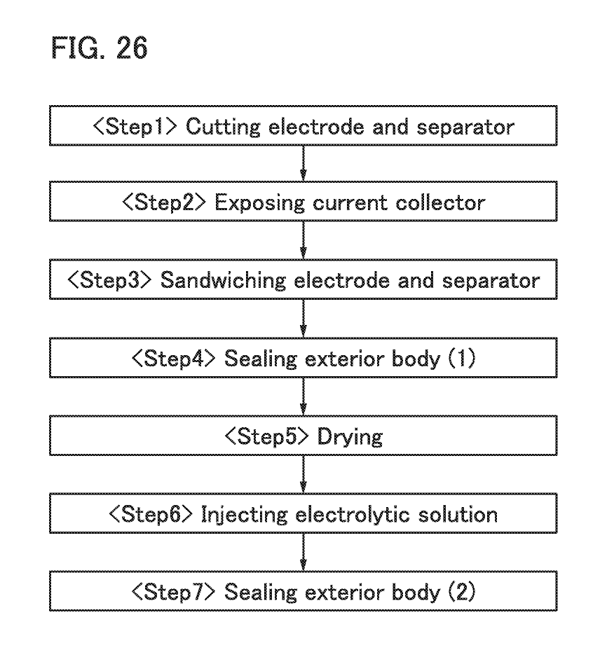

Next, a thin storage battery was fabricated. A fabricating method of the thin storage battery will be described using a flow chart in FIG. 26. First, the completed positive electrode and negative electrode were cut. In addition, the separator was cut (Step 1).

Then, the positive electrode active material and the negative electrode active material on tab regions were removed to expose the current collectors (Step 2).

Then, the exterior body was folded in half so that the positive electrode, the separator, and the negative electrode that were stacked were sandwiched (Step 3). At this time, the positive electrode and the negative electrode were stacked such that the positive electrode active material layer and the negative electrode active material layer faced each other.

Then, the exterior body was bonded at three sides except a side from which an electrolytic solution is injected, by heating (Step 4). At this time, the sealing layers provided for the lead electrodes were positioned so as to overlap with the sealing portion of the exterior body.

After the exterior body was sealed at Side A and Side B, the exterior body and the positive electrode, the separator, and the negative electrode wrapped by the exterior body were dried (Step 5). The drying conditions were as follows: 80° C. under a reduced pressure for 10 hours.

Next, an electrolytic solution was injected from one side that was not sealed, in an argon gas atmosphere (Step 6). After that, the one side of the exterior body was sealed by heating in a reduced-pressure atmosphere (Step 7). Through the above steps, a thin storage battery A was fabricated. Furthermore, a thin storage battery B was fabricated which uses the negative electrode not subjected to heat treatment after the negative electrode active material layer was formed on one surface of the current collector.

### [Evaluation of Initial Charge and Discharge Characteristics]

Next, initial charge and discharge and the charge and discharge cycles of the storage battery A and the storage battery B were measured. The measurement was performed with a charge-discharge measuring instrument (produced by TOYO SYSTEM Co., LTD.) at an evaluation temperature of 100° C. As the charging conditions, constant current charging was performed with the upper limit of 4 V. As the discharging conditions, constant current discharging was performed with the lower limit of 2 V. The charging and discharging were performed at a rate of approximately 0.3 C. Note that for the calculation of the rate, 1 C was set to 170 mA/g which was the current value per weight of the positive electrode active material.

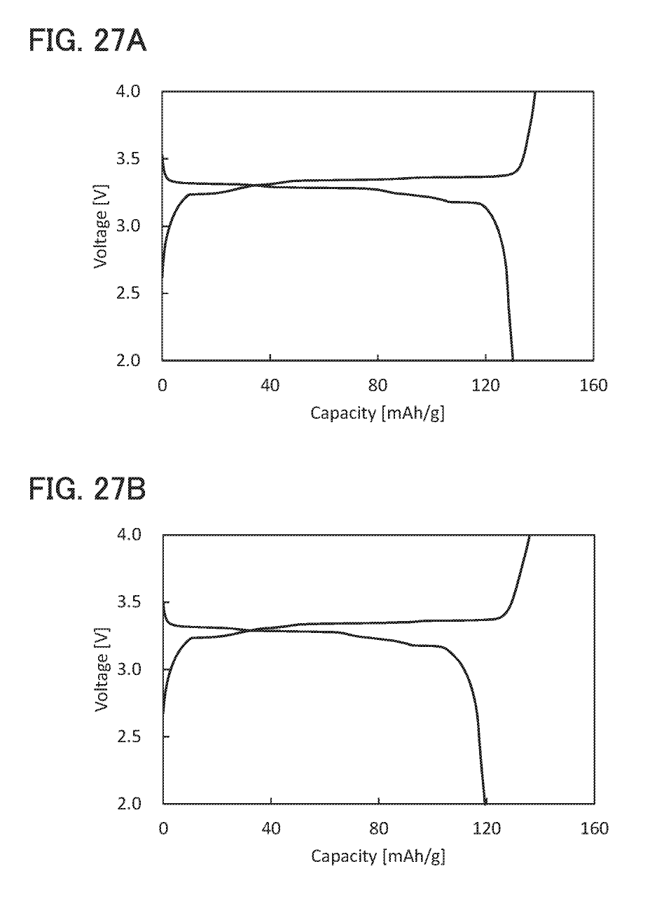

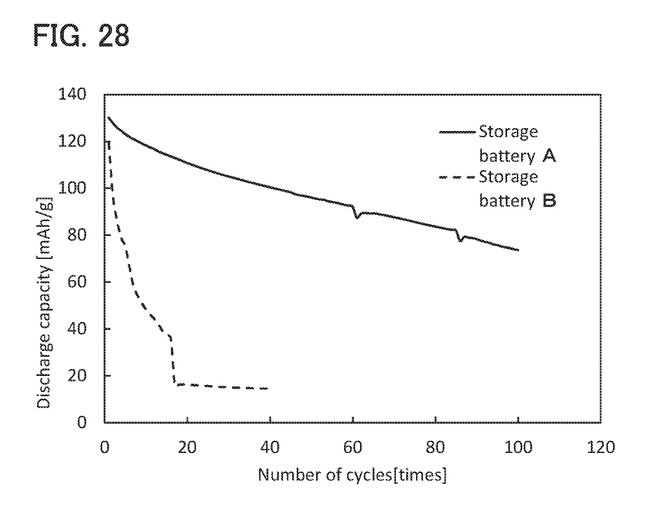

FIG. 27 shows initial charge and discharge characteristics, and FIG. 28 shows charge and discharge cycle characteristics. Note that in FIG. 27, the horizontal axis represents capacity (mAh/g) and the vertical axis represents voltage (V). In FIG. 28, the horizontal axis represents the number of cycles (times) and the vertical axis represents discharge capacity (mAh/g).

FIG. 27(A) shows initial charge and discharge characteristics of the storage battery A, and FIG. 27(B) shows initial charge and discharge characteristics of the storage battery B. From FIG. 27(A) and FIG. 27(B), it was found that the storage battery A that uses the negative electrode subjected to the heat treatment after the formation of the negative electrode active material layer shows more favorable characteristics than the storage battery B not subjected to the heat treatment. Moreover, according to FIG. 28, it was confirmed that the storage battery A has favorable cycle characteristics because it does not exhibit an inflection point where the capacity largely decreases in the middle of the cycles, that is in contrast observed in the storage battery B, and shows a gradual deterioration in discharge capacity.

### REFERENCE NUMERALS

115 sealing layer
118 bonding portion
119 inlet
281 tab region
282 tab region
300 storage battery
301 positive electrode can
302 negative electrode can
303 gasket
304 positive electrode
305 positive electrode current collector
306 positive electrode active material layer
307 negative electrode
308 negative electrode current collector
309 negative electrode active material layer
310 separator
500 battery cell
501 positive electrode current collector
502 positive electrode active material layer
502a positive electrode active material layer
502b positive electrode active material layer
503 positive electrode
504 negative electrode current collector
505 negative electrode active material layer
505_1 negative electrode active material layer
505_2 negative electrode active material layer
506 negative electrode
507 separator
508 electrolytic solution
509 exterior body
510 positive electrode lead electrode
511 negative electrode lead electrode
512 bonding portion
513 curved portion
514 bonding portion
515 film
515_1 film
515_2 film
516 film
521 graphene
522 positive electrode active material
600 storage battery
601 positive electrode cap
602 battery can
603 positive electrode terminal
604 positive electrode
605 separator
606 negative electrode
607 negative electrode terminal
608 insulating plate
609 insulating plate
611 PTC element
612 safety valve mechanism
700 power storage device
701 terminal pair
702 terminal pair
703 switching control circuit
704 switching circuit
705 switching circuit
706 voltage transformation control circuit
707 voltage transformer circuit
708 battery portion
709 battery cell
710 transistor
711 bus
712 bus
713 transistor
714 current control switch
715 bus
716 bus
717 switch pair
718 switch pair
721 transistor pair
722 transistor
723 transistor
724 bus
725 bus
731 transistor pair
732 transistor
733 transistor
734 bus
735 bus
741 battery control unit
751 insulated DC-DC converter
752 switch portion
753 transformer
900 circuit board
910 label
911 terminal
912 circuit
913 storage battery
914 antenna
915 antenna
916 layer
917 layer
918 antenna
919 terminal
920 display device
921 sensor
922 terminal
951 terminal
952 terminal
981 film
982 film
990 storage battery
991 exterior body
992 exterior body
993 wound body
994 negative electrode
995 positive electrode
996 separator
997 lead electrode
998 lead electrode
1122 charger
1123 charger
7100 portable display device
7101 housing
7102 display portion
7103 operation button
7104 power storage device
7200 portable information terminal
7201 housing
7202 display portion
7203 band
7204 buckle
7205 operation button
7206 input output terminal
7207 icon
7300 display device
7304 display portion
7400 mobile phone
7401 housing
7402 display portion
7403 operation button
7404 external connection port
7405 speaker
7406 microphone
7407 power storage device
7408 lead electrode
7409 current collector
8000 display device
8001 housing
8002 display portion
8003 speaker portion
8004 power storage device
8021 charging apparatus
8022 cable
8024 power storage device
8100 lighting device
8101 housing
8102 light source
8103 power storage device
8104 ceiling
8105 wall
8106 floor
8107 window
8200 indoor unit
8201 housing
8202 air outlet
8203 power storage device
8204 outdoor unit
8300 electric refrigerator-freezer
8301 housing
8302 door for a refrigerator
8303 door for a freezer
8304 power storage device
8400 automobile
8401 headlight
8500 automobile
9600 tablet terminal
9625 switch
9626 switch
9627 power switch
9628 operation switch
9629 fastener
9630 housing
9630a housing
9630b housing
9631 display portion
9631a display portion
9631b display portion
9632a region
9632b region
9633 solar cell
9634 charge and discharge control circuit
9635 power storage unit
9636 DC-DC converter
9637 converter
9638 operation key
9639 button
9640 movable portion

1.-14. (canceled)

15. An electrode comprising:
a current collector;
an active material layer; and
a first film,
wherein a first surface of the current collector comprises a region provided with the active material layer,
wherein a second surface of the current collector comprises a region not provided with the active material layer,
wherein the first film comprises a region in contact with the second surface of the current collector,
wherein the first film comprises an insulating film, and
wherein the insulating film comprises at least one component of the current collector and oxygen.

16. The electrode according to claim 15,
wherein the first film comprises a region having a thickness of more than or equal to 5 nm and less than or equal to 50 nm.

17. The electrode according to claim 15,
wherein the current collector comprises copper, and
wherein the first film comprises copper oxide.

18. The electrode according to claim 15,
wherein a second film in contact with a surface of the active material layer is included.

19. A negative electrode comprising the electrode according to claim 15,
wherein the current collector is a negative electrode current collector, and
wherein the active material layer is a negative electrode active material layer.

20. A power storage device comprising:
a positive electrode;
a separator;
a negative electrode; and
an electrolytic solution,
wherein the separator is provided between the positive electrode and the negative electrode,
wherein the positive electrode comprises a positive electrode active material layer and a positive electrode current collector,
wherein the negative electrode comprises a negative electrode current collector and a negative electrode active material layer which faces the positive electrode active material layer with the separator positioned therebetween,
wherein a first surface of the negative electrode current collector comprises a region provided with the negative electrode active material layer,
wherein a second surface of the negative electrode current collector comprises a region not provided with the negative electrode active material layer,
wherein the negative electrode comprises a first film,
wherein the first film comprises an insulating film,
wherein the first film comprises a region in contact with the second surface of the negative electrode current collector, and
wherein the insulating film comprises at least one component of the negative electrode current collector and oxygen.

21. The power storage device according to claim 20,
wherein the first film comprises a region having a thickness of more than or equal to 5 nm and less than or equal to 50 nm.

22. The power storage device according to claim 20,
wherein the negative electrode current collector comprises copper, and
wherein the first film comprises copper oxide.

23. The power storage device according to claim 20,
wherein a second film in contact with a surface of the negative electrode active material layer is included.

24. An electronic device comprising:
the power storage device according to claim 20; and
a display device, an operation button, an external connection port, a speaker, or a microphone.

25. A method for manufacturing an electrode, the method comprising the steps of:
mixing an active material, a binder, and a conductive additive to form a slurry;
applying the slurry onto a current collector;
drying the applied slurry to form an active material layer; and
performing heat treatment in an atmosphere containing oxygen to form a film in contact with the current collector,
wherein the film is formed on a surface of the current collector where the active material layer is not provided and comprises at least one component of the current collector and oxygen.

26. The method according to claim 25,
wherein the drying is performed at higher than or equal to 30° C. and lower than or equal to 160° C.

27. The method according to claim 25,
wherein the heat treatment is performed at higher than or equal to 50° C. and lower than or equal to 200° C. for longer than or equal to 2 hours.

28. The method according to claim 25,
wherein the current collector is a negative electrode current collector and the active material layer is a negative electrode active material layer.
